(19) United States
(12) Patent Application Publication
(10) Pub. No.: US 2026/0101338 A1
(43) Pub. Date: Apr. 9, 2026

(54) MULTI-SLOT/PDSCH/PUSCH SCHEDULING ON MULTIPLE CELLS

(71) Applicant: Samsung Electronics Co., Ltd., Suwon-si (KR)

(72) Inventors: Ebrahim MolavianJazi, San Jose, CA (US); Aristides Papasakellariou, Houston, TX (US); Hongbo Si, Allen, TX (US)

(21) Appl. No.: 19/333,304

(22) Filed: Sep. 18, 2025

Related U.S. Application Data
(60) Provisional application No. 63/703,630, filed on Oct. 4, 2024.
(60) Provisional application No. 63/718,511, filed on Nov. 8, 2024.
(60) Provisional application No. 63/755,691, filed on Feb. 7, 2025.
(60) Provisional application No. 63/779,937, filed on Mar. 28, 2025.
(60) Provisional application No. 63/798,095, filed on May 1, 2025.
(60) Provisional application No. 63/864,942, filed on Aug. 15, 2025.

(51) Int. Cl. H04W 72/1273; H04L 1/1829; H04W 72/232

(52) U.S. Cl. CPC H04W 72/1273; H04L 1/1864; H04W 72/232

(57) ABSTRACT

Apparatuses and methods for multi-slot/physical downlink shared channel (PDSCH)/physical uplink shared channel (PUSCH) scheduling on multiple cells. A method for a user equipment (UE) includes receiving first information for a number of sets of cells, receiving a physical downlink shared channel (PDCCH) that provides a downlink control information (DCI) format, receiving first more than one PDSCH on first more than one cell, determining hybrid automatic repeat request acknowledgement (HARQ-ACK) information bits, and transmitting a physical uplink control channel (PUCCH) or a PUSCH that provides the HARQ-ACK information bits. The DCI format schedules receptions of the first more than one PDSCH on the first more than one cell in a set s of cells from the number of sets of cells. The first more than one PDSCH include one or more PDSCHs on each cell from the first more than one cell.

### CROSS REFERENCE TO RELATED APPLICATIONS AND CLAIM OF PRIORITY

The present application claims priority under 35 U.S.C. § 119 (e) to U.S. Provisional Patent Application No. 63/703,630 filed on Oct. 4, 2024; U.S. Provisional Patent Application No. 63/718,511 filed on Nov. 8, 2024; U.S. Provisional Patent Application No. 63/755,691 filed on Feb. 7, 2025; U.S. Provisional Patent Application No. 63/779,937 filed on Mar. 28, 2025; U.S. Provisional Patent Application No. 63/798,095 filed on May 1, 2025; and U.S. Provisional Patent Application No. 63/864,942 filed on Aug. 15, 2025 which are hereby incorporated by reference in their entirety.

### TECHNICAL FIELD

The present disclosure relates generally to wireless communication systems and, more specifically, the present disclosure is related to apparatuses and methods for multi-slot/physical downlink shared channel (PDSCH)/physical uplink shared channel (PUSCH) scheduling on multiple cells.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to multi-slot/PDSCH/PUSCH scheduling on multiple cells.

In one embodiment, a method for a user equipment (UE) is provided. The method includes receiving first information for a number of sets of cells, receiving a physical downlink shared channel (PDCCH) that provides a downlink control information (DCI) format, receiving first more than one PDSCH on first more than one cell, determining hybrid automatic repeat request acknowledgement (HARQ-ACK) information bits, and transmitting a physical uplink control channel (PUCCH) or a PUSCH that provides the HARQ-ACK information bits. The DCI format schedules receptions of the first more than one PDSCH on the first more than one cell in a set s of cells from the number of sets of cells. The first more than one PDSCH include one or more PDSCHs on each cell from the first more than one cell. First

$${N}_{sets}^{HARQ - ACK , s}$$

HARQ-ACK information bits, from the HARQ-ACK information bits, are associated with the receptions of the first more than one PDSCH. All subsequent

$$( {N}_{sets}^{HARQ - ACK , max} - {N}_{sets}^{HARQ - ACK , s} )$$

HARQ-ACK information bits, from the HARQ-ACK information bits, have a negative acknowledgement (NACK) value.

$${N}_{sets}^{HARQ - ACK , s}$$

is a sum, across all the first more than one cell, of

$${N}_{TB , c}^{DL} \cdot {N}_{PDSCH , c}^{max}$$

when transport bock group (TBG) HARQ-ACK bundling does not apply for a cell c, or

$${N}_{TB , c}^{DL} \cdot {N}_{HARQ - ACK , c}^{TBG , max}$$

when TBG HARQ-ACK bundling applies for the cell c.

$${N}_{TB , c}^{DL}$$

is a maximum number of codewords per PDSCH on the cell c, when spatial HARQ-ACK bundling does not apply for the cell c, otherwise

$${N}_{TB , c}^{DL} = 1. {N}_{PDSCH , c}^{max}$$

is a maximum number of start and length indicator values (SLIVs) over all rows of a first time-domain resource allocation (TDRA) table associated with the cell c,

$${N}_{HARQ - ACK , c}^{TBG , max}$$

is a maximum number of TBGs for HARQ-ACK bundling for the cell c.

$${N}_{sets}^{HARQ - ACK , max}$$

is a maximum number of HARQ-ACK information bits for any DCI format that schedules PDSCHs on one or more cells in any set of cells from the number of sets of cells. The cell c is from the first more than one cell.

In another embodiment, a UE is provided. The UE includes a transceiver configured to receive first information for a number of sets of cells, receive a PDCCH that provides a DCI format, and receive first more than one PDSCH on first more than one cell. The UE further includes a processor operably coupled with the transceiver. The processor configured to determine HARQ-ACK information bits. The transceiver is further configured to transmit a PUCCH or a PUSCH that provides the HARQ-ACK information bits. The DCI format schedules receptions of the first more than one PDSCH on the first more than one cell in a set s of cells from the number of sets of cells. The first more than one PDSCH include one or more PDSCHs on each cell from the first more than one cell. First

$${N}_{sets}^{HARQ - ACK , s}$$

HARQ-ACK information bits, from the HARQ-ACK information bits, are associated with the receptions of the first more than one PDSCH. All subsequent

$$( {N}_{s e t s}^{HARQ - ACK , max} - {N}_{s e t s}^{H ARQ - ACK , s} )$$

HARQ-ACK information bits, from the HARQ-ACK information bits, have a NACK value

$${N}_{s e t s}^{HARQ - ACK , s}$$

is a sum, across all the first more than one cell, of

$${N}_{TB , c}^{D L} \cdot {N}_{PDSCH , c}^{max}$$

when TBG HARQ-ACK bundling does not apply for a cell c, or

$${N}_{TB , c}^{D L} \cdot {N}_{H ARQ - ACK , c}^{TBG , max} ,$$

when TBG HARQ-ACK bundling applies for the cell c.

$${N}_{TB , c}^{D L}$$

is a maximum number of codewords per PDSCH on the cell c, when spatial HARQ-ACK bundling dies not apply for the cell c, otherwise

$${N}_{TB , c}^{D L} = 1. {N}_{PDSCH , c}^{max}$$

is a maximum number of SLIVs over all rows of a first TDRA table associated with the cell c.

$${N}_{HARQ - ACK , c}^{TBG , max}$$

is a maximum number of TBGs for HARQ-ACK bundling for the cell c.

$${N}_{s e t s}^{HARQ - ACK , max}$$

is a maximum number of HARQ-ACK information bits for any DCI format that schedules PDSCHs on one or more cells in any set of cells from the number of sets of cells. The cell c is from the first more than one cell.

In yet another embodiment, a base station is provided. The base station includes a transceiver configured to transmit first information for a number of sets of cells, transmit a PDCCH that provides a DCI format, transmit the first more than one PDSCH on the first more than one cell, and receive a PUCCH or a PUSCH that provides HARQ-ACK information bits. The base station further includes a processor operably coupled with the transceiver. The processor is configured to determine the HARQ-ACK information bits from the PUCCH or PUSCH reception. The DCI format schedules receptions of the first more than one PDSCH on the first more than one cell in a set s of cells from the number of sets of cells. The first more than one PDSCH include one or more PDSCHs on each cell from the first more than one cell. First

$${N}_{s e t s}^{HARQ - ACK , s}$$

HARQ-ACK information bits, from the HARQ-ACK information bits, are associated with the receptions of the first more than one PDSCH. All subsequent

$$( {N}_{s e t s}^{HARQ - ACK , max} - {N}_{s e t s}^{HARQ - ACK , s} )$$

HARQ-ACK information bits, from the HARQ-ACK information bits, have a NACK value.

$${N}_{sets}^{HARQ - ACK , s}$$

is a sum, across all the first more than one cell, of

$${N}_{TB , c}^{DL} \cdot {N}_{PDSCH , c}^{max}$$

when TBG HARQ-ACK budling does not apply for a cell c, or

$${N}_{TB , c}^{DL} \cdot {N}_{HARQ - ACK , c}^{TBG , max} ,$$

when TBG HARQ-ACK budling applies for the cell c.

$${N}_{TB , c}^{DL}$$

is a maximum number of codewords per PDSCH on the cell c, when spatial HARQ-ACK bundling does not apply for the cell c, otherwise

$${N}_{TB , c}^{DL} = 1. {N}_{PDSCH , c}^{max}$$

is a maximum number of SLIVs over all rows of a first TDRA table associated with the cell c.

$${N}_{HARQ - ACK , c}^{TBG , max} > 1$$

is a maximum number of TBGs for HARQ-ACK bundling for the cell c.

$${N}_{sets}^{HARQ - ACK , max}$$

is a maximum number of HARQ-ACK information bits for any DCI format that schedules PDSCHs on one or more cells in any set of cells from the number of sets of cells. The cell c is from the first more than one cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates examples of co-scheduled cell configurations according to embodiments of the present disclosure;

FIG. 10 illustrates an example of cell switching pattern according to embodiments of the present disclosure;

FIGS. 11A and 11B illustrate an example of cell switching pattern according to embodiments of the present disclosure;

FIGS. 12A and 12B illustrate an example of cell switching pattern according to embodiments of the present disclosure; and

FIG. 13 illustrates an example method performed by a UE in a wireless communication system according to embodiments of the present disclosure.

### DETAILED DESCRIPTION

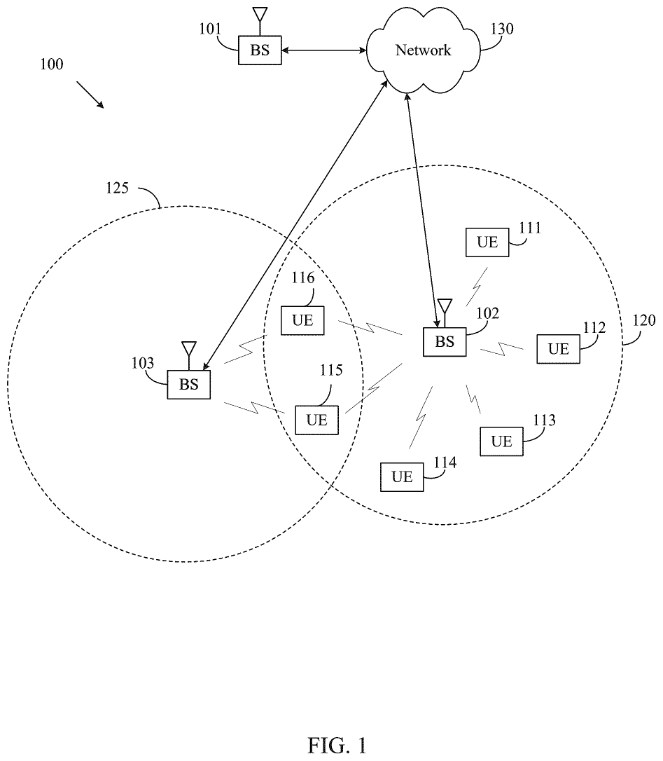

FIGS. 1-13 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 Rel-18 v18.4.0, “NR; Physical channels and modulation;” [REF 2] 3GPP TS 38.212 Rel-18 v18.4.0, “NR; Multiplexing and channel coding;” [REF 3] 3GPP TS 38.213 Rel-18 v18.4.0, “NR; Physical layer procedures for control;” [REF 4] 3GPP TS 38.214 Rel-18 v18.4.0, “NR; Physical layer procedures for data;” [REF 5] 3GPP TS 38.215 Rel-18 v18.4.0, “NR; Physical layer measurements;” [REF 6] 3GPP TS 38.321 Rel-18 v18.3.0, “NR; Medium Access Control (MAC) protocol specification;” [REF 7] 3GPP TS 38.331 Rel-18 v18.3.0, “NR; Radio Resource Control (RRC) protocol specification;” and [REF 8] 3GPP TS 38.300 Rel-18 v18.3.0, “NR; NR and NG-RAN Overall Description; Stage 2.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to receive multi-slot/PDSCH/PUSCH scheduling on multiple cells. In certain embodiments, one or more of the BSs 101-103 include circuitry, programing, or a combination thereof to support multi-slot/PDSCH/PUSCH scheduling on multiple cells.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

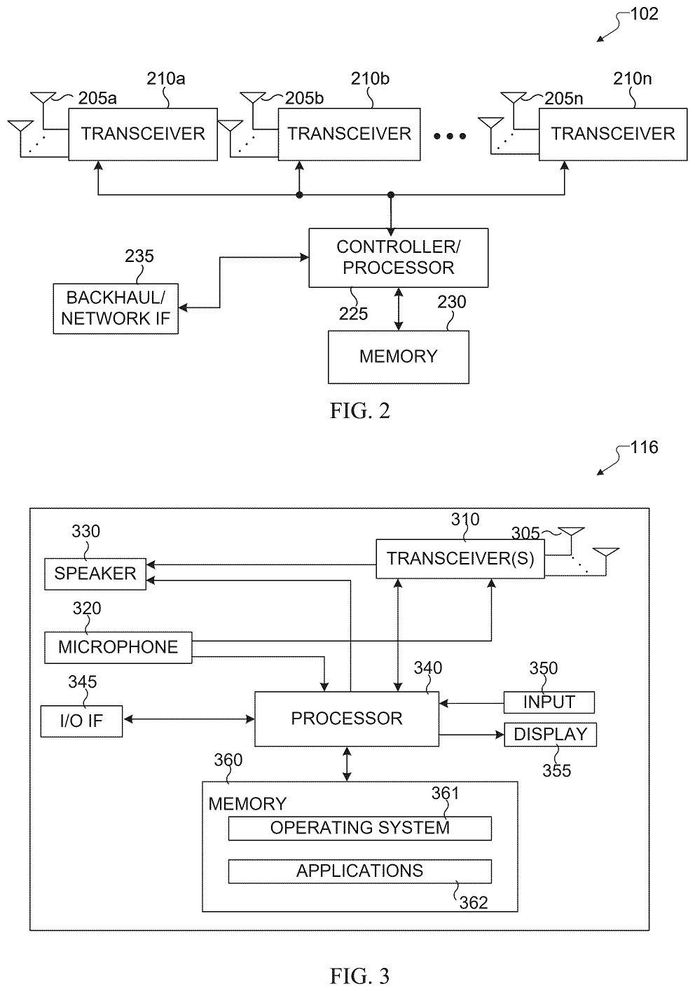

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as performing multi-slot/PDSCH/PUSCH scheduling on multiple cells. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for multi-slot/PDSCH/PUSCH scheduling on multiple cells as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUS). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

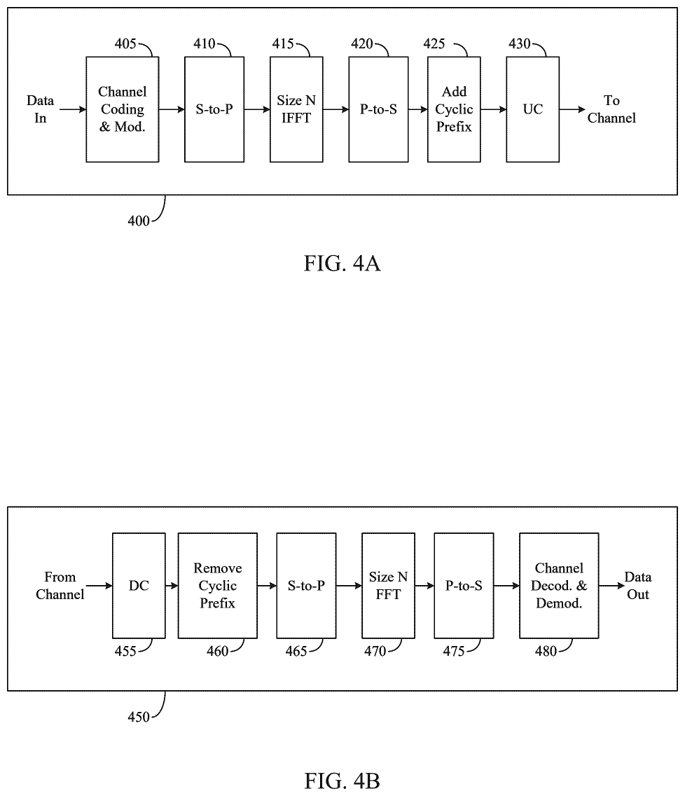

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to support multi-slot/PDSCH/PUSCH scheduling on multiple cells as described in embodiments of the present disclosure. In some embodiments, the receive path 450 is configured to support multi-slot/PDSCH/PUSCH scheduling on multiple cells as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

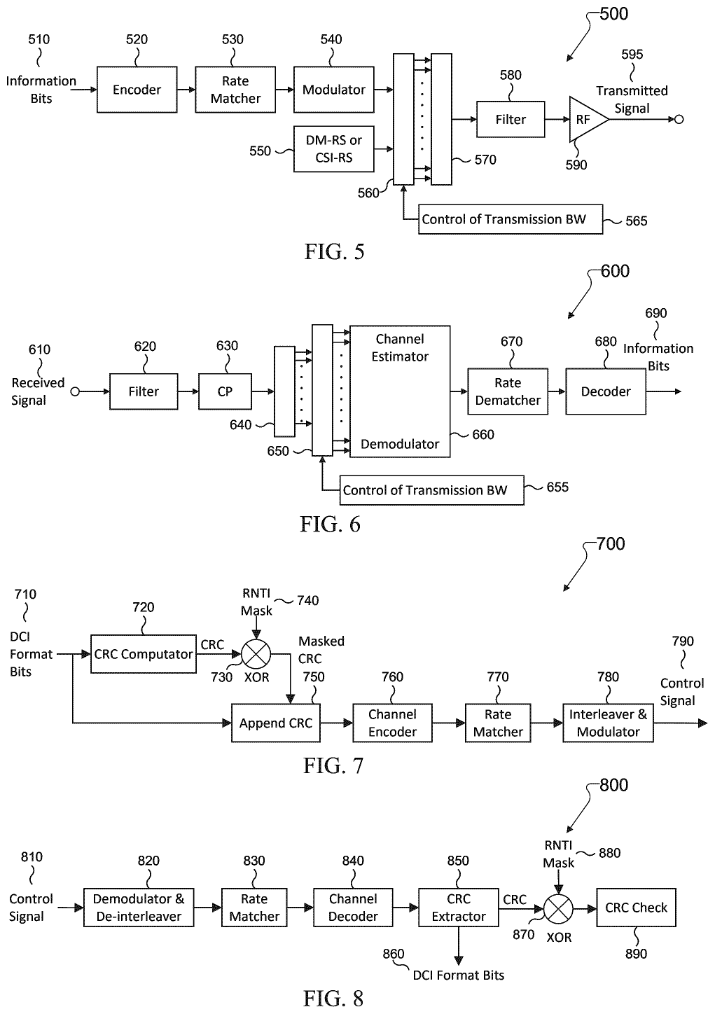

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR (0,0)=0, XOR (0,1)=1, XOR (1,0)=1, XOR (1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

A DCI format 0_3/1_3 can be used to schedule physical uplink shared channels (PUSCHs) or physical downlink shared channels (PDSCHs) on multiple cells. In 5G NR Rel-18, a DCI format 0_3/1_3 can schedule only one PUSCH or only one PDSCH on each of the multiple cells.

On the other hand, for higher frequency bands or for operation in unlicensed bands, 5G NR Rel-16/17 supports scheduling multiple PUSCHs or multiple PDSCHs on a cell using a single DCI format.

A combination of the two features is beneficial to reduce control overhead and reduce PDCCH blocking probability for scheduling a UE.

Embodiments of the present disclosure recognize that there is a need to enable joint multi-slot/PDSCH/PUSCH and multi-cell scheduling using a single DCI format, namely to support for DCI format 0_3/1_3 to schedule multiple PUSCHs/PDSCHs on each of multiple co-scheduled cells.

The present disclosure provides methods and apparatus to enable joint multi-slot/PDSCH/PUSCH and multi-cell scheduling using a single DCI format.

The embodiments may apply to any deployments, verticals, or scenarios including in FRI, FR2, FR3, FR4, with enhanced mobile broadband (eMBB), ultra reliable low latency communications (URLLC) and industrial internet of things (IIoT), massive machine-type communications (mMTC) and IoT including LTE NB-IoT or NR IoT or Ambient IoT (A-IoT), with AI/ML operation, with sidelink/vehicle to anything (V2X) communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multi-cast broadcast services (MBS), with integrated sensing and communication (ISAC) operation, and so on.

Embodiments of the disclosure are summarized in the following and are fully elaborated further herein. Combinations of the embodiments are also applicable but are not described in detail for brevity.

A TDRA table for joint multi-cell and multi-slot/PDSCH/PUSCH scheduling is provided. In one embodiment, a UE (e.g., the UE 116) can be configured a time domain resource assignment (TDRA) table for joint multi-cell and multi-slot/PDSCH/PUSCH scheduling. In a first approach, the UE can be configured a single joint table with a number of rows, wherein entries in each row correspond to different cells/bandwidth parts (BWPs) and, for each cell/BWP, a single entry is a provided that is a single TDRA index pointing to a multi-slot/PDSCH/PUSCH TDRA table for the respective cell/BWP. In a second approach, the UE can be configured a single joint table with a number of rows, wherein entries in each row correspond to different cells/BWPs and, for each cell/BWP, multiple entries are provided that are TDRA indexes each pointing to a single-slot/PDSCH/PUSCH TDRA table for the respective cell/BWP.

Type-1 hybrid automatic repeat request acknowledgement (HARQ-ACK) codebook for joint multi-cell and multi-slot/PDSCH scheduling is provided. In one embodiment, when a UE is configured for joint multi-cell and multi-slot/PDSCH scheduling, the UE can generate a Type-1 HARQ-ACK codebook based on one or both of a TDRA table for multi-cell/multi-slot (multi-PDSCH) scheduling and a TDRA table for single-cell/single-slot (single-PDSCH) scheduling, or combinations thereof, such as an intersection or union of such TDRA tables. A Type-2 HARQ-ACK codebook for joint multi-cell and multi-slot/PDSCH scheduling is provided.

In one embodiment, when a UE is configured for joint multi-cell and multi-PDSCH scheduling, the UE can generate a Type-2 HARQ-ACK codebook that includes a first sub-codebook associated with DCI formats that schedule a single PDSCH on a single cell (and with other DCI formats with associated HARQ-ACK information and without scheduling a corresponding PDSCH reception), and a second sub-codebook associated with DCI formats that schedules more than one PDSCH on more than one cell, with one PDSCH or multiple PDSCHs for each cell from the more than one cells. The UE includes, for each DCI format in the second sub-codebook, a maximum number of HARQ-ACK information bits based on:
a maximum total number of TBs across different slots configured for multi-slot/PDSCH scheduling, and across different cell combinations applicable for DCI format 1_3, and across different set of cells for multi-cell scheduling in a physical UL control channel (PUCCH) group, and
an applicable HARQ-ACK bundling across different TBs for a same PDSCH/cell, or bundling across different slots for a same PDSCH/cell, if any.

When the UE generates a first number of HARQ-ACK information bits for TBs/PDSCHs associated with a first DCI format 1_3 that is smaller than the maximum number of HARQ-ACK information bits, the UE generates an additional number of HARQ-ACK information bits with NACK values so that the resulting number of HARQ-ACK information bits in the second HARQ-ACK codebook is equal to the maximum number. Such additional NACK values can be appended to the first number of HARQ-ACK information bits, or can be distributed among the first HARQ-ACK information bits, such as by appending some NACK values to HARQ-ACK information bits corresponding to each cell in the set of cells.

DCI fields for joint multi-cell and multi-PUSCH/PDSCH scheduling is provided. In one embodiment, certain DCI fields can be indicated or interpreted differently in a DCI format 0_3/1_3 that schedules only a single PUSCH/PDSCH for a cell or for one or more or all cells in a set of cells compared to a DCI format 0_3/1_3 that schedules multiple PUSCHs/PDSCHs for the cell or for one or more or all cells in the set of cells. Such fields can include at least one of: UL-SCH field or CSI request field in a DCI format 0_3, that apply to a reference cell, such as a smallest cell index among co-scheduled cells by a DCI format 0_3, or a smallest cell index among first cells from the co-scheduled cells by the DCI format 0_3, wherein the first cells includes cells that are configured or scheduled with only one PUSCH transmission (e.g., only one start and length indicator value (SLIV) indicated by TDRA). When the DCI format 0_3 schedules more than one PUSCHs on the reference cell, the UL-SCH field or the CSI request field may be absent (0 bits) or may apply only to a reference PUSCH from the multiple PUSCHs, for example, based on order of starting/ending time of PUSCH transmissions or based on ascending (or descending) order of SLIV in a corresponding TDRA table row or based on CSI computation/processing timeline. When certain fields in a DCI format 1_3 are repurposed as a bitmap to indicate SCell dormancy, the bitmap can include NDI bit and RV bits corresponding to first TB of only a reference PDSCH or first TBs of scheduled PDSCHs, on a cell with smallest cell index among cells that are not scheduled (e.g., with invalid frequency domain resource assignment (FDRA) value) by a DCI format 1_3.

UE features for number of unicast DCIs and search space for co-scheduled cells with different subcarrier spacing (SCS) or carrier type are provided. In one embodiment, when a set of co-scheduled cells include cells with different SCS, a number of unicast DL or UL DCI formats that a UE supports can be based on a ratio of the scheduling cell SCS and a first SCS for first scheduled cells or a second SCS for second scheduled cells, and counting can be in a time duration that depends on both such SCSs.

Cell switching pattern between PCell and SCell is provided. In one embodiment, a UE can be configured a pattern for switching between a first cell, such as a PCell, and a second cell, such as an SCell. For example, the PCell is an FRI frequency division duplexing (FDD) cell, and the SCell is a supplementary DL (SDL) cell. For example, the switching pattern can be based on a periodicity, such as 5 or 10 or 20 msec or other values, and a number of switching points to indicates a switch from the PCell to the SCell or from the SCell to the PCell, including switching delays. A number of switching points in the Cell switching pattern can be based on one or more of: an synchronization signal block (SSB) periodicity, a number of actually transmitted SSB indexes on the PCell, a periodicity of the Cell switching pattern, and whether or not SSB is present or absent on the SCell (such as whether the PCell and the SCell are synchronized and/or collocated).

In the following, unless otherwise noted, a parameter referenced in italics is provided by higher layers such as by SIB or RRC.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by MIB or a system information block (SIB), such as a SIB1, or by a common RRC signaling, or by UE-specific RRC signaling.

DL transmissions or UL transmissions can be based on an orthogonal frequency division multiplexing (OFDM) waveform including a variant using DFT precoding that is known as DFT-spread-OFDM (see also REF 1).

A UE typically monitors multiple candidate locations for respective potential PDCCH receptions to decode one or more DCI formats in a slot, for example as described in REF 3. A DCI format includes cyclic redundancy check (CRC) bits in order for the UE to confirm a correct detection of the DCI format. A DCI format type is identified by a radio network temporary identifier (RNTI) that scrambles the CRC bits (see also REF 2). For a DCI format scheduling a PDSCH or a PUSCH to a single UE, the RNTI can be a cell RNTI (C-RNTI) and serves as a UE identifier. For a DCI format scheduling a PDSCH conveying system information (SI), the RNTI can be a SI-RNTI. For a DCI format scheduling a PDSCH providing a random access response (RAR), the RNTI can be a random access RNTI (RA-RNTI). For a DCI format providing transmit power control (TPC) commands to a group of UEs, the RNTI can be a TPC-RNTI. Each RNTI type can be configured to a UE through higher-layer signaling such as RRC signaling (see also REF 5). A DCI format scheduling PDSCH transmission to a UE is also referred to as DL DCI format or DL assignment while a DCI format scheduling PUSCH transmission from a UE is also referred to as UL DCI format or UL grant.

A PDCCH transmission can be within a set of physical resource blocks (PRBs). A gNB can configure a UE one or more sets of PRB sets, also referred to as control resource sets (CORESETs), for PDCCH receptions (see also REF 3). A PDCCH transmission can be in control channel elements (CCEs) of a CORESET. A UE determines CCEs for a PDCCH reception based on a search space set (see also REF 3). A set of CCEs that can be used for PDCCH reception by a UE define a PDCCH candidate location.

A gNB separately encodes and transmits each DCI format in a respective PDCCH. When applicable, a RNTI for a UE that a DCI format is intended for masks a CRC of the DCI format codeword in order to enable the UE to identify the DCI format. For example, the CRC can include 16 bits or 24 bits and the RNTI can include 16 bits or 24 bits. Otherwise, when a RNTI is not included in a DCI format, a DCI format type indicator field can be included in the DCI format.

A set of PDCCH candidates for a UE to monitor is defined in terms of PDCCH search space sets. A search space set can be a common search space (CSS) set or a UE-specific search space (USS) set.

For each DL BWP configured to a UE in a serving cell, the UE can be provided by higher layer signalling with
P≤3 CORESETs if coresetPoolIndex is not provided, or if a value of coresetPoolIndex is same for CORESETs if coresetPoolIndex is provided
P≤5 CORESETs if coresetPoolIndex is not provided for a first CORESET, or is provided and has a value 0 for a first CORESET, and is provided and has a value 1 for a second CORESET For each CORESET, the UE is provided the following by ControlResourceSet:
a CORESET index p, by controlResourceSetId or by controlResourceSetId-v1610, where
0<p<12 if coresetPoolIndex is not provided, or if a value of coresetPoolIndex is same for CORESETs if coresetPoolIndex is provided;
0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by controlResourceSetId or by controlResourceSetId-v1610
a PDCCH monitoring periodicity of kₛ slots and a PDCCH monitoring offset of oₛ slots, by monitoringSlotPeriodicityAndOffset or by monitoringSlotPeriodicityAndOffset-r17
a PDCCH monitoring pattern within a slot, indicating first symbol(s) of the CORESET for PDCCH monitoring within each slot where the UE monitors PDCCH, by monitoringSymbolsWithinSlot
a duration of Tₛ<kₛ indicating a number of slots that the search space set s exists by duration, or a number of slots in consecutive groups of slots where the search space set s can exist by duration-r17
a bitmap, by monitoringSlotsWithinSlotGroup, that applies per group of slots and provides a PDCCH monitoring pattern indicating slots in a group of slots for PDCCH monitoring
a size of the group of slots is same as a size of monitoringSlotsWithinSlotGroup
for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ
for a Type1-PDCCH CSS set provided by ra-SearchSpace in SIB1, the PDCCH monitoring pattern indicates only up to 1 slot in the group of slots for PDCCH monitoring
for a Type0-PDCCH CSS set or for a Type0A-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlotsWithinSlotGroup
a number of PDCCH candidates

$${M}_{s}^{( L )}$$

per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpaceType
if search space set s is a CSS set
an indication by dci-Format0-0-AndFormat1-0 to monitor PDCCH candidates for DCI format 0_0 and DCI format 1_0
an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level
an indication by dci-Format2-1 to monitor PDCCH candidates for DCI format 2_1
an indication by dci-Format2-2 to monitor PDCCH candidates for DCI format 2_2
an indication by dci-Format2-3 to monitor PDCCH candidates for DCI format 2_3
an indication by dci-Format2-4 to monitor PDCCH candidates for DCI format 2_4
an indication by dci-Format2-6 to monitor PDCCH candidates for DCI format 2_6
an indication by dci-Format2-9 to monitor PDCCH candidates for DCI format 2_9
an indication by dci-Format4-0 to monitor PDCCH candidates for DCI format 4_0
an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively
an indication by searchSpaceLinkingId that search space set s is linked to another search space set for which is provided a same value for searchSpaceLinkingId
if search space set s is a USS set,
an indication by dci-Formats to monitor PDCCH candidates either for DCI format 0_0 and DCI format 1_0, or for DCI format 0_1 and DCI format 1_1, or
an indication by dci-FormatsExt to monitor PDCCH candidates for DCI format 0_2 and DCI format 1_2, or for DCI format 0_1, DCI format 1_1, DCI format 0_2, and DCI format 1_2, or
an indication by dci-FormatsMC to monitor PDCCH candidates for one or both of DCI format 0_3 and DCI format 1_3, or
an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1, on an indication by dci-Format-NCR to monitor PDCCH candidates for DCI format 2_8
a bitmap by freqMonitorLocations, if provided, to indicate an index of one or more RB sets for the search space set s, where the most significant bit (MSB) k in the bitmap corresponds to RB set k−1 in the DL BWP. For RB set k indicated in the bitmap, the first PRB of the frequency domain monitoring location confined within the RB set is given by where

$${RB}_{s 0 + k , DL}^{start , μ} + {N}_{RB}^{offset} ,$$

where

$${RB}_{s 0 + k , DL}^{start , μ}$$

is the index of first common RB of the RB set k [6, [REF 4]], and

$${N}_{RB}^{offset}$$

is provided by rb-Offset or

$${N}_{RB}^{offset} = 0$$

if rb-Offset is not provided. For each RB set with a corresponding value of 1 in the bitmap, the frequency domain resource allocation pattern for the monitoring location is determined based on the first

$${N}_{RBG , set 0}^{size}$$

bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number

$${n}_{s , f}^{μ} [ 4 ,$$

[REF 1]] in a frame with number n_{f} if (n_{f}

$${N}_{slot}^{frame , μ} + {n}_{s , f}^{μ} - {o}_{s} )$$

mod kₛ=0. The UE monitors PDCCH candidates for search space set s for Tₛ consecutive slots, starting from slot

$${n}_{s , f}^{μ} ,$$

and does not monitor PDCCH candidates for search space set s for the next kₛ−Tₛ consecutive slots. If monitoringSlotsWithinSlotGroup is provided, for search space set s, the UE determines that the slot with number

$${n}_{s , f}^{μ} [ 4 ,$$

[REF 1]] in a frame with number n_{f} satisfying

$$( {n}_{f} {N}_{slot}^{frame , μ} + {n}_{s , f}^{μ} - {o}_{s} ) mod {k}_{s} = 0$$

is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlotsWithinSlotGroup, starting from slot

$${n}_{s , f}^{μ} ,$$

and does not monitor PDCCH candidates for search space set s for the next kₛ−Tₛ consecutive slots.

A USS at CCE aggregation level L∈{1, 2, 4, 8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

For an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

A UE (e.g., the UE 116) does not expect to monitor PDCCH candidates on an active DL BWP of a secondary cell if the UE is configured to monitor PDCCH candidates for detection of DCI formats scheduling on that secondary cell in another serving cell. For a serving cell included in MC-DCI-SetofCells, if provided, the UE does not expect to monitor PDCCH candidates on more than one scheduling cell for detection of DCI formats scheduling on the serving cell. For the active DL BWP of a serving cell on which the UE monitors PDCCH candidates, the UE monitors PDCCH candidates at least for the same serving cell.

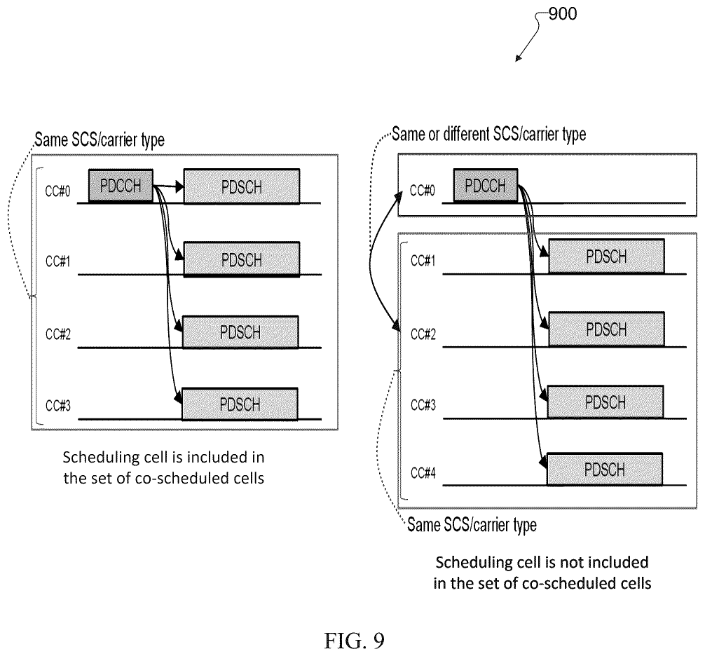

FIG. 9 illustrates examples of co-scheduled cell configurations 900 according to embodiments of the present disclosure. For example, any of the UEs 111-116 of FIG. 1, such as the UE 116, can be configured by co-scheduled cell configurations 900. This example is for illustration only and other embodiments can be used without departing from the scope of the present disclosure.

5G NR Rel-18 introduced multi-cell PDSCH/PUSCH scheduling with a single DCI. The new non-fallback DCI formats 1_3 and 0_3 are introduced to schedule PDSCH or PUSCH on up to 4 intra-band and/or inter-band cells simultaneously. Co-scheduled cells have same SCS and carrier type (licensed or unlicensed, FR1 or FR2-1 or FR2-2), while scheduling cell can have different SCS and/or carrier type from those of co-scheduled cells if scheduling cell is not included in the co-scheduled cells. The UE can be configured with only one scheduling cell for each scheduled cell, and UE can be configured to monitor DCI format 1_3/0_3 and DCI format 0_0/1_0/0_1/1_1 and/or 0_2/1_2 (if supported by the UE) on the same scheduling cell. For some of fields in DCI format 1_3/0_3, a single indication is commonly applied to co-scheduled cell(s) so that the payload size of DCI format 1_3/0_3 could be compact while some other fields in DCI format 1_3/0_3 have separate indication for each of co-scheduled cell(s) for flexibility.

With reference to FIG. 9, an example for configuration of scheduled cell and corresponding scheduling cell for multi-cell scheduling is shown.

Multi-cell scheduling by a single DCI allows the PDCCH of a serving cell to schedule PDSCH(s)/PUSCH(s) on one or more serving cells with the single DCI but with the following restrictions

When a serving cell is configured with a PDCCH which schedules PDSCH(s)/PUSCH(s) on a cell set, the PUSCH/PDSCH on serving cells in the cell set is scheduled by a PDCCH on the serving cell.

When PCell is configured with a PDCCH which schedules PDSCH(s)/PUSCH(s) on serving cells in a cell set, that PCell's PDSCH and PUSCH cannot be scheduled by a PDCCH on an SCell.

When an SCell is configured with a PDCCH which schedules PDSCH(s)/PUSCH(s) on serving cells in a cell set, PCell is not included in the cell set.

The scheduling PDCCH and the scheduled PDSCH(s)/PUSCH(s) can use the same or different numerologies.

The co-scheduled PDSCH(s) with a PDCCH use the same numerology.

The co-scheduled PUSCH(s) with a PDCCH use the same numerology.

In one example, several of the restrictions herein can be relaxed or removed. For example, the co-scheduled PDSCHs or PUSCHs can have different SCS/numerology. For example, a scheduling cell for a set of cells, such as a PCell or an SCell scheduling cell, can also be scheduled for single-cell scheduling or for multi-cell scheduling by a different cell.

A DCI format for multi-cell scheduling can be a DCI format 0_3 or a DCI format 1_3. DCI format 0_3 is used for the scheduling of one PUSCH in one cell, or multiple PUSCHs in multiple cells with one PUSCH per cell. DCI format 1_3 is used for the scheduling of one PDSCH in one cell, or multiple PDSCHs in multiple cells with one PDSCH per cell.

For example, the UE is configured one or multiple sets of a cells, associated with a same scheduling cell, using the following RRC parameters.

```
mc-DCI-SetOfCellsToAddModList-r18 SEQUENCE (SIZE (1..maxNrofSetsOfCells-r18)) OF MC-
DCI-SetOfCells-r18 OPTIONAL, -- Need N
  mc-DCI-SetOfCellsToReleaseList-r18 SEQUENCE (SIZE (1..maxNrofSetsOfCells-r18)) OF
SetOfCellsId-r18 OPTIONAL -- Need N
MC-DCI-SetOfCells-r18 ::= SEQUENCE {
  setOfCellsId-r18 SetOfCellsId-r18,
  nCI-Value-r18 INTEGER (0..7),
  scheduledCellListDCI-1-3-r18 SEQUENCE (SIZE (2..maxNrofCellsInSet-r18)) OF ServCellIndex
OPTIONAL, -- Need R
  scheduledCellListDCI-0-3-r18 SEQUENCE (SIZE (2..maxNrofCellsInSet-r18)) OF ServCellIndex
OPTIONAL, -- Need R
  scheduledCellComboListDCI-1-3-r18 SEQUENCE (SIZE (1..maxNrofCellCombos-r18)) OF
ScheduledCellCombo-r18 OPTIONAL, -- Need R
  scheduledCellComboListDCI-0-3-r18 SEQUENCE (SIZE (1..maxNrofCellCombos-r18)) OF
ScheduledCellCombo-r18 OPTIONAL, -- Need R
  antennaPortsDCI1-3-r18 ENUMERATED {type1a, type2} OPTIONAL, -- Cond TypeDCI1-3
  antennaPortsDCI0-3-r18 ENUMERATED {type1a, type2} OPTIONAL, -- Cond TypeDCI0-3
  tpmi-DCI0-3-r18 ENUMERATED {type1a, type2} OPTIONAL, -- Cond TypeDCI0-3
  sri-DCI0-3-r18 ENUMERATED {type1a, type2} OPTIONAL, -- Cond TypeDCI0-3
  priorityIndicatorDCI-1-3-r18 ENUMERATED {enabled} OPTIONAL, -- Need R
  priorityIndicatorDCI-0-3-r18 ENUMERATED {enabled} OPTIONAL, -- Need R
  dormancyDCI-1-3-r18 ENUMERATED {enabled} OPTIONAL, -- Need R
  dormancyDCI-0-3-r18 ENUMERATED {enabled} OPTIONAL, -- Need R
  pdcchMonAdaptDCI-1-3-r18 ENUMERATED {enabled} OPTIONAL, -- Need R
  pdcchMonAdaptDCI-0-3-r18 ENUMERATED {enabled} OPTIONAL, -- Need R
  minimumSchedulingOffsetK0DCI-1-3-r18 ENUMERATED {enabled} OPTIONAL, -- Need R
  minimumSchedulingOffsetK0DCI-0-3-r18 ENUMERATED {enabled} OPTIONAL, -- Need R
  pdsch-HARQ-ACK-OneShotFeedbackDCI-1-3-r18 ENUMERATED {enabled} OPTIONAL, --
Need R
  pdsch-HARQ-ACK-enhType3DCI-1-3-r18 ENUMERATED {enabled} OPTIONAL, -- Need R
  pdsch-HARQ-ACK-enhType3DCIfieldDCI-1-3-r18 ENUMERATED {enabled} OPTIONAL, --
Need R
  pdsch-HARQ-ACK-retxDCI-1-3-r18 ENUMERATED {enabled} OPTIONAL, -- Need R
  pucch-sSCellDynDCI-1-3-r18 ENUMERATED {enabled} OPTIONAL, -- Need R
  tdra-FieldIndexListDCI-1-3-r18 SEQUENCE (SIZE (1..32)) OF TDRA-FieldIndexDCI-1-3-r18
OPTIONAL, -- Need R
  tdra-FieldIndexListDCI-0-3-r18 SEQUENCE (SIZE (1..64)) OF TDRA-FieldIndexDCI-0-3-r18
OPTIONAL, -- Need R
  rateMatchListDCI-1-3-r18 SEQUENCE (SIZE (1..16)) OF RateMatchDCI-1-3-r18 OPTIONAL, --
Need R
  zp-CSI-RSListDCI-1-3-r18 SEQUENCE (SIZE (1..8)) OF ZP-CSI-DCI-1-3-r18 OPTIONAL, --
Need R
  tci-ListDCI-1-3-r18 SEQUENCE (SIZE (1..16)) OF TCI-DCI-1-3-r18 OPTIONAL, -- Need R
  srs-RequestListDCI-1-3-r18 SEQUENCE (SIZE (1..16)) OF SRS-RequestCombo-r18 OPTIONAL,
-- Need R
  srs-OffsetListDCI-1-3-r18 SEQUENCE (SIZE (1..8)) OF SRS-OffsetCombo-r18 OPTIONAL, --
Need R
  srs-RequestListDCI-0-3-r18 SEQUENCE (SIZE (1..16)) OF SRS-RequestCombo-r18 OPTIONAL,
-- Need R
  srs-OffsetListDCI-0-3-r18 SEQUENCE (SIZE (1..8)) OF SRS-OffsetCombo-r18 OPTIONAL --
Need R
}
```

For example, TDRA configuration for multi-cell scheduling is based on the following RRC parameters.

```
  tdra-FieldIndexListDCI-1-3-r18 SEQUENCE (SIZE (1..32)) OF TDRA-FieldIndexDCI-1-3-r18
OPTIONAL, -- Need R
  tdra-FieldIndexListDCI-0-3-r18 SEQUENCE (SIZE (1..64)) OF TDRA-FieldIndexDCI-0-3-r18
OPTIONAL, -- Need R
TDRA-FieldIndexDCI-1-3-r18 ::= SEQUENCE (SIZE (2.. maxNrofBWPsInSetOfCells-r18)) OF
INTEGER (0..maxNrofDL-Allocations-1-r18)
TDRA-FieldIndexDCI-0-3-r18 ::= SEQUENCE (SIZE (2.. maxNrofBWPsInSetOfCells-r18)) OF
INTEGER (0..maxNrofUL-Allocations-1-r18)
```

TDRA-FieldIndexDCI-1-3 configure each row of the joint TDRA field table for DL scheduling via DCI format 1_3 containing the applicable TDRA field indexes for multiple BWPs/cells, where the TDRA index for a BWP of a cell points to a corresponding TDRA in the TDRA table applicable for DCI format 1-1, the order of TDRA index in each row refers the BWP-Id for a cell and the order of cells in scheduledCellListDCI-1-3 (i.e., first TDRA index in a row is for the smallest BWP-Id that can be scheduled by the DCI format 1-3, as specified in [REF 2], of the first cell in scheduledCellListDCI-1-3, second TDRA index in a row is for the second smallest BWP-Id that can be scheduled by the DCI format 1-3, as specified in [REF 2], of the first cell and so on), and the number of TDRA indices in a row of TDRA-FieldIndexDCI-1-3 should be the same as the total number of BWPs that can be scheduled by the DCI format 1-3, as specified in [REF 2], across cells included in scheduledCellListDCI-1-3. Similar holds for TDRA field and TDRA configuration for DCI format 0_3.

In certain embodiments, a UE can be provided one or more sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods such as those described herein. A PDSCH reception or a PUSCH transmission on any cell from the set of co-scheduled cells is scheduled by a DCI format that does not schedule any other PDSCH reception or PUSCH transmission on any other cells from the set of co-scheduled cells, such as for example by a DCI format not having a multi-cell scheduling capability or when there is no traffic associated with the other cells at a given time. Additionally, the UE can be indicated via a DCI format in a PDCCH or a MAC CE in a PDSCH a subset of a set of co-scheduled cells, wherein cells of the subset can change across different PDCCH monitoring occasions, for example, as indicated by a corresponding DCI format.

Herein, operation with a cell or a set of cells refers to DL/UL transmissions on the cell(s), such as PDSCH receptions or PUSCH transmissions across the cell(s). Operation can also include other UE procedures or behaviors corresponding to DL/UL transmissions, such as reporting HARQ-ACK information, beam/CSI measurement or reporting, transmission or reception or processing of UL/DL reference signals, and so on.

In one example, the UE can be configured a number of sets of co-scheduled cells by higher layer signaling, such as by a UE-specific RRC configuration. For example, the UE can be configured a first set of cells, such as {cell #0, cell #1, cell #4, cell #7} and a second set {cell #2, cell #3, cell #5, cell #6}. The multiple sets of co-scheduled cells can be scheduled from a same scheduling cell or from different scheduling cells.

In one example, a set of co-scheduled cells can include a PCell/PSCell and one or more SCells. In another example, a set of co-scheduled cells can include only SCells. In one example, a scheduling cell can belong to a set of co-scheduled cells. In another example, the UE does not expect that a scheduling cell belongs to a set of co-scheduled cells.

In one example, per the specifications for the system operation, a set of co-scheduled cells is defined as a set of scheduled cells from a same scheduling cell and additional higher layer configuration is not required for the set of co-scheduled cells. Accordingly, a DCI format for multi-cell scheduling, or other complementary methods, can jointly schedule any number of scheduled cells that have a same scheduling cell.

In another example, a set of co-scheduled cells can have two or more scheduling cells. For example, a UE can receive a DCI format for scheduling multiple co-scheduled cells on a first scheduling cell in a first PDCCH monitoring occasion, or on a second scheduling cell in a second PDCCH monitoring occasion. The DCI format can be one with CRC scrambled with any RNTI or restricted to CRC scrambled by a RNTI provided by UE-specific RRC signaling such as a C-RNTI, CS-RNTI, or MCS-C-RNTI. Such PDCCH monitoring from two scheduling cells can be simultaneous, for example in a same span, or same slot, or can be non-overlapping, such as in different slots (per higher layer configuration, or per indication in a PDCCH or via a MAC CE). The UE may (or may not) expect that both the first scheduling cell and the second scheduling cell can schedule, through PDCCH transmissions in a same time interval such as a span or a slot, transmissions or receptions on a same cell. The UE can also monitor PDCCH for detection of a DCI format providing scheduling only on one cell from the set of co-scheduled cells (single-cell scheduling DCI format). Also, for single-cell scheduling, the UE may be configured to monitor PDCCH for a first scheduled cell on (only) the first scheduling cell, and monitor PDCCH for a second scheduled cell on (only) the second scheduling cell. In such a case, scheduling by two scheduling cells may apply only to multi-cell scheduling and may not apply to single-cell scheduling.

Different sets of co-scheduled cells can have a same number of cells, or can have different numbers of cells, for example, based on a separate configuration of scheduled cells per set of co-scheduled cells. Similarly, different sets of co-scheduled cells can have a same number of cells, or can have different numbers of cells based on a separate configuration, such as by UE-specific RRC signaling, of scheduled cells per set of co-scheduled cells.

A UE can report one or more of: a maximum number of sets of co-scheduled cells, or a maximum number of cells within a set of co-scheduled cells, or a maximum total number of co-scheduled cells across different sets, or a maximum number of co-scheduled cells per PDCCH monitoring occasion, as capability(-ies) to the gNB (e.g., the BS 102). In one example, a number of set(s), or a number of cells within each set of co-scheduled cells, or a total number of co-scheduled cells, or a number of co-scheduled cells per PDCCH monitoring occasion can depend on an operating frequency band or a frequency range.

A UE can also be configured a number of cells that do not belong to any of set(s) of co-scheduled cells. For example, the UE can be configured a cell #8 that does not belong to either the first set or the second set in the previous example.

In one example, restrictions can apply for co-scheduled cells and a UE can expect that co-scheduled cells in a corresponding set: (i) have a same numerology (SCS configuration and cyclic prefix (CP)); or (ii) have a same numerology for respective active DL/UL BWPs; or (iii) have a same duplex configuration, for example, cells have FDD configuration or cells have time division duplexing (TDD) configuration; or (iv) are within a same frequency band (intra-band CA).

A serving cell can belong only to a single set of co-scheduled cells, so that the sets of co-scheduled cells do not include any common cell, or can belong to multiple sets of co-scheduled cells to enable larger scheduling flexibility to a serving gNB. For example, a serving cell can belong to a first set of co-scheduled cells and to a second set of co-scheduled cells, when cells in the first and second sets of co-scheduled cells have a common feature such as a common numerology, duplex configuration, operating frequency band/range, and so on. In a further example, a serving cell can belong to both a first set of co-scheduled cells and to a second set of co-scheduled cells, when the serving cell has a first common feature with cells in the first set of co-scheduled cells, and a second common feature with cells in the second set of co-scheduled cells, wherein the first common feature can be different from the second common feature.

In a first approach, a UE expects to be provided multi-cell scheduling for cells in a set of co-scheduled cells. For example, for a first set of co-scheduled cells including cells {cell #0, cell #1, cell #4, cell #7}, a DCI format schedules PDSCH receptions or PUSCH transmissions on four cells in the first set of co-scheduled cells {cell #0, cell #1, cell #4, cell #7}.

In a second approach, the UE can be provided multi-cell scheduling for a subset of a set of co-scheduled cells. For example, a DCI format can schedule PDSCH receptions or PUSCH transmissions on only two cells, such as {cell #0, cell #4}, from the first set of cells.

In a first option for the second approach, the subset of cells can be indicated by a MAC CE. Such a MAC CE command can include one or more of: an indication for activation or deactivation/release of a subset of cells; an indication for a number of sets of co-scheduled cells; or an indication for a number of subsets of co-scheduled cells from a corresponding number of sets of co-scheduled cells.

In a second option for the second approach, the subset of the set of co-scheduled cells can be provided by a DCI format in a PDCCH/PDSCH. The subset of cells can change between PDCCH monitoring occasions (MOs) for PDSCH/PUSCH scheduling as indicated by a corresponding DCI format. For example, a first DCI format in a first PDCCH MO indicates scheduling on a first subset of cells, while a second DCI format in a second PDCCH MO indicates scheduling on a second subset of cells. In one example, a DCI format for multi-cell scheduling provides indexes of cells that are co-scheduled or provides a configured index for the subset of co-scheduled cells or CIF values corresponding to the co-scheduled cells. For example, RRC signaling can indicate first/second/third indexes and corresponding first/second/third subsets from a set of co-scheduled cells (or first/second/third sets of co-scheduled cells), a fourth index can correspond to cells from the set of co-scheduled cells (or to sets of co-scheduled cells), and a first field of 2 bits in a DCI format can provide a value for the index to indicate the scheduled cells. Include a 1-bit flag field to indicate whether the DCI format is for single-cell scheduling or for multi-cell scheduling in order for a UE to accordingly interpret the other fields of the DCI format. Then, for single-cell scheduling, the first field can be interpreted as a CIF field in case of cross-carrier scheduling. In another example, a DCI format for multi-cell scheduling provides a number of co-scheduled cells, and the indexes of the co-scheduled cells are provided by additional methods, such as by an additional DCI format or by higher layer signaling as described herein.

In one example, a CIF in a DCI format for multi-cell scheduling can indicate a subset of co-scheduled cells from a set of co-scheduled cells, wherein a mapping between values of the CIF and subsets of co-scheduled cells is configured by UE-specific RRC signaling. One value of the CIF can correspond to cells from the set of co-scheduled cells (or sets of co-scheduled cells). The indication can be by an index of the sub-set of co-scheduled cells or by a bitmap mapping to the sub-sets of co-scheduled cells. In another example, separate CIF values are indicated per co-scheduled cell, wherein an indication can be a cell index or a single-cell CIF index, or by a bitmap mapping to each of the co-scheduled cells. When the DCI format is applicable to cells in the set of co-scheduled cells, the DCI format does not include a CIF.

In a third option for the second approach, a UE can determine the indexes for the co-scheduled cells. For example, the UE can determine the indexes for the co-scheduled cells based on a PDCCH monitoring parameter, such as: (i) a CORESET index; or (ii) a search space set index, or a carrier indicator parameter n_CI corresponding to the search space set index; or (iii) a set of CCEs in the search space set or a first/last CCE in the search space set; in which the UE has received the DCI format for multi-cell scheduling.

According to the third option, the UE can be configured a mapping among values for PDCCH monitoring parameters, such as search space sets, and a number of co-scheduled cells or indexes of the co-scheduled cells. In one example, a first value for parameter n_CI in a search space set can indicate a first subset of co-scheduled cells, and a second value for parameter n_CI in the search space set can indicate a second subset of co-scheduled cells. According to this example, the parameter n_CI can correspond to a single cell (behavior) or can correspond to a group of cells, such as a subset/set of co-scheduled cells.

In one example, the UE can be configured different search space sets for monitoring downlink DCI format(s) for multi-cell scheduling compared to uplink multi-cell scheduling. For example, the UE can be configured first search space set(s) for monitoring a DCI format 1_3 for multi-cell scheduling of PDSCHs for one or multiple set(s) of co-scheduled cells, and second search space set(s) for monitoring a DCI format 0_3 for multi-cell scheduling of PUSCHs for one or multiple set(s) of co-scheduled cells. In one example, such search space sets can also include DCI formats one or more downlink DCI format(s) such as 1_1 or 1_2 for single-cell scheduling of a PDSCH, or one or more uplink DCI format(s) such as 0_1 or 0_2 for single-cell scheduling of a PUSCH. In another example, such search space sets include DCIs format(s) for single-cell scheduling only for a corresponding link direction. For example, a search space set for monitoring DCI format for 1_3 for multi-cell scheduling of PDSCHs can only include DCI formats 1_1 or 1_2 for single-cell scheduling of a PDSCH (and not DCI formats 0_1 or 0_2 for single-cell scheduling of a PUSCH). Similar, a search space set for monitoring DCI format for 0_3 for multi-cell scheduling of PUSCHs can only include DCI formats 0_1 or 0_2 for single-cell scheduling of a PUSCH (and not DCI formats 1_1 or 1_2 for single-cell scheduling of a PDSCH). In one example, the UE does not expect that a search space set for monitoring a multi-cell scheduling is also configured for monitoring DCI formats for single-cell scheduling. It is noted that, a DCI format for multi-cell scheduling may be used for single-cell scheduling as well. The methods herein can be beneficial, for example, to avoid waste of PDCCH candidates when UE has no or infrequent UL traffic, as the sizes of downlink and uplink DCI formats for multi-cell scheduling (or single-cell scheduling) can be different.

It is noted that, when a cell is configured to be in a set of co-scheduled cells, the UE can still receive (a PDCCH with) a DCI format that schedules a PDSCH reception or PUSCH transmission only on the cell (single-cell scheduling DCI format). The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a corresponding field in the DCI format.

A set of DL/UL transmissions on a respective set/subset of cells that are jointly scheduled by a single DCI format, or by using complementary methods such as those described herein, can refer to multiple PDSCHs or multiple PUSCHs that may or may not overlap in time. For example, the UE can be indicated to receive multiple PDSCHs or to transmit multiple PUSCHs on multiple co-scheduled cells wherein receptions/transmissions are in a same slot or at least one reception/transmission is in a different slot than the remaining ones.

Multi-cell scheduling can be an optional UE feature with capability signaling that can additionally be separate for PDSCH receptions and for PUSCH transmissions. For example, a UE can report a capability for a maximum number of {2, 4, 8, 16} co-scheduled cells for the DL and a maximum of {2, 4} co-scheduled cells for the UL.

In certain embodiments, a UE that is configured for multi-cell scheduling can be provided a first set of cell-common scheduling information parameters, whose values apply to co-scheduled cells, and a second set of cell-specific scheduling information parameters, whose values apply for each corresponding co-scheduled cell. The UE can determine cell-common and cell-specific scheduling information parameters based on the specifications of the system operation, or based on higher layer configuration. For some cell-specific scheduling information parameters, the UE can be provided differential values compared to a reference value wherein the reference value can correspond, for example, to a first scheduled cell from a set of scheduled cells.

For a UE that is configured a number of sets of co-scheduled cells, a DCI format for multi-cell scheduling can provide complete or partial scheduling information for cell-common or cell-specific scheduling parameters, for multiple PDSCH receptions or multiple PUSCH transmissions on respective multiple co-scheduled cells. When the DCI format for multi-cell scheduling provides partial scheduling information, the UE can determine remaining scheduling information from UE-specific RRC signaling, or by using other complementary methods.

In one example, a DCI format for multi-cell scheduling can have a same size as a DCI format for single cell scheduling. This can enable maintaining a total number of DCI format sizes when supporting multi-cell scheduling and avoid fragmentation of a number of PDCCH candidates that a UE can monitor over an increased number of DCI format sizes, thereby avoiding having a smaller number of PDCCH candidates per DCI format size. In another example, the UE does not expect to receive a DCI format for multi-cell scheduling that is same as or has a same size as a DCI format 1_0 or 0_0 as a differentiation between single-cell scheduling and multi-cell scheduling may not be feasible since an additional field to provide such differentiation may not be feasible to include in a DCI format 1_0 or 0_0.

Various embodiments can also apply to various other scenarios such as when a UE (e.g., the UE 116) is jointly scheduled to receive/transmit multiple PDSCHs/PUSCHs: (i) from/to multiple transmission-reception points (TRPs) or other communication entities, such as multiple distributed units (DUs) or multiple remote radio heads (RRHs) and so on, for example, in a distributed MIMO operation, wherein TRPs/DUs/RRHs can be associated with one or more cells; or (ii) in multiple time units, such as multiple slots or multiple transmission time intervals (TTIs); or (iii) on one or more TRPs/cells, wherein the UE can receive/transmit more than one PDSCH/PUSCH on each co-scheduled TRP/cell; or (iv) for multiple transport blocks (TBs), or for multiple codewords (CWs) corresponding to single TB or multiple TBs; or (v) for multiple semi-persistently scheduled PDSCHs (SPS PDSCHs) or for multiple configured grant PUSCHs (CG PUSCHs) that are jointly activated on one or multiple TRPs/cells.

Accordingly, any reference to “co-scheduled cells” can be replaced with/by “co-scheduled TRPs/DUs/RRHs” or “co-scheduled slots/TTIs”, or “co-scheduled PDSCHs/PUSCHs”, or “co-scheduled TBs/CWs”, or “co-scheduled SPS-PDSCHs/CG-PUSCHs”, and so on. Similar for other related terms, such as “multi-cell scheduling”, and so on.

Various embodiments provide reception of multiple PDSCHs or transmission of multiple PUSCHs on respective cells, including carriers of a same cell such as on an UL carrier (also referred to as, a normal UL (NUL) carrier) or a supplementary uplink (SUL) carrier. The embodiments also apply to cases where scheduling is for a mixture of PDSCHs and PUSCHs. For example, the UE can receive first PDSCHs on respective first cells and can transmit second PUSCHs on respective second cells, wherein the first PDSCHs and the second PUSCHs are jointly scheduled.

If a UE is provided MC-DCI-SetofCells for scheduling by a DCI format PDSCH receptions or PUSCH transmissions on serving cells from a set of more than one serving cells, the UE expects the more than one serving cells to be in a same PUCCH group. The UE provides HARQ-ACK information in a same HARQ-ACK codebook for sets of serving cells that are associated with a same PUCCH group. The UE does not expect to be configured to receive multicast PDSCH on serving cells of the same PUCCH group as serving cells from the sets of serving cells.

If a UE is provided by MC-DCI-SetofCellsToAddModList a number of sets of serving cells and is provided USS sets to monitor PDCCH for detection of DCI format 1_3, the UE separately applies the following procedures for determining a corresponding second Type-2 HARQ-ACK sub-codebook for scheduling cells associated with DCI format 1_3 that
schedules PDSCH receptions on more than one serving cells from a set of serving cells, and/or
does not include a SCell dormancy indication field or the SCell dormancy indication field is reserved, indicates SCell dormancy, and schedules PDSCH reception on one or more serving cells from the set of serving cells
   in the following, and for the purpose of providing HARQ-ACK information corresponding to SCell dormancy indication, the UE assumes that the UE receives a PDSCH on the serving cell associated with fields in DCI format 1_3 used for SCell dormancy indication, as described in Clause 10.3 [of REF3], and that the PDSCH provides one transport block that the UE correctly decodes
      from the procedures for determining a first Type-2 HARQ-ACK sub-codebook that is associated with unicast SPS PDSCH receptions or with any unicast DCI format scheduling a PDSCH reception on a single serving cell, or has associated HARQ-ACK information without scheduling a PDSCH reception. The UE appends the second Type-2 HARQ-ACK sub-codebook to the first Type-2 HARQ-ACK sub-codebook.

Denote by

$${N}_{C - DAI}^{DL}$$

the number of bits for the counter DAI field in DCI format 1_3 and set

$${T}_{D} = {2}^{{N}_{C - DAI}^{DL}} .$$

### Denote by

$${V}_{C - DAI , c , m}^{DL}$$

the value of the counter DAI in a DCI format 1_3 scheduling PDSCH receptions on more than one serving cells among the more than one serving cells, in PDCCH monitoring occasion m according to Table 9.1.3-1 of [REF3]. Denote by

$${V}_{T - DAI , m}^{DL}$$

the value of the total DAI in DCI format 1_3 scheduling PDSCH receptions on more than one cells in PDCCH monitoring occasion m according to Table 9.1.3-1 of [REF3]. The UE assumes a same value of total DAI in DCI formats 1_3 in PDCCH monitoring occasion m that schedule more than one PDSCH receptions on respective more than one serving cells from a set of serving cells.

The UE determines the

$${\tilde{o}}_{0}^{ACK} , {\tilde{o}}_{1}^{ACK} , … , {\tilde{o}}_{{0}_{ACK} - 1}^{ACK} ,$$

for a total number of O_{ACK} HARQ-ACK information bits in the second Type-2 HARQ-ACK sub-codebook according to the following pseudo-code.

```
Set to ${N}_{cells , set}^{DL , max}$ the maximum number of serving cells in ScheduledCell-ListDCI-1-3 of a set of
  serving cells provided by MC-DCI-SetofCells, across the number of sets of serving cells, that
  can be scheduled PDSCH receptions by DCI format 1_3
Set ${N}_{s e t s}^{TB , max}$ to the maximum total number of TBs in PDSCH receptions that can be scheduled by a
  DCI format 1_3 over more than one serving cells in a set of serving cells across the number of
  sets of serving cells
Set ${N}_{s e t s}^{D L}$ to the number of sets of serving cells MC-DCI-SetofCells in a PUCCH group
$Set {N}_{cells}^{DL} to the number of serving cells , across {N}_{sets}^{D L} sets of serving cells in the PUCCH group$
$Set c to the index of serving cells , c = 0 , … , {N}_{cells}^{D L} - 1 , a lower index corresponds to a lower RRC$
  index of a corresponding serving cell
  $- if the UE indicates type 2 - HARQ - ACK - Codebook and receives {N}_{PDSCH , c}^{m} > 1 PDSCHs on a$
    $serving cell c that are scheduled by {N}_{PDSCH , c}^{m} DCI formats 1 \_ 3 in PDCCH receptions at a$
    same PDCCH monitoring occasion m, where
    - each of the DCI formats 1 3 schedules more than one PDSCH receptions on respective
      more than one serving cells,
    - c is the smallest cell index among the respective more than one serving cells, and
    $- c is same across the {N}_{PDSCH , c}^{m} DCI formats 1 \_ 3$
    $the serving cell c is counted {N}_{PDSCH , c}^{m} times for PDCCH monitoring occasion m in increasing$
    $order of the PDSCH reception starting time among the {N}_{PDSCH , c}^{m} PDSCH receptions$
Set mc to the index of a serving cell, in a set of indexes of serving cells arranged in ascending order,
from the set of NDL, max
  $from the sets of {N}_{cells , set}^{DL , max} serving cells , mc = 0 , … , {N}_{cells , set}^{DL , max} - 1$
Set m = 0 − PDCCH monitoring occasion index for detection of a DCI format 1_3 scheduling
  PDSCH receptions on more than one serving cells from a set of serving cells: lower index
  corresponds to earlier PDCCH monitoring occasion
Set j = 0
Set Vₜₑₘₚ = 0
Set Vₜₑₘₚ₂ = 0
Set Vₛ = Ø
Set M to the number of PDCCH monitoring occasions
while m < M
  c = 0
  if harq-ACK-SpatialBundlingPUCCH is not provided,
    $while c < {N}_{cells}^{D L}$
      if PDCCH monitoring occasion m is before an active UL BWP change on the serving cell
      of PUCCH transmission if the UE is provided pucch-sSCellDyn, or an active UL BWP
      change on the PCell if the UE is not provided pucch-sSCellDyn, and the PUCCH
      transmission with the HARQ-ACK information starts at or after a slot for the active UL
      BWP change
        c = c + 1;
      else
        if there is a PDSCH reception on serving cell c that is scheduled by a DCI format
        scheduling more than one PDSCHs that provide respective more than one transport
        blocks with enabled HARQ-ACK information on respective more than one serving
        cells, where the DCI format is associated with a PDCCH reception in PDCCH
        monitoring occasion m and c is the smallest serving cell index among the more than
        one serving cells
          $if {V}_{C - DAI , c , m}^{D L} \leq {V}_{temp}$
            j = j + 1;
end if
${V}_{temp} = {V}_{C - DAI , c , m}^{DL} ;$
$if {V}_{T - DAI , m}^{D L} = ∅$
  ${V}_{temp , 2} = {V}_{C - DAI , c , m}^{D} ;$
else
  ${V}_{temp , 2} = {V}_{T - DAI , m}^{D L} ;$
end if
cnt = 0;
mc = 0;
$while mc < {N}_{cells , set}^{DL , max}$
  if the UE is scheduled PDSCH reception on serving cell mc, if any, from the more
    than one serving cells
    if PDCCH monitoring occasion m is before an active DL BWP change on
    serving cell mc, and the active DL BWP change is not triggered in PDCCH
    monitoring occasion m, and the PUCCH with the HARQ-ACK information
    starts at or after a slot for the active DL BWP change,
      if maxNrofCode WordsScheduledByDCI is 2 for serving cell mc,
        ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = NACK ;$
        ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + 1 + cnt}^{ACK} = NACK ;$
        cnt = cnt + 2;
      else
        ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = NACK ;$
        cnt = cnt + 1;
      end if
    else
      if maxNrofCode WordsScheduledByDCI is 2 for serving cell mc
        ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = HARQ - ACK$
          corresponding to the first transport block of this cell
                ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + 1 + cnt}^{ACK} = HARQ - ACK$
                  corresponding to the second transport block of this cell
                cnt = cnt + 2;
              else
                ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = HARQ - ACK$
                  corresponding to the transport block of this cell
                cnt = cnt + 1;
              end if
            end if
          end if
          mc = mc + 1;
        end while
        $while cnt < {N}_{sets}^{TB , max}$
          ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = NACK ;$
          cnt = cnt + 1;
        end while
        ${V}_{s} = {V}_{s} ⋃ \{ {N}_{sets}^{TB , max} \cdot {T}_{D} \cdot j + {N}_{sets}^{TB , max} \cdot ( {V}_{C - DAI , c , m}^{DL} - 1 ) , … , {N}_{sets}^{TB , max} \cdot {T}_{D} \cdot j + {N}_{sets}^{TB , max} \cdot ( {V}_{C - DAI , c , m}^{DL} - 1 ) + {N}_{sets}^{TB , max} - 1 \} ;$
      end if
      c = c + 1;
    end if
  end while
else
  $while c < {N}_{cells}^{DL}$
    if PDCCH monitoring occasion m is before an active UL BWP change on the serving cell
    of PUCCH transmission if the UE is provided pucch-sSCellDyn, or an active UL BWP
    change on the PCell if the UE is not provided pucch-sSCellDyn, and the PUCCH
    transmission with the HARQ-ACK information starts at or after a slot for the active UL
    BWP change
      c = c + 1;
  else
    if there is a PDSCH reception on serving cell c that is scheduled by a DCI format
    scheduling more than one PDSCHs that provide respective more than one transport
    blocks with enabled HARQ-ACK information on respective more than one serving
    cells, where the DCI format is associated with a PDCCH reception in PDCCH
    monitoring occasion m and c is the smallest serving cell index among the more than
    one serving cells
      $if {V}_{C - DAI , c , m}^{DL} \leq {V}_{temp}$
        j = j + 1;
      end if
      ${V}_{temp} = {V}_{C - DAI , c , m}^{DL} ;$
      $if {V}_{T - DAI , m}^{DL} = ∅$
        ${V}_{temp , 2} = {V}_{T - DAI , m}^{DL} ;$
      else
        ${V}_{temp , 2} = {V}_{T - DAI , m}^{DL} ;$
      end if
      cnt = 0;
      mc = 0;
      $while mc < {N}_{cells , set}^{DL , max}$
        if the UE is scheduled PDSCH reception for transport blocks with enabled
        HARQ-ACK information on serving cell mc, if any, from the more than one
        serving cells
          if PDCCH monitoring occasion m is before an active DL BWP change on
          serving cell mc, and the active DL BWP change is not triggered in PDCCH
          monitoring occasion m, and the PUCCH with the HARQ-ACK information
          starts at or after a slot for the active DL BWP change,
            ${\tilde{o}}_{{N}_{cells , set}^{DL , max} \cdot {T}_{D} \cdot j + {N}_{cells , set}^{DL , max} \cdot ( {V}_{C \cdot DAI , c , m}^{DL} - 1 ) + cnt}^{ACK} = NACK ;$
          else
            if maxNrofCodeWordsScheduledByDCI is 2 for serving cell mc
              if the PDSCH reception provides two transport blocks
                    ${\tilde{o}}_{{N}_{cells , set}^{DL , max} \cdot {T}_{D} \cdot j + {N}_{cells , set}^{DL , max} \cdot ( {V}_{C \cdot DAI , c , m}^{DL} - 1 ) + cnt}^{ACK} = binary AND operation of the HARQ - ACK information bits corresponding to the first and second transport blocks of this cell$
                  else
                    ${\tilde{o}}_{{N}_{cells , set}^{DL , max} \cdot {T}_{D} \cdot j + {N}_{cells , set}^{DL , max} \cdot ( {V}_{C \cdot DAI , c , m}^{DL} - 1 ) + cnt}^{ACK} = HARQ - ACK information bit corresponding to the first transport block of this cell$
                  end if
                else
                  ${\tilde{o}}_{{N}_{cells , set}^{DL , max} \cdot {T}_{D} \cdot j + {N}_{cells , set}^{DL , max} \cdot ( {V}_{C \cdot DAI , c , m}^{DL} - 1 ) + cnt}^{ACK} = HARQ - ACK information bit of this cell$
                    this cell
                end if
                cnt = cnt + 1;
              end if
            end if
            mc = mc + 1;
          end while
          while $cnt < {N}_{cells , set}^{DL , max}$
            ${\tilde{o}}_{{N}_{cells , set}^{DL , max} \cdot {T}_{D} \cdot j + {N}_{cells , set}^{DL , max} \cdot ( {V}_{C \cdot DAI , c , m}^{DL} - 1 ) + cnt}^{ACK} = NACK ;$
            cnt = cnt + 1;
          end while
          ${V}_{s} = {V}_{s} ⋃ \{ {N}_{cells , set}^{DL , max} \cdot {T}_{D} \cdot j + {N}_{cells , set}^{DL , max} \cdot ( {V}_{C \cdot DAI , c , m}^{DL} - 1 ) , {N}_{cells , set}^{DL , max} \cdot {T}_{D} \cdot j + {N}_{cells , set}^{DL , max} \cdot ( {V}_{C \cdot DAI , c , m}^{DL} - 1 ) + 1 … , {N}_{cells , set}^{DL , max} \cdot {T}_{D} \cdot j + {N}_{cells , set}^{DL , max} \cdot ( {V}_{C \cdot DAI , c , m}^{DL} - 1 ) + {N}_{cells , set}^{DL , max} - 1 \} ;$
        end if
        c = c + 1;
      end if
    end while
  end if
  m = m + 1;
  end while
  ${V}_{temp} = ( j mod ( \frac{4}{{T}_{D}} ) ) \times ( \frac{4}{{T}_{D}} ) + {V}_{temp} ;$
  $if UE does not set {V}_{temp 2} = {V}_{T - DAI}^{UL} and {T}_{D} = 2$
    Vₜₑₘₚ₂ = Vₜₑₘₚ;
  end if
  $j = ⌊ \frac{j \times {T}_{D}}{4} ⌋ ;$
  if Vₜₑₘₚ₂ < Vₜₑₘₚ
  j = j + 1;
  end if
  if harq-ACK-SpatialBundlingPUCCH is not provided,
    ${O}^{ACK} = {N}_{sets}^{TB , max} \cdot ( 4 \cdot j + {V}_{temp 2} )$
  else
    ${O}^{ACK} = {N}_{cells , set}^{DL , max} \cdot ( 4 \cdot j + {V}_{temp 2} )$
  end if
  ${\tilde{σ}}_{i}^{A C K} = NACK for any i ∈ \{ 0 , 1 , ⋯ , {O}^{ACK} - 1 \} \backslash {V}_{s} .$
```

If O_{ACK}+O_{SR}+O_{CSI}≤11 and

$${N}_{sets}^{DL} > 0 ,$$

for obtaining a PUCCH Transmission power as described in clause 7.2.1 of [REF3], the UE determines n_{HARQ-ACK}=n_{HARQ-ACK,0}+n_{HARQ-ACK,1}, where n_{HARQ-ACK,0} is the value of n_{HARQ-ACK} for the first Type-2 HARQ-ACK sub-codebook and n_{HARQ-ACK,1} is the value of n_{HARQ-ACK} for the second Type-2 HARQ-ACK sub-codebook that is determined as

$${n}_{HARQ - ACK} = ( ( {V}_{DAI , {m}_{last}}^{DL} - {\sum }_{s = 0}^{{N}_{s e t s}^{D L} - 1} {U}_{DAI , s} ) mod ( {T}_{D} ) ) {N}_{TB , max}^{DL , MC} + {\sum }_{s = 0}^{{N}_{s e t s}^{D L} - 1} {\sum }_{m = 0}^{M - 1} {N}_{m , s}^{received}$$

where
in the following
a DCI format 1_3 schedules more than one PDSCH receptions providing transport blocks with enabled HARQ-ACK information
a dormancy indication is regarded as a PDSCH reception providing a single transport block with enabled HARQ-ACK information

$${v}_{DAI , {m}_{last}}^{DL}$$

is the value of the total DAI field in a last DCI format 1_3 the UE detects in a last PDCCH monitoring occasion within the M PDCCH monitoring occasions where the UE detects at least one DCI format 1_3.

$${V}_{DAI , {m}_{last}}^{DL} = 0$$

if the UE does not detect any DCI format 1_3 in any of the M PDCCH monitoring occasions.
U_{DAI,s} is the total number of DCI format 1_3 that the UE detects within the M PDCCH monitoring occasions for the set s of serving cells. U_{DAI,s}=0 if the UE does not detect any DCI format 1_3 associated with scheduling on set s of serving cells in any of the M PDCCH monitoring occasions.

$${N}_{TB , max}^{DL , MC} = {N}_{sets}^{TB , max}$$

if harq-ACK-SpatialBundlingPUCCH is not provided; otherwise,

$${N}_{TB , max}^{DL , MC} = {N}_{cells , set}^{DL , max} .$$

$${N}_{m , s}^{received}$$

the number of transport blocks, in PDSCH receptions not overlapping with an UL symbol indicated by tdd-UL-DL-ConfigurationCommon or by tdd-UL-DL-ConfigurationDedicated if provided, associated with a DCI format 1_3 that the UE detects in PDCCH monitoring occasion m for set s of serving cells, if harq-ACK-SpatialBundlingPUCCH is not provided
the number of more than one PDSCHs, not overlapping with an UL symbol indicated by tdd-UL-DL-ConfigurationCommon or by tdd-UL-DL-ConfigurationDedicated if provided, scheduled by a DCI format 1_3 that the UE detects in PDCCH monitoring occasion m for set s of serving cells, if harq-ACK-SpatialBundlingPUCCH is provided

5G NR Rel-16 and Rel-17 support multi-slot scheduling using a single DCI format, also referred to as multi-PUSCH or multi-PDSCH scheduling, where the time domain allocations of the multiple PDSCH or multiple PUSCH can be contiguous or discontinuous. Time domain HARQ-ACK bundling is supported for both Type 1 HARQ-ACK codebook and Type 2 HARQ-ACK codebook.

For pusch-TimeDomainAllocationListForMultiPUSCH in pusch-Config, if a row indicates resource allocation for two to eight contiguous PUSCHs and extendedK2 is not configured, K2 given by k2-r16 indicates the slot where a UE (e.g., the UE 116) shall transmit the first PUSCH of the multiple PUSCHs. Each PUSCH has a separate SLIV and mapping type. The number of scheduled PUSCHs is signalled by the number of indicated valid SLIVs in the row of the pusch TimeDomainAllocationListForMultiPUSCH signalled in DCI format 0_1.

For pdsch-TimeDomainAllocationListForMultiPDSCH in pdsch-Config each PDSCH has a separate SLIV, mapping type and K0. The number of scheduled PDSCHs is signalled by the number of indicated SLIVs in the row of the pdsch-TimeDomainAllocationListForMultiPDSCH signalled in DCI format 1_1. If pdsch-TimeDomainAllocationListForMultiPDSCH is provided, it is applicable to DCI format 1_1 only.

The following table includes a number of RRC parameters applicable to multi-PDSCH scheduling.

```
  pdsch-TimeDomainAllocationListForMultiPDSCH-r17 SetupRelease { MultiPDSCH-TDRA-List-
r17 } OPTIONAL -- Need M
MultiPDSCH-TDRA-r17 ::= SEQUENCE {
  pdsch-TDRA-List-r17 SEQUENCE (SIZE(1..maxNrofMultiplePDSCHs-r17)) OF PDSCH-
TimeDomainResourceAllocation-r16,
  ...
}
MultiPDSCH-TDRA-List-r17 ::= SEQUENCE (SIZE(1.. maxNrofDL-AllocationsExt-r17)) OF
MultiPDSCH-TDRA-r17
maxNrofMultiplePDSCHs-r17 INTEGER ::= 8 -- Maximum number of PDSCHs in PDSCH TDRA
list
maxNrofDL-AllocationsExt-r17 INTEGER::= 64 -- Maximum number of PDSCH time domain
resource allocations for multi-PDSCH scheduling
PDSCH-TimeDomainResourceAllocation-r16 ::= SEQUENCE {
  k0-r16 INTEGER(0..32) OPTIONAL, -- Need S
  mappingType-r16 ENUMERATED {typeA, typeB},
  startSymbolAndLength-r16 INTEGER (0..127),
  repetitionNumber-r16 ENUMERATED {n2, n3, n4, n5, n6, n7, n8, n16} OPTIONAL, -- Cond
Formats1-0_1-1_4-0_4-1_4-2
  ...,
  [[
  k0-v1710 INTEGER(33..128) OPTIONAL -- Need S
  ]],
  [[
  repetitionNumber-v1730 ENUMERATED {n2, n3, n4, n5, n6, n7, n8, n16} OPTIONAL -- Cond
Format1-2
  ]]
}
nrofHARQ-BundlingGroups-r17 ENUMERATED {n1, n2, n4} OPTIONAL -- Need R
```

The following includes UE procedure for grouping of code blocks to code block groups (CBGs).

If a UE is configured to receive code block group (CBG) based transmissions by receiving the higher layer parameter PDSCH-CodeBlockGroupTransmission for PDSCH, the UE shall determine the number of CBGs for a transport block reception as M=min(N, C), where N is the maximum number of CBGs per transport block as configured by maxCodeBlockGroupsPerTransportBlock for PDSCH, and C is the number of code blocks in the transport block according to the procedure defined in Clause 7.2.3 of [REF 2].

$$Define {M}_{1} = mod ( C , M ) , {K}_{1} = ⌈ \frac{C}{M} ⌉ , and {K}_{2} = ⌊ \frac{C}{M} ⌋ .$$

If M₁>0, CBG m, m=0, 1, . . . , M₁−1, consists of code blocks with indices m·K₁+k, k=0, 1, . . . , K₁−1. CBG m, m=M₁, M₁+1, . . . , M−1, consists of code blocks with indices M₁·K₁+(m−M₁)·K₂+k, k=0, 1, . . . , K₂−1.

The following includes UE procedures for CBG-based HARQ-ACK codebook determination.

If a UE is provided PDSCH-CodeBlockGroupTransmission for a serving cell, the UE receives a PDSCH scheduled by DCI format 1_1, that includes code block groups (CBGs) of a transport block. The UE is also provided maxCodeBlockGroupsPerTransportBlock indicating a maximum number

$${N}_{HARQ - ACK}^{CBG / TB , max}$$

of CBGs for generating respective HARQ-ACK information bits for a transport block reception for the serving cell.

For a number of C code blocks (CBs) in a transport block, the UE determines a number of CBGs M according to clause 5.1.7.1 of [6, TS 38.214] and determines a number of HARQ-ACK bits for the transport block as

$${N}_{HARQ - ACK}^{CBG / TB} = M .$$

The UE generates an ACK for the HARQ-ACK information bit of a CBG if the UE correctly received all code blocks of the CBG and generates a NACK for the HARQ-ACK information bit of a CBG if the UE incorrectly received at least one code block of the CBG. If the UE receives two transport blocks, the UE concatenates the HARQ-ACK information bits for CBGs of the second transport block after the HARQ-ACK information bits for CBGs of the first transport block.

The HARQ-ACK codebook includes the

$${N}_{HARQ - ACK}^{CBG / TB , max}$$

HARQ-ACK information bits in ascending order of CBG index and, if

$${N}_{HARQ - ACK}^{CBG / TB} < {N}_{HARQ - ACK}^{CBG / TB , max}$$

for a transport block, the UE generates a NACK value for the last

$${N}_{HARQ - ACK}^{CBG / TB , max} - {N}_{HARQ - ACK}^{CBG / TB}$$

HARQ-ACK information bits for the transport block in the HARQ-ACK codebook.

If the UE generates a HARQ-ACK codebook in response to a retransmission of a transport block, corresponding to a same HARQ process as a previous transmission of the transport block, the UE generates an ACK for each CBG that the UE correctly decoded in a previous transmission of the transport block.

If a UE correctly detects each of the

$${N}_{HARQ - ACK}^{CBG / TB}$$

CBGs and does not correctly detect the transport block for the

$${N}_{HARQ - ACK}^{CBG / TB}$$

CBGs, the UE generates a NACK value for each of the

$${N}_{HARQ - ACK}^{CBG / TB}$$

### CBGs.

The following includes UE procedures for Type-2 HARQ-ACK codebook generation for multi-PDSCH scheduling.

If a UE is provided nrofHARQ-BundlingGroups and is not provided harq-ACK-SpatialBundlingPUCCH for a serving cell c, the UE generates HARQ-ACK information over transport block groups (TBGs) for PDSCH receptions where, for a maximum number of

$${N}_{PDSCH}^{max}$$

PDSCH receptions scheduled by a DCI format on the serving cell, a maximum number of TBGs

$${N}_{HARQ - ACK , c}^{TBG , max}$$

is provided by nrofHARQ-BundlingGroups. If the UE detects a DCI format scheduling N_{PDSCH,c} PDSCH receptions on the serving cell c, the UE generates

$${N}_{HARQ - ACK , c}^{TBG , max}$$

HARQ-ACK information bits for the first TBs and, if applicable, generates

$${N}_{HARQ - ACK , c}^{TBG , max}$$

HARQ-ACK information bits for the second TBs as described in clause 9.1.1 of [REF3] by setting

$${N}_{HARQ - ACK}^{CBG / TB , max} = {N}_{HARQ - ACK , c}^{TBG , max}$$

and C=N_{PDSCH,c}. For a TBG associated with at least one PDSCH that does not overlap with an UL symbol indicated by tdd-UL-DL-ConfigurationCommon, or by tdd-UL-DL-ConfigurationDedicated if provided, the UE assumes that TB(s) provided by a PDSCH that overlaps with an UL symbol indicated by tdd-UL-DL-ConfigurationCommon, or by tdd-UL-DL-ConfigurationDedicated if provided, are correctly received. For a TBG associated only with PDSCHs that overlap with UL symbols indicated by tdd-UL-DL-ConfigurationCommon, or by tdd-UL-DL-ConfigurationDedicated if provided, the UE generates a NACK value for the TBG.

If a UE is provided nrofHARQ-BundlingGroups and harq-ACK-SpatialBundlingPUCCH for a serving cell c, the UE generates HARQ-ACK information over PDSCH reception groups for PDSCH receptions scheduled by a DCI format on the serving cell c where a maximum number of PDSCH reception groups,

$${N}_{HARQ - ACK , c}^{TBG , max} ,$$

is provided by nrofHARQ-BundlingGroups. If the UE detects a DCI format scheduling N_{PDSCH,c} PDSCH receptions on the serving cell c, the UE generates

$${N}_{HARQ - ACK , c}^{TBG , max}$$

HARQ-ACK information bits for the N_{PDSCH,c} PDSCH receptions as described in clause 9.1.1 of [REF3] by setting

$${N}_{HARQ - ACK}^{CBG / TB , max} = {N}_{HARQ - ACK , c}^{TBG , max}$$

and C=N_{PDSCH,c}, after binary AND operation of the HARQ-ACK information bits corresponding to the first and second transport blocks of each PDSCH reception. For a PDSCH reception group associated with at least one PDSCH that does not overlap with an UL symbol indicated by tdd-UL-DL-ConfigurationCommon, or by tdd-UL-DL-ConfigurationDedicated if provided, the UE assumes that TBs provided by a PDSCH that overlaps with an UL symbol indicated by tdd-UL-DL-ConfigurationCommon, or by tdd-UL-DL-ConfigurationDedicated if provided, are correctly received. For a PDSCH reception group associated only with PDSCHs that overlap with UL symbols indicated by tdd-UL-DL-ConfigurationCommon, or by tdd-UL-DL-ConfigurationDedicated if provided, the UE generates a NACK value for the PDSCH reception group.

If a UE is provided pdsch-TimeDomainAllocationListForMultiPDSCH and neither provided nrofHARQ-BundlingGroups nor harq-ACK-SpatialBundlingPUCCH for a serving cell c, the UE generates HARQ-ACK information over transport blocks for PDSCH receptions. If the UE detects a DCI format scheduling N_{PDSCH,c} PDSCH receptions on the serving cell c, the UE generates N_{PDSCH,c} HARQ-ACK information bits for the first TBs in the ascending order of the starting of PDSCH receptions and, if applicable, generates N_{PDSCH,c} HARQ-ACK information bits for the second TBs in the ascending order of the starting of PDSCH receptions. For a PDSCH reception that overlaps with an UL symbol indicated by tdd-UL-DL-ConfigurationCommon, or by tdd-UL-DL-ConfigurationDedicated if provided, the UE generates a NACK value for the first TB and, if applicable, generates a NACK value for the second TB in the PDSCH reception. If

$${N}_{PDSCH , c} < {N}_{PDSCH , c}^{max} ,$$

the UE generates a NACK value for the last

$${N}_{TB , c}^{DL} \cdot {N}_{PDSCH , c}^{max} - {N}_{TB , c}^{DL} \cdot {N}_{PDSCH , c}$$

HARQ-ACK information bits where

$${N}_{TB , c}^{DL}$$

is the value of maxNrofCodeWordsScheduledByDCI for serving cell c and

$${N}_{PDSCH , c}^{max}$$

is determined by the maximum number of SLIVs amongst rows of the TDRA table configured by pdsch-TimeDomainAllocationListForMultiPDSCH.

If a UE is provided pdsch-TimeDomainAllocationListForMultiPDSCH and harq-ACK-SpatialBundlingPUCCH and not provided nrofHARQ-BundlingGroups for a serving cell c, the UE generates HARQ-ACK information over PDSCH receptions for PDSCH receptions scheduled by a DCI format on the serving cell c. If the UE detects a DCI format scheduling N_{PDSCH,c} PDSCH receptions on the serving cell c, the UE generates N_{PDSCH,c} HARQ-ACK information bits for the PDSCH receptions in the ascending order of the starting of PDSCH receptions after binary AND operation of the HARQ-ACK information bits corresponding to the first and second transport blocks of each PDSCH reception. For a PDSCH reception that overlaps with an UL symbol indicated by tdd-UL-DL-ConfigurationCommon, or by tdd-UL-DL-ConfigurationDedicated if provided, the UE generates a NACK value for the PDSCH reception. If

$${N}_{PDSCH , c} < {N}_{PDSCH , c}^{max} ,$$

the UE generates a NACK value for the last

$${N}_{PDSCH , c}^{max} - {N}_{PDSCH , c}$$

HARQ-ACK Information bits.

If a UE
is provided pdsch-TimeDomainAllocationListForMultiPDSCH and, if provided, nrofHARQ-BundlingGroups with value

$${N}_{HARQ - ACK}^{TBG , max} > 1 for {N}_{cells}^{DL , TBG}$$

serving cells; and
is not provided pdsch-TimeDomainAllocationListForMultiPDSCH or is provided nrofHARQ-BundlingGroups with value

$${N}_{HARQ - ACK}^{TBG , max} = 1 , for {N}_{cells}^{DL , TB}$$

serving cells where

$${N}_{cells}^{DL , TB} + {N}_{cells}^{DL , TBG} = {N}_{cells}^{D L}$$

the UE determines the

$${õ}_{0}^{ACK} , {õ}_{1}^{ACK} , … , {õ}_{{o}_{{ACK}^{- 1}}}^{ACK}$$

according to the previous pseudo-code with the following modifications

$${N}_{cells}^{DL}$$

is used for the determination of a first HARQ-ACK sub-codebook for
SPS PDSCH reception,
any DCI format having associated HARQ-ACK information without scheduling PDSCH reception, and
PDSCH reception scheduled by a DCI format scheduling one PDSCH
PDSCH reception with

$${N}_{HARQ - ACK}^{TBG , max} = 1$$

for TBG-based HARQ-ACK information on the

$${N}_{cells}^{DL , TB}$$

serving cells,

$${N}_{cells}^{DL}$$

is replaced by

$${N}_{cells}^{DL , TBG}$$

for the determination of a second HARQ-ACK sub-codebook corresponding to the

$${N}_{cells}^{DL , TBG}$$

serving cells for TBG-based HARQ-ACK information, or for TB-based HARQ-ACK information corresponding to multiple PDSCH receptions scheduled by a single DCI format, and
if, for an active DL BWP of a serving cell, the UE is not provided coresetPoolIndex or is provided coresetPoolIndex with value 0 for one or more first CORESETs and is provided coresetPoolIndex with value 1 for one or more second CORESETs, and is provided ackNackFeedbackMode=joint, the serving cell is counted as two times where the first time corresponds to the first CORESETs and the second time corresponds to the second CORESETs, and
instead of generating one or two HARQ-ACK information bits per PDSCH for a serving cell from the

$${N}_{cells}^{DL , TBG}$$

serving cells, the UE generates

$${N}_{HARQ - ACK , max}^{TBG , max}$$

HARQ-ACK information bits for the PDSCH receptions scheduled by a DCI format, where

$${N}_{HARQ - ACK , max}^{TBG , max}$$

is the maximum value between

$${N}_{TB , c}^{DL} \cdot {N}_{HARQ - ACK , c}^{TBG , max}$$

across

$${N}_{cells}^{DL , TBG}$$

serving cells if the UE is provided nrofHARQ-BundlingGroups, and

$${N}_{TB , c}^{DL} \cdot {N}_{PDSCH , c}^{max}$$

across

$${N}_{cells}^{DL , TBG}$$

serving cells where the UE is not provided nrofHARQ-BundlingGroups, and

$${N}_{TB , c}^{DL}$$

is the value of maxNrofCodeWordsScheduledByDCI for serving cell c if harq-ACK-SpatialBundlingPUCCH is not provided; else,

$${N}_{TB , c}^{DL} = 1 .$$

If for a serving cell c where the UE is provided nrofHARQ-BundlingGroups, it is

$${N}_{TB , c}^{DL} \cdot {N}_{HARQ - ACK , c}^{TBG , max} < {N}_{HARQ - ACK , max}^{TBG , max} ,$$

the UE generates NACK for the last

$${N}_{HARQ - ACK , max}^{TBG , max} - {N}_{TB , c}^{DL} \cdot {N}_{HARQ - ACK , c}^{TBG , max}$$

HARQ-ACK information bits for serving cell c. If for a serving cell c where the UE is not provided nrofHARQ-BundlingGroups, it is

$${N}_{TB , c}^{DL} \cdot {N}_{PDSCH , c}^{max} < {N}_{HARQ - ACK , max}^{TBG , max} ,$$

the UE generates NACK for the last

$${N}_{HARQ - ACK , max}^{TBG , max} - {N}_{TB , c}^{DL} \cdot {N}_{PDSCH , c}^{max}$$

HARQ-ACK information bits for serving cell c.
The pseudo-code operation when PDSCH-CodeBlockGroupTransmission is provided is not applicable.
The counter DAI value and the total DAI value apply separately for each HARQ-ACK sub-codebook.
The UE generates the HARQ-ACK codebook by appending the second HARQ-ACK sub-codebook to the first HARQ-ACK sub-codebook.

If O_{ACK}+O_{SR}+O_{CSI}≤11 and

$${N}_{cells}^{DL , TBG} > 0 ,$$

the UE also determines n_{HARQ-ACK}=n_{HARQ-ACK,TB}+n_{HARQ-ACK,TBG} for obtaining a PUCCH transmission power, as described in clause 7.2.1 of [REF3], with

$${n}_{HARQ - ACK , TBG} = ( ( {V}_{DAI , {m}_{last}}^{DL} - {\sum }_{c = 0}^{{N}_{cells}^{DL , TBG} - 1} {U}_{DAI , c}^{TBG} ) mod ( {T}_{D} ) ) {N}_{HARQ - ACK , max}^{TBG , max} + {\sum }_{c = 0}^{{N}_{cells}^{DL , TBG} - 1} {\sum }_{m = 0}^{M - 1} {N}_{m , c}^{received , TBG}$$

where
if

$${N}_{cells}^{DL} = 1 , {V}_{DAI , {m}_{last}}^{DL}$$

is the value of the counter DAI in the last DCI format scheduling mor than one PDSCH receptions for any serving cell c form the

$${N}_{cells}^{DL , TBG}$$

serving cells with TBG-based HARQ-ACK information or with TB-based HARQ-ACK information that the UE detects within the M PDCCH monitoring occasions
if

$${N}_{cells}^{DL} > 1 , {V}_{DAI , {m}_{last}}^{DL}$$

is the value of the total DAI in the last DCI format scheduling more than one PDSCH receptions with TBG-based HARQ-ACK information or with TB-based HARQ-ACK information for any serving cell c from the

$${N}_{cells}^{DL , TBG}$$

serving cells that the UE detects within the M PDCCH monitoring occasions

$${V}_{DAI , {m}_{last}}^{DL} = 0 ,$$

if the UE does not detect any DCI format scheduling more than one PDSCH receptions with TBG-based HARQ-ACK information or with TB-based HARQ-ACK information for any serving cell c from the

$${N}_{cells}^{DL , TBG}$$

serving cells in any of the M PDCCH monitoring occasions

$${U}_{DAI , c}^{TBG}$$

is the total number of DCI formats scheduling more than one PDSCH receptions with TBG-based HARQ-ACK information or with TB-based HARQ-ACK information for any serving cell c from the

$${N}_{cells}^{DL , TBG}$$

serving cells that the UL detects within the M PDCCH monitoring occasions for serving cell c

$${U}_{DAI , c}^{TBG} = 0$$

if the UE does not any DCI format scheduling more than one PDSCH receptions for serving cell c in any of the M PDCCH monitoring occasions
if harq-ACK-SpatialBundlingPUCCH is provided,
   if nrofHARQ-BundlingGroups is provided,

$${N}_{m , c}^{received , TBG}$$

is the number of PUSCH groups that include at least one PDSCH not overlapping with a UL symbol indicated by tdd-UL-DL-ConfigurationCommon, or tdd-UL-DL-ConfigurationDedicated if provided, that the UE receives in serving cell c from the

$${N}_{cells}^{DL , TBG}$$

serving cells in PDCCH monitoring occasion m and the UE reports corresponding HARQ-ACK information in the PUCCH
if nrofHARQ-BundlingGroups is not provided,

$${N}_{m , c}^{received , TBG}$$

is the number of PDSCHs that the UE receives in serving cell c from the

$${N}_{cells}^{DL , TBG}$$

serving cells n PDCCH monitoring occasion m and the UE reports corresponding HARQ-ACK information in the PUCCH
if harq-ACK-SpatialBundlingPUCCH is not provided,
   if nrofHARQ-BundlingGroups is provided,

$${N}_{m , c}^{received , TBG}$$

is the number of TBGs including at least one PDSCH not overlapping with an UL symbol indicated by tdd-UL-DL-ConfigurationCommon, or by tdd-UL-DL-ConfigurationDedicated if provided, that the UE receives in serving cell c from the

$${N}_{cells}^{DL , TBG}$$

serving cells in PDCCH monitoring occasion m and the UE reports corresponding HARQ-ACK information in the PUCCH
if nrofHARQ-BundlingGroups is not provided,

$${N}_{m , c}^{received , TBG}$$

is the number of transport blocks in PDSCHs that the UE receives in serving cell c from the

$${N}_{cells}^{DL , TBG}$$

serving cells in PDCCH monitoring occasion m and the UE reports corresponding HARQ-ACK information in the PUCCH.

Various methods and examples throughout the disclosure refer to ‘multi-slot’ and related variations or combinations such as multi-slot scheduling or multi-slot TDRA table, and so on. Such methods can also apply when corresponding UE procedures, such as PDSCH reception or PUSCH transmission, apply to multiple transmissions or receptions that are in a same slot, such as multiple PDSCHs in a same slot or multiple PUSCHs in a same slot, or first PDSCHs/PUSCHs in a first slot, and second PDSCHs/PUSCHs in a second slot, and so on. For example, various methods and examples can also apply when the term ‘multi-slot’ is replaced with ‘multi-PDSCH’ or ‘multi-PUSCH’.

In one embodiment, a UE can be configured a TDRA table for joint multi-cell and multi-slot/PDSCH/PUSCH scheduling. In a first approach, the UE can be configured a single joint table with a number of rows, wherein entries in each row correspond to different cells/BWPs and, for each cell/BWP, a single entry is a provided that is a single TDRA index pointing to a multi-slot/PDSCH/PUSCH TDRA table for the respective cell/BWP. In a second approach, the UE can be configured a single joint table with a number of rows, wherein entries in each row correspond to different cells/BWPs and, for each cell/BWP, multiple entries are provided that are TDRA indexes each pointing to a single-slot TDRA table for the respective cell/BWP.

In a first approach, the UE can be configured a single joint table with a number of rows, wherein entries in each row correspond to different cells/BWPs and, for each cell/BWP, a single entry is a provided that is a single TDRA index pointing to a multi-slot/PDSCH/PUSCH TDRA table for the respective cell/BWP.

For example, a first TDRA table for DCI format 1_3 includes 32 rows, and each row includes 16 entries corresponding to 4 BWPs of 4 cells in a set of co-scheduled cells. For example, each entry, from the 16 entries in a given row for a given cell/BWP, is an index that points to a second multi-slot/PDSCH/PUSCH TDRA table, and is associated with a respective combination of 4 or 8 TDRA entries for respective 4 or 8 slots/PDSCHs. For example, each of the respective 4 of 8 TDRA entries can be indexes to a third TDRA table for single-cell scheduling, or can be explicit SLIV entries.

Table 1A is an example of the first TDRA table (tdra-FieldIndexListDCI-1-3-r19) for multi-cell/multi-slot/PDSCH scheduling based on the first approach.

TABLE 1A

| | BWP#1 | BWP#2 | BWP#1 | BWP#2 | BWP#1 | BWP#2 | BWP#1 | BWP#2 |
|---|---|---|---|---|---|---|---|---|
| | of | of | of | of | of | of | of | of |
| | cell#1 | cell#1 | cell#2 | cell#2 | cell#3 | cell#3 | cell#4 | cell#4 |
| TDRA- | 2 | 1 | 3 | 2 | 1 | 4 | 2 | 1 |
| FieldIndexDCI- | | | | | | | | |
| 1-3-r19 | | | | | | | | |
| #1 | | | | | | | | |
| TDRA- | 1 | 2 | 4 | 1 | 3 | 2 | 2 | 1 |
| FieldIndexDCI- | | | | | | | | |
| 1-3-r19 | | | | | | | | |
| #2 | | | | | | | | |
| . . . | | | | | | | | |
| TDRA- | 61 | 59 | 60 | 63 | 58 | 62 | 57 | 61 |
| FieldIndexDCI- | | | | | | | | |
| 1-3-r19 | | | | | | | | |
| #32 | | | | | | | | |

The values/indexes 2, 1, and 61, provided in the column corresponding to ‘BWP #1 of cell #1’ and respectively in rows TDRA-FieldIndexDCI-1-3-r19 #1, TDRA-FieldIndexDCI-1-3-r19 #2, and TDRA-FieldIndexDCI-1-3-r19 #32, refer to respective row indexes 2+1=3, 1+1=2, and 61+1=62 of a second multi-PDSCH TDRA table (MultiPDSCH-TDRA-List-r17) configured for BWP #1 of cell #1.

Table 1B is an example of the second TDRA table (MultiPDSCH-TDRA-List-r17) for multi-slot/PDSCH scheduling on BWP #1 of cell #1.

TABLE 1B

| | PDSCH#1 | PDSCH#2 | PDSCH#3 | PDSCH#4 | PDSCH#5 | PDSCH#6 | PDSCH#7 | PDSCH#8 |
|---|---|---|---|---|---|---|---|---|
| MultiPDSCH-TDRA- | 0, A, 10 | 1, A, 6 | 2, A, 13 | 3, A, 19 | | | | |
| r17#1 | | | | | | | | |
| MultiPDSCH-TDRA- | 0, A, 4 | | | | | | | |
| r17#2 | | | | | | | | |
| MultiPDSCH-TDRA- | 0, B, 7 | 0, B, 17 | | | | | | |
| r17#3 | | | | | | | | |
| . . . | | | | | | | | |
| MultiPDSCH-TDRA- | 0, A, 74 | 1, A, 83 | 2, A, 91 | 3, A, 67 | 4, A, 43 | 5, A, 82 | 6, A, 89 | 7, A, 77 |
| r17#61 | | | | | | | | |
| MultiPDSCH-TDRA- | 0, A, 99 | 1, A, 59 | | | | | | |
| r17#62 | | | | | | | | |
| MultiPDSCH-TDRA- | 0, B, 44 | 0, B, 52 | 1, B, 81 | 1, B, 90 | 2, B, 79 | 2, B, 64 | 3, B, 51 | 3, B, 60 |
| r17#63 | | | | | | | | |

Each combination such as (0, A, 10) for PDSCH #1 in MultiPDSCH-TDRA-r17 #1 refers to a PDSCH-TimeDomainResourceAllocation-r16 that includes a respective collection of a K0 value, a mapping type A or B, and an SLIV.

For example, TDRA configuration for the first approach to multi-slot/multi-cell scheduling can be based on the following example chain of RRC parameters, wherein the UE does not expect to be configured a repetitionNumber within a configuration for PDSCH-TimeDomainResourceAllocation.

```
  tdra-FieldIndexListDCI-1-3-r19 SEQUENCE (SIZE (1..32)) OF TDRA-FieldIndexDCI-1-3-r19
OPTIONAL, -- Need R
TDRA-FieldIndexDCI-1-3-r19 ::= SEQUENCE (SIZE (2.. maxNrofBWPsInSetOfCells-r18)) OF
INTEGER (0.. maxNrofDL-AllocationsExt-1-r17)
maxNrofDL-AllocationsExt-1-r17 INTEGER::= 63 -- Maximum number of PDSCH time domain
resource allocations for multi-PDSCH scheduling minus 1
MultiPDSCH-TDRA-List-r17 ::= SEQUENCE (SIZE(1.. maxNrofDL-AllocationsExt-r17)) OF
MultiPDSCH-TDRA-r17
MultiPDSCH-TDRA-r17 ::= SEQUENCE {
  pdsch-TDRA-List-r17 SEQUENCE (SIZE(1..maxNrofMultiplePDSCHs-r17)) OF PDSCH-
TimeDomainResourceAllocation-r16,
  ...
}
PDSCH-TimeDomainResourceAllocation-r16 ::= SEQUENCE {
  k0-r16 INTEGER(0..32) OPTIONAL, -- Need S
  mappingType-r16 ENUMERATED {typeA, typeB},
  startSymbolAndLength-r16 INTEGER (0..127),
  repetitionNumber-r16 ENUMERATED {n2, n3, n4, n5, n6, n7, n8, n16} OPTIONAL, -- Cond
Formats1-0_1-1_4-0_4-1_4-2
  ...,
  [[
  k0-v1710 INTEGER(33..128) OPTIONAL -- Need S
  ]],
  [[
  repetitionNumber-v1730 ENUMERATED {n2, n3, n4, n5, n6, n7, n8, n16} OPTIONAL -- Cond
Format1-2
  ]]
}
```

For example, the single joint TDRA table is a first TDRA table such as tdra-FieldIndexListDCI-1-3 (as in [REF 4] or a variation of such table) that includes a first number of first rows, wherein:

Each row, from the first rows, includes a first number of entries/indexes, wherein the number of entries/indexes in each row is equal to a total number of BWPs (DL BWPs for DCI format 1_3, or UL BWPs for DCI format 0_3) that can be scheduled by a multi-cell scheduling DCI format (DCI format 1_3 for PDSCH scheduling and DCI format 0_3 for PUSCH scheduling) across cells included in the set of cells (scheduledCellListDCI-0-3 for PUSCH scheduling, and scheduledCellListDCI-1-3 for PDSCH scheduling).

The first entries/indexes in a row, from the first rows, are in ascending order of first a BWP index and second a cell index. For example, for 4 cells each with 2 BWPs/cell, the ordering is {BWP #1 of cell #1, BWP #2 of cell #1, BWP #1 of cell #2, BWP #2 of cell #2, BWP #1 of cell #3, BWP #2 of cell #3, BWP #1 of cell #4, BWP #2 of cell #4}. In other words, a first TDRA index in a first row is for the smallest BWP-Id that can be scheduled by the DCI format 1-3, as specified in [REF 2], of the first cell in scheduledCellListDCI-1-3, a second TDRA index in the first row is for the second smallest BWP-Id that can be scheduled by the DCI format 1-3, as specified in [REF 2], of the first cell, and so on.

An entry/index, corresponding to a BWP of a cell, in a row, such as the first row, points to a corresponding second TDRA index in a second TDRA table that is applicable for DCI format 1_1, such as an index that points to a second TDRA table for multi-slot/PDSCH scheduling. For example, the UE (e.g., the UE 116) is configured, for each BWP of each cell, a respective second TDRA table pdsch-TimeDomainAllocationListForMultiPDSCH for multi-slot PDSCH scheduling, that includes a second number of third TDRA indexes that are respectively associated with a combination of a second number of TDRA indexes for multiple slots.

The respective third TDRA indexes can point to a respective third TDRA table for single-slot scheduling on the respective BWP/cell. Alternatively, the respective third TDRA indexes are respective SLIV entries for single-slot scheduling on the respective BWP/cell.

In a second approach, the UE can be configured a single joint table with a number of rows, wherein entries in each row correspond to different cells/BWPs, and for each cell/BWP, multiple entries are provided that are TDRA indexes each pointing to a single-slot TDRA table for the respective cell/BWP.

For example, the first TDRA table for DCI format 1_3 includes 32 rows, and each row includes up to 16*4 (or 16*8) entries, for 4 BWPs of 4 cells in a set of co-scheduled cells. For example, for a given cell/BWP, each row includes 4 indexes (or 8 indexes) that point to a second single-slot TDRA table or directly provide 4 SLIV entries (or 8 SLIV entries), and are associated with respective 4 (or 8) slots/PDSCHs.

Table 2A is an example of the first TDRA table (such as tdra-FieldIndexListDCI-1-3-r19 or pdsch-TimeDomainAllocationListForMultiPDSCHandMultiCell) for multi-cell/multi-slot scheduling based on the second approach.

TABLE 2A

| | BWP#1 | BWP#2 | BWP#1 | BWP#2 | BWP#1 | BWP#2 | BWP#1 | BWP#2 |
|---|---|---|---|---|---|---|---|---|
| | of | of | of | of | of | of | of | of |
| | cell#1 | cell#1 | cell#2 | cell#2 | cell#3 | cell#3 | cell#4 | cell#4 |
| TDRA- | (14) | (4, 7) | (1, 2, 5, 6) | (3, 11) | (8) | (1, 9) | (12, 14) | (1, 2, 3, 4, |
| FieldIndexDCI- | | | | | | | | 5, 6, 7, 8) |
| 1-3-r19 | | | | | | | | |
| #1 | | | | | | | | |
| TDRA- | (1, 2, 5, 9) | (2, 4, 6, 8, | (3, 9) | (2, 7) | (1, 5) | (2) | (3, 6, 8, | (3, 7) |
| FieldIndexDCI- | | 10, 12, | | | | | 10, 13, | |
| 1-3-r19 | | 14, 16) | | | | | 15) | |
| #2 | | | | | | | | |
| . . . | | | | | | | | |
| TDRA- | (2, 3, 6, 8, | (2, 8, 10, | (1, 4) | (3, 6, 9, | (5, 15) | (2, 10) | (2, 3, 5, 7, | (4, 6, 8, |
| FieldIndexDCI- | 11, 13, | 13) | | 12) | | | 11, 13) | 10, 12, |
| 1-3-r19 | 14, 15) | | | | | | | 14, 16) |
| #32 | | | | | | | | |

For example, the combination of indexes (14), provided in the column corresponding to ‘BWP #1 of cell #1’ and in row corresponding to TDRA-FieldIndexDCI-1-3-r19 #1, configures a single TDRA value for a single PDSCH per row index 14 of a second single-PDSCH/slot TDRA table (PDSCH-TimeDomainResourceAllocationList-r16) that is provided for BWP #1 of cell #1, as shown in the example Table 2-B herein. For example, TDRA row index 14 refers to K0 value=2, mapping type A, and SLIV=91.

For example, the combination of indexes (1,2,5,9), provided in the column corresponding to ‘BWP #1 of cell #2’ and in row TDRA-FieldIndexDCI-1-3-r19 #2, configures four TDRA values for respective four PDSCHs per row indexes 1, 2, 5, and 9 of the second single-PDSCH/slot TDRA table (PDSCH-TimeDomainResourceAllocationList-r16) configured for BWP #1 of cell #1, as shown in the example Table 2-B herein. For example, row index 1 refers to K0 value=0, mapping type A, and SLIV=4. Similar for row indexes 2, 5, and 9.

Similar discussion holds for the combination of indexes (2,3,6,8,11,13,14,15) indicated by TDRA-FieldIndexDCI-1-3-r19 #32 that configures eight TDRA values for eight PDSCHs on BWP #1 of cell #1.

Table 2B is an example of the second TDRA table (such as PDSCH-TimeDomainResourceAllocationList-r16) for single-cell/single-slot scheduling on BWP #1 of cell #1.

TABLE 2B

| | | Mapping | |
|---|---|---|---|
| | K0 | type | SLIV |
| PDSCH- | 0 | A | 4 |
| TimeDomainResourceAllocation- | | | |
| r16 #1 | | | |
| PDSCH- | 0 | A | 10 |
| TimeDomainResourceAllocation- | | | |
| r16 #2 | | | |
| PDSCH- | 1 | B | 7 |
| TimeDomainResourceAllocation- | | | |
| r16 #3 | | | |
| . . . | | | |
| PDSCH- | 2 | A | 91 |
| TimeDomainResourceAllocation- | | | |
| r16 #14 | | | |
| MultiPDSCH-TDRA- | 3 | A | 53 |
| r17#15 | | | |
| PDSCH- | 4 | B | 81 |
| TimeDomainResourceAllocation- | | | |
| r16 #16 | | | |

For example, TDRA configuration for the first approach to multi-slot/multi-cell scheduling can be based on the following example chain of RRC parameters, wherein the UE does not expect to be configured a repetitionNumber within a configuration for PDSCH-TimeDomainResourceAllocation.

```
  tdra-FieldIndexListDCI-1-3-r19 SEQUENCE (SIZE (1..32)) OF TDRA-FieldIndexDCI-1-3-r19
OPTIONAL, -- Need R
TDRA-FieldIndexDCI-1-3-r19 ::= SEQUENCE (SIZE (2.. maxNrofBWPsInSetOfCells-r18)) OF
MultiPDSCH-TDRA-r17
MultiPDSCH-TDRA-r17 ::= SEQUENCE {
  pdsch-TDRA-List-r17 SEQUENCE (SIZE(1..maxNrofMultiplePDSCHs-r17)) OF PDSCH-
TimeDomainResourceAllocation-r16,
  ...
}
PDSCH-TimeDomainResourceAllocation-r16 ::= SEQUENCE {
  k0-r16 INTEGER(0..32) OPTIONAL, -- Need S
  mappingType-r16 ENUMERATED {typeA, typeB},
  startSymbolAndLength-r16 INTEGER (0..127),
  repetitionNumber-r16 ENUMERATED {n2, n3, n4, n5, n6, n7, n8, n16} OPTIONAL, -- Cond
Formats1-0_1-1_4-0_4-1_4-2
  ...,
  [[
  k0-v1710 INTEGER(33..128) OPTIONAL -- Need S
  ]],
  [[
  repetitionNumber-v1730 ENUMERATED {n2, n3, n4, n5, n6, n7, n8, n16} OPTIONAL -- Cond
Format1-2
  ]]
}
```

For example, the single joint TDRA table is a first TDRA table such as tdra-FieldIndexListDCI-1-3-r19 or pdsch-TimeDomainAllocationListForMultiPDSCHandMultiCell that includes a first number of first rows, wherein:

Each row, from the first rows, includes a first number of entries/indexes, wherein the number of entries/indexes in each row is equal to a total number of slots/PUSCHs/PDSCHs that can be scheduled by a multi-cell scheduling DCI format (DCI format 1_3 for PDSCH scheduling and DCI format 0_3 for PUSCH scheduling) across BWPs (DL BWPs for DCI format 1_3, or UL BWPs for DCI format 0_3) and across cells included in the set of cells (scheduledCellListDCI-0-3 for PUSCH scheduling, and scheduledCellListDCI-1-3 for PDSCH scheduling).

The first entries/indexes in a row, from the first rows, are in ascending order of first a BWP index and second a cell index. For example, for 4 cells each with 2 BWPs, the ordering is {BWP #1 of cell #1, BWP #2 of cell #1, BWP #1 of cell #2, BWP #2 of cell #2, BWP #1 of cell #3, BWP #2 of cell #3, BWP #1 of cell #4, BWP #2 of cell #4}. In other words, first S11 TDRA indexes in a first row are for the smallest BWP-Id that can be scheduled by the DCI format 1-3, as specified in [REF 2], of the first cell in scheduledCellListDCI-1-3, second S21 TDRA indexes in the first row are for the second smallest BWP-Id that can be scheduled by the DCI format 1-3, as specified in [REF 2], of the first cell, and so on. Values S1, S2, and so on can be same or different, and are determined based on higher layer structure for the first TDRA table. For example, respective values S1, S2, and so on for a first cell/BWP can be same as or different from respective values S1, S2, and so on for a second cell/BWP.

Each of the Sij entries/indexes, corresponding to a BWP-Id i of a cell index j, in a row, such as the first row, points to a corresponding second TDRA index in a second TDRA table that is applicable for DCI format 1_1, such as an index that points to a second TDRA table for single-slot scheduling. For example, the UE is configured, for each BWP of each cell, a respective second TDRA table by pdsch-TimeDomainAllocationList for single-slot PDSCH scheduling. The second TDRA table includes a second number of TDRA indexes that are respectively associated with a second number of TDRA values for one slot. Alternatively, each of the Sij entries/indexes are an SLIV entry that provides a TDRA value for a corresponding slot/PDSCH.

For example, when a UE is configured a set of cells for multi-cell scheduling by scheduledCellListDCI-1-3, the UE does not expect to be also configured/provided pdsch-TimeDomainAllocationListForMultiPDSCH for a cell/BWP from the set of cells. Similar for the applicability of TDRA table, provided by pusch-TimeDomainAllocationListForMultiPUSCH, with DCI formats 0_0/0_1/0_2 and DCI format 0_3, when the UE is configured scheduledCellListDCI-0-3.

In various methods, such as the first approach or the second approach, there can be a restriction on special cases where a DCI format 0_3/1_3 schedules one cell or one PUSCH/PDSCH per cell. For example, when a UE receives a DCI format 0_3/1_3 that schedules a single cell, the UE does not expect the DCI format 0_3/1_3 to schedule multiple slots/PUSCHs/PDSCHs on the single cell. For example, the UE expects that the DCI format 0_3/1_3 indicates a TDRA value that is not associated with multiple SLIV values for the single cell. Alternatively, when a UE is configured pusch-TimeDomainAllocationListForMultiPUSCH or pdsch-TimeDomainAllocationListForMultiPDSCH that applies to a DCI format 0_3/1_3, or when a TDRA table applicable to the DCI format 0_3/1_3 such as pdsch-TimeDomainAllocationListForMultiPDSCHandMultiCell is configured with multiple TDRA indexes for each BWP/cell, the UE does not expect that the DCI format 0_3/1_3 schedules on only one cell from a corresponding set of cells.

In another example, such restrictions are not applicable. For example, joint operation with multiple slots/PUSCHs/PDSCHs on a single cell is not supported by SC-DCI formats, while supported by MC-DCI formats 0_3/1_3. For example, while the UE expects that an SC-DCI format such as DCI format 0_1/1_1 does not schedule multiple slots/PUSCHs/PDSCHs on a cell, the UE can receive a DCI format 0_3/1_3 that schedules multiple slots/PUSCHs/PDSCHs on the cell and does not schedule any PUSCH or PDSCH on any other cells.

In various methods, such as the first approach or the second approach, there a UE can be configured a first row in a TDRA table for DCI format 0_3/1_3 that points to scheduling a first number, such as 4, of slots/PUSCHs/PDSCHs on a given cell/BWP, and a second row in the same TDRA table that points to scheduling a second number, such as 2, of slots/PDSCHs/PUSCHs on the same given cell/BWP. In other examples, the UE expects to be configured a TDRA table for DCI format 0_3/1_3 that points to a same number, such as 4 (or 8), slots/PUSCHs/PDSCHs for a given cell/BWP.

In various methods, such as the first approach or the second approach, a TDRA table for DCI format 0_3/1_3 can indicate scheduling on multiple contiguous time-domain resources/slots, or multiple non-contiguous time-domain resources/slots.

In one example, the UE determines whether a DCI format 0_3/1_3 schedules one PDSCH or multiple PDSCHs on a cell from a number of co-scheduled cells implicitly, for example, based on whether an indicated value for a TDRA field in the DCI format 0_3/1_3 points to one SLIV entry/value or multiple SLIV entries/values for the cell. For example, there may be no explicit field in the DCI format 0_3/1_3 or in the higher layer configuration for the cell or that for the set of cells that distinguishes single-slot scheduling from multi-slot/PDSCH/PUSCH scheduling for the cell or for the set of cells.

In another example, the UE can be provided an explicit indication to distinguish single-slot scheduling from multi-slot/PDSCH/PUSCH scheduling for a DCI format 0_3/1_3. For example, the DCI format 0_3/1_3 can include a field, such as a one-bit flag, that indicates single-slot scheduling or multi-slot/PDSCH/PUSCH scheduling. For example, the UE can be configured TDRA tables for both single-slot scheduling and multi-slot/PDSCH/PUSCH scheduling for first cells in a set of cells for multi-cell scheduling scheduledCellListDCI-1-3, and the field/one-bit flag indicates which TDRA table to apply for the first cells. For example, the UE may be configured, for second cells in the set of cells, a single respective TDRA table for only single-slot scheduling or only multi-slot/PDSCH/PUSCH scheduling, and the UE applies the corresponding TDRA table without regards of the field/one-bit flag. For example, such indication can be provided by a MAC-CE or by higher layer configuration, instead of a field/one-bit flag in the DCI format 0_3/1_3.

In various approaches, such as the first approach or the second approach, the specifications of system operation can predetermine a maximum number of PUSCHs or PDSCHs that can be scheduled by a DCI format 0_3/1_3.

In one example, the maximum number can be per cell, such as per scheduled/serving cell in a set of cells for multi-cell scheduling, such as scheduledCellListDCI-0-3 or scheduledCellListDCI-1-3. For example, a DCI format 0_3/1_3 can schedule up to 4 PUSCHs/PDSCHs, or up to 8 PUSCHs/PDSCHs per cell. For example, the maximum number can be a UE capability that is reported by the UE.

In another example, the maximum number can be additionally across different cells scheduled by a DCI format 0_3/1_3. For example, the UE can be subject to a first maximum number of PUSCHs/PDSCHs per scheduled cell by a DCI format 0_3/1_3, and a second maximum number of a total number of PUSCHs/PDSCHs across scheduled cells by a DCI format 0_3/1_3. For example, the second maximum number can be smaller than a product of a number (or a maximum number) of cells in the set of cells and the first maximum number. For example, when a DCI format 0_3/1_3 can schedule up to 4 cells, the first maximum number can be 8, while the second maximum number can be 16 (that is smaller than 4 cells times 4 PUSCHs/PDSCHs per cells). For example, the first and second maximum numbers can be UE capabilities that are reported by the UE.

For example, the UE can report a first capability for multi-cell multi-PDSCH scheduling (e.g., FG 66-3) and a separate/second capability for multi-cell multi-PUSCH scheduling (such as 66-4). For example, the UE can report the first/second capabilities per band combination (BC) or per band. For example, the UE reports FG 66-3 and/or FG 66-4 in each BC that the UE reports a third/fourth capability (FG 49-1/1b or FG 49-2/2b) for multi-cell scheduling with single PDSCH or with single-PUSCH scheduling, respectively.

In another example, the UE additionally reports a number of cells/CCs/bands from a BC in which the UE reports the FG 66-3 and/or 66-4. For example, the UE can report FG 66-3 or 66-4 in a BC with 4 bands/CCs/cells, and the UE can report that the UE can support multi-PDSCH scheduling (or multi-PUSCH) scheduling on 2 of the 4 bands/CCs/cells, without indicating which 2 bands/CCs/cells among the 4 bands/CCs/cells.

In another example, the UE reports the first/second capability in a BC manner, and also indicates which bands/CCs/cells in the BC support the multi-PDSCH or multi-PUSCH scheduling.

In another example, the UE can report the first/second capability in a per band manner. For example, the UE only reports such first/second capability in bands from BCs that the UE can support multi-cell scheduling (e.g., FG 49-1/1b or FG 49-2/2b). For example, the feature is reported for a band, and it is supported only in a BC for which the UE supports FG49-1 or FG49-1b.

In one embodiment, when a UE is configured for joint multi-cell and multi-slot/PDSCH scheduling, the UE can generate a Type-1 HARQ-ACK codebook based on one or both of a TDRA table for multi-cell/multi-slot scheduling and a TDRA table for single-cell/single-slot scheduling, or combinations thereof, such as an intersection or union of such TDRA tables.

For example, the UE generates the Type-1 HARQ-ACK codebook based on a set of row indexes R of a table that is associated with the active DL BWP and defining respective sets of slot offsets K0, start and length indicators SLIV, and PDSCH mapping types for PDSCH reception, for example as described in [REF 4]. For example, the row indexes R of the table are provided by the union of row indexes of time domain resource allocation (TDRA) tables for DCI formats the UE is configured to monitor PDCCH for serving cell c. For example, the TDRA tables can include one or more of TDRA tables (or certain columns thereof) that the UE applies for multi-cell, multi-slot/PDSCH scheduling, as subsequently described.

For example, when a UE is configured a set of cells for multi-cell scheduling scheduledCellListDCI-1-3, and the UE is configured a single-cell, single-slot TDRA table, such as by pdsch-TimeDomainAllocationList, that is applicable to SC-DCI formats, such as DCI format 1_1, and is also configured a multi-cell, multi-slot/PDSCH TDRA table, such as by tdra-FieldIndexListDCI-1-3-r19 or pdsch-TimeDomainAllocationListForMultiPDSCH, that is applicable to DCI format 1_3, as previously described, the UE generates a Type-1 HARQ-ACK codebook based on at least one of:
rows of only the single-cell, single-slot TDRA table pdsch-TimeDomainAllocationList;
entries corresponding to a respective cell/BWP from rows of only the multi-cell, multi-slot/PDSCH TDRA table pdsch-TimeDomainAllocationListForMultiPDSCH;
union of entries corresponding to a respective cell/BWP from rows of the multi-cell, multi-slot/PDSCH TDRA table pdsch-TimeDomainAllocationListForMultiPDSCH and rows of the single-cell, single-slot TDRA table pdsch-TimeDomainAllocationList; or
intersection of entries corresponding to a respective cell/BWP from rows of the multi-cell, multi-slot/PDSCH TDRA table pdsch-TimeDomainAllocationListForMultiPDSCH with rows of the single-cell, single-slot TDRA table pdsch-TimeDomainAllocationList.

For example, when a UE is configured a set of cells for multi-cell scheduling scheduledCellListDCI-1-3, and the UE is configured a single-slot TDRA table, such as by pdsch-TimeDomainAllocationList that is applicable to SC-DCI formats, such as DCI formats 1_1, and also configured a multi-cell/multi-slot TDRA table, such as by pdsch-TimeDomainAllocationListForMultiPDSCHandMultiCell that is applicable to DCI format 1_3, as previously described, the UE generates a Type-1 HARQ-ACK codebook based on at least one of:
rows of only the single-cell, single-slot TDRA table pdsch-TimeDomainAllocationList;
entries corresponding to a respective cell/BWP from rows of only the multi-cell, multi-slot/PDSCH TDRA table pdsch-TimeDomainAllocationListForMultiPDSCHandMultiCell;
union of entries corresponding to a respective cell/BWP from rows of the multi-cell, multi-slot/PDSCH TDRA table pdsch-TimeDomainAllocationListForMultiPDSCHandMultiCell and rows of the single-cell, single-slot TDRA table pdsch-TimeDomainAllocationList; or
intersection of entries corresponding to a respective cell/BWP from rows of the multi-cell, multi-slot/PDSCH TDRA table pdsch-TimeDomainAllocationListForMultiPDSCHandMultiCell with rows of the single-cell, single-slot TDRA table pdsch-TimeDomainAllocationList.

For example, certain restrictions can be taken into account for the multi-cell/multi-slot TDRA table provided by pdsch-TimeDomainAllocationListForMultiPDSCH or by pdsch-TimeDomainAllocationListForMultiPDSCHandMultiCell. For example, the UE does not expect an entry in pdsch-TimeDomainAllocationListForMultiPDSCH or in pdsch-TimeDomainAllocationListForMultiPDSCHandMultiCell for a given cell/BWP to include or point to a TDRA index or SLIV entry that is not present in the single-cell/single-slot TDRA table such as pdsch-TimeDomainAllocationList. In such case, the UE can generate the Type-1 HARQ-ACK codebook only based on the single-cell/single-slot TDRA table.

As previously described, various methods and examples herein continue to apply when ‘multi-slot’ is replaced with ‘multi-PDSCH’.

In one embodiment, when a UE is configured for joint multi-cell and multi-PDSCH scheduling (such as with a TDRA table for a cell, from a set of cells for co-scheduling, with at least one entry having multiple SLIVs, and associated at least with multi-cell scheduling), the UE can generate a Type-2 HARQ-ACK codebook that includes a first sub-codebook associated with DCI formats that schedule a single PDSCH on a single cell (and with other DCI formats with associated HARQ-ACK information and without scheduling a corresponding PDSCH reception, and DCI formats that schedule multiple PDSCHs on a single cell that is configured for TBG-based/PDSCH-group HARQ-ACK bundling), and a second sub-codebook associated with DCI formats that schedule more than one PDSCHs on a single cell (if supported, with no TBG-based HARQ-ACK bundling or with more than one TBG-based HARQ-ACK bundling groups configured for the single cell) or more than one PDSCHs on more than one cells, with one PDSCH or multiple PDSCHs for each cell from the more than one cells (with or without TBG-based/PDSCH-group HARQ-ACK bundling configured for the more than one cells). The UE includes, for each DCI format in the second sub-codebook, a maximum number of HARQ-ACK information bits based on:
a maximum total number of TBs (or TBGs/PDSCH groups) across different PDSCHs (e.g., multi-PDSCHs) configured for multi-PDSCH scheduling, and across different cell combinations applicable for DCI format 1_3, and across different sets of cells for multi-cell scheduling in a PUCCH group, and
an applicable HARQ-ACK bundling across different TBs for a same PDSCH/cell, or bundling across different PDSCHs for a same multi-PDSCH/cell, if any.

When the UE generates a first number of HARQ-ACK information bits for TBs/PDSCHs associated with a first DCI format 1_3 that is smaller than the maximum number of HARQ-ACK information bits, the UE generates an additional number of HARQ-ACK information bits with NACK values so that the resulting number of HARQ-ACK information bits in the second HARQ-ACK codebook is equal to the maximum number. Such additional NACK values can be appended to the first number of HARQ-ACK information bits, or can be distributed among the first HARQ-ACK information bits, such as by appending some NACK values to HARQ-ACK information bits corresponding to each cell in the set of cells.

For example, the UE includes, in the first HARQ-ACK sub-codebook, HARQ-ACK information corresponding to one or more of:
DCI formats (for single-cell scheduling or for multi-cell scheduling) that do not schedule any PDSCH reception on any cell, and has associated HARQ-ACK information, such as for one or more of SCell dormancy, TCI state indication, and so on,
single-cell scheduling DCI formats such as DCI formats 1_0/1_1/1_2 that schedule only one PDSCH on one cell,
multi-cell scheduling DCI formats such as DCI formats 1_3 that schedule only one PDSCH on only one cell (for example, an indicated TDRA entry by the TDRA field points to a row with single SLIV entry for the only one cell),
multi-cell scheduling DCI formats such as DCI formats 1_3 that schedule more than one PDSCHs on a single cell, if supported, wherein the single cell is configured a single HARQ-ACK bundle for the more than one PDSCHs,
Note: when a DCI format for multi-cell scheduling such as DCI format 1_3 schedules only one PDSCH reception on only one cell, and is also associated with additional HARQ-ACK information corresponding to another UE procedure, such as for SCell dormancy, the UE assumes the other UE procedure as if a correct PDSCH reception on a cell other than the only one cell, and therefore includes HARQ-ACK information for such DCI format in the second sub-codebook.

For example, the UE (e.g., the UE 116) includes, in the second HARQ-ACK sub-codebook, HARQ-ACK information corresponding to one or more of:
Single-cell scheduling DCI formats such as DCI formats 1_1/1_2 that schedule more than one PDSCHs on a single cell, if supported, wherein the cell is not configured TBG-based HARQ-ACK bundling or is configured a number of >1 TBG-based HARQ-ACK bundles for the more than one PDSCHs,
Multi-cell scheduling DCI formats such as DCI format 1_3 that schedule multiple PDSCHs on a single cell, if supported, wherein the cell is not configured TBG-based HARQ-ACK bundling, or is configured a number of >1 HARQ-ACK bundles for the more than one PDSCHs,
multi-cell scheduling DCI formats such as DCI formats 1_3 that schedule multiple PDSCHs on more than one cells, with one PDSCH or multiple PDSCHs per cell (for example, an indicated TDRA entry by the TDRA field points to a row with single SLIV entry or with multiple SLIV entries, respectively, for the more than one cells).
For example, the UE determines first values of a first counter downlink assignment indicator (DAI) for respective first DCI formats corresponding to the first sub-codebook, and second values of a second counter DAI for respective second DCI formats corresponding to the second sub-codebook.

For example, the UE determines first values of a first total downlink assignment indicator (DAI) for respective first DCI formats corresponding to the first sub-codebook, and second values of a second total DAI for respective second DCI formats corresponding to the second sub-codebook.

For example, a DAI field in a DCI format (from the first DCI formats or from the second DCI formats) includes 4 bits with 2 MSB bits corresponding to an associated counter DAI (from the first values of the first counter DAI or the second values of the second counter DAI) and 2 least significant bit (LSB) bits corresponding to a total DAI (from the first values of the first total DAI or the second values of the second total DAI).

For example, a value of the counter DAI field in DCI formats (such as the first DCI formats), each scheduling PDSCH receptions on respective single serving cells (with single PDSCH on a serving cell, or with multiple PDSCHs on a serving cells configured with a single HARQ-ACK bundling group) with associated HARQ-ACK information, or having associated HARQ-ACK information without scheduling a PDSCH reception, in a same HARQ-ACK codebook (such as the first sub-codebook) denotes the accumulative number of {serving cell, PDCCH monitoring occasion}-pairs in which PDSCH receptions that provide transport blocks with enabled HARQ-ACK information report, or HARQ-ACK information bits that are not in response for PDSCH receptions, associated with the DCI formats, excluding the SPS activation DCI, is present up to the current serving cell and current PDCCH monitoring occasion,
first, if the UE indicates by type2-HARQ-ACK-Codebook support for more than one PDSCH reception on a serving cell that are scheduled from a same PDCCH monitoring occasion, in increasing order of the PDSCH reception starting time for the same {serving cell, PDCCH monitoring occasion} pair,
   For example, when a first DCI format schedules first more than one PDSCH receptions on a cell, and a second DCI format schedules second more than one PDSCH receptions on the cell, and the first and second DCI formats are provided by a first and a second PDCCH, respectively, and the first and second PDCCHs are from a same PDCCH monitoring occasion, a counter DAI for the first DCI format is smaller than a counter DAI for the second DCI format when a PDSCH (such as an earliest PDSCH with earliest starting time) from the first PDSCHs has a starting time that is before respective starting times for the second PDSCHs (including a starting time of an earliest PDSCH with earliest starting time from the second PDSCHs);
   Such first and second DCI formats can include single-cell scheduling DCI formats that schedule more than one PDSCHs on a single cell (if supported) or multi-cell scheduling DCI formats that schedule more than one PDSCHs on a single cell (if supported), wherein the single cell is configured a single TBG-based HARQ-ACK bundle for the more than one PDSCHs;
second in ascending order of serving cell index, and
third in ascending order of PDCCH monitoring occasion index m, where 0≤m<M.

For example, a value of the counter DAI field in DCI formats (such as the second DCI formats), each scheduling more than one PDSCH receptions on one serving cell (if supported) or on more than one serving cells (with multiple PDSCH receptions on one serving cell, or with single PDSCH reception or multiple PDSCH receptions on a serving cell from the more than one serving cells) with associated HARQ-ACK information in a same HARQ-ACK codebook (such as the second sub-codebook), denotes the accumulative number of {the one serving cell (if supported) or serving cell with smallest index from the more than one serving cells, PDCCH monitoring occasion}-pairs in which PDSCH receptions are present up to the current more than one serving cells and current PDCCH monitoring occasion,
first, if the UE indicates by type2-HARQ-ACK-Codebook support for more than one PDSCH receptions on a serving cell that are scheduled from a same PDCCH monitoring occasion, in increasing order of the PDSCH reception starting time for the same {the one serving cell (if supported) or serving cell with smallest index from the more than one serving cells, PDCCH monitoring occasion} pair,
   For example, when a first DCI format schedules on first more than one serving cells, and a second DCI format schedules on second more than one serving cells, wherein a serving cell with smallest index among the from the first more than one cells is same as a serving cell with smallest index among the second more than one cells, and the first and second DCI formats are provided by a first and a second PDCCH, respectively, and the first and second PDCCHs are from a same PDCCH monitoring occasion, and when the first DCI format schedules first more than one PDSCHs on the serving cell with smallest index and the second DCI format schedules second more than one PDSCHs on the serving cell with smallest index, a counter DAI for the first DCI format is smaller than a counter DAI for the second DCI format when a PDSCH (such as an earliest PDSCH with earliest starting time) from the first PDSCHs has a starting time that is before respective starting times for the second PDSCHs (including a starting time of an earliest PDSCH with earliest starting time from the second PDSCHs);
   For example, when a first DCI format schedules first more than one PDSCH receptions on a first serving cell (if supported) or on first more than one serving cells, and a second DCI format schedules second more than one PDSCH receptions on a second serving cell or second more than one serving cells, and the first and second DCI formats are provided by a first and a second PDCCH, respectively, and the first and second PDCCHs are from a same PDCCH monitoring occasion, a counter DAI for the first DCI format is smaller than a counter DAI for the second DCI format when a PDSCH (such as an earliest PDSCH with earliest starting time) from the first more than one PDSCH receptions has a starting time that is before respective starting times for the second more than one PDSCH receptions (for example, before a starting time of an earliest PDSCH with earliest starting time from the second more than one PDSCH receptions);
   Such first and second DCI formats can include single-cell scheduling DCI formats that schedule more than one PDSCHs on a single cell (if supported) or multi-cell scheduling DCI formats that schedule more than one PDSCHs on a single cell (if supported), or multi-cell scheduling DCI formats that schedule one or more PDSCHs on more than one cells, wherein the single cell is not configured TBG-based HARQ-ACK bundling, or is configured more than one TBG-based HARQ-ACK bundles;
second in ascending order of the smallest serving cell index from the more than one serving cells, and
third in ascending order of PDCCH monitoring occasion index m, where 0≤m<M.

For example, when a UE is configured a set of cells for multi-cell scheduling scheduledCellListDCI-1-3, and the UE is configured a multi-cell/multi-PDSCH TDRA table, such as by pdsch-TimeDomainAllocationListForMultiPDSCHandMultiCell or a multi-PDSCH variation of tdra-FieldIndexListDCI-1-3 with entries based on a single-cell/multi-PDSCH TDRA table TimeDomainAllocationListForMultiPDSCH that is applicable to DCI format 1_3 for the set of cells, and when no TBG-based HARQ-ACK bundling is provided, the UE determines a maximum number

$${N}_{ s ets}^{TB , m ax}$$

of HARQ-ACK information bits per DCI format for the second sub-codebook as the maximum total number of TBs in PDSCH receptions (including one PDSCH reception or multiple PDSCH receptions per serving cell) that can be scheduled by a DCI format 1_3 over more than one serving cells in a set of serving cells across the number of sets of serving cells. For example, the maximum number

$${N}_{sets}^{TB , max}$$

can be determined as:

$${N}_{s e t s}^{TB , m ax} = {max}_{\begin{matrix}different sets s of cells \\ scheduledCellListDCI - 1 - 3 \\ i n a PUCCH group\end{matrix}} {N}_{set s}^{T B}$$

$${N}_{set s}^{TB} = {max}_{\begin{matrix}different cell combinations j \\ that can be scheduled by a DCI format 1 - 3 \\ for the set s of cells\end{matrix}} {N}_{set s , cell combo j}^{T B}$$

$${N}_{set s , cell combo j}^{T B} = {\sum }_{\begin{matrix}different cells c \\ i n the cell combo j \\ of the set s of cells\end{matrix}} {N}_{TB , c}^{D L} \cdot {N}_{P D S C H , c}^{m ax}$$

Herein,

$${N}_{TB , c}^{D L}$$

is the value of maxNrofCodeWordsScheduledByDCI for serving cell c (or 1 if not configured, that is single-TB configuration for PDSCHs reception) and

$${N}_{P D S C H , c}^{m ax}$$

is determined by the maximum number of SLIVs amongst rows of the TDRA table configured by pdsch-TimeDomainAllocationListForMultiPDSCH for serving cell c or among entries/columns corresponding to the serving cell c from rows of a multi-cell/multi-PDSCH TDRA table configured by, for example, pdsch-TimeDomainAllocationListForMultiPDSCHandMultiCell.

Herein, to determine

$${N}_{set s}^{T B} ,$$

a maximum of

$${N}_{set s , cell combo j}^{T B}$$

is taken over different cell combinations j that can be scheduled by a DCI format 1_3 for the set s of cells. For example, the cell combinations can include the DL cell combinations scheduledCellComboListDCI-1-3-r18 that are configured for the cell set scheduledCellListDCI-1-3, or the cell combinations can include cells in the set of cells when no cell combinations are configured by higher layers (that is, the summation is over cells in the set of cells).

When a corresponding multi-cell, multi-PDSCH TDRA table includes values/indexes corresponding to multiple BWPs of the serving cell c, the UE considers, for the purposes of determining

$${N}_{P D S C H , c}^{ma x} ,$$

only values/indexes that are associated with an active DL BWP in which the UE receives the PDSCHs on the c, such as a (new/target) BWP indicated/determined by a BWP indicator field of the DCI format 1_3 for the associated PDSCH receptions, or a currently active BWP. For example, the UE may discard (e.g., may not use or apply) values/indexes corresponding to other DL BWPs. For example, the UE determines a size of a HARQ-ACK codebook, such as Type-1 HARQ-ACK codebook or Type-2 HARQ-ACK codebook, using parameter values (such as

$${N}_{P D S C H , c}^{m ax}$$

or) that are based on configuration parameters such as TDRA tables associated with respective currently active BWPs of respective cells. For example, the UE determines sizes (i.e., respective number of bits) for fields in a DCI format 0_3/1_3, such as for redundancy version (RV) field or new data indicator (NDI) field, or corresponding information blocks within such fields, using parameter values (such as

$${N}_{P D S C H , c}^{m ax} )$$

that are based on configuration parameters such as TDRA tables associated with respective currently active BWPs of respective cells. For example, an interpretation of the DCI fields can be based on respective configurations for the respective currently active BWPs or based on respective configurations for the respective new/target BWPs of respective cells as indicated by as indicated/determined by a BWP indicator field of the DCI format 0_3/1_3.

In another example, such size determinations for HARQ-ACK codebook size or for DCI field sizes are based on parameters of a new/target BWP that is indicated/determined by a BWP indicator field of the DCI format. For example, the UE determines a size of a HARQ-ACK codebook, such as Type-1 HARQ-ACK codebook or Type-2 HARQ-ACK codebook, using parameter values (such as

$${N}_{P D S C H , c}^{m ax}$$

or) that are based on configurations parameters such as TDRA tables associated with respective new/target BWPs of respective cells as indicated/determined by a BWP indicator field of the DCI format 1_3. For example, the UE determines sizes (i.e., respective number of bits) for fields in a DCI format 0_3/1_3, such as for redundancy version (RV) field or new data indicator (NDI) field, or corresponding information blocks within such fields, using parameter values (such as

$${N}_{P D S C H , c}^{m ax} )$$

that are based on configuration parameters such as TDRA tables associated with respective new/target BWPs of respective cells as indicated/determined by a BWP indicator field of the DCI format 0_3/1_3. For example, an interpretation of the DCI fields can be based on respective configurations for the respective new/target BWPs of respective cells as indicated by as indicated/determined by a BWP indicator field of the DCI format 0_3/1_3.

Herein,

$${N}_{P D S C H , c}^{m ax}$$

can be replaced by

$${N}_{H A R Q - ACK , c}^{T B G , m ax} ,$$

when the UE is configured TBG-based HARQ-ACK bundling for the serving cell c.

For example, in various examples herein, the first max operations on the cell combinations and the second max operation on the cells within the cell combination can be combined into a single max operation over serving cells that can be scheduled by a DCI format 1_3.

In one example, the UE determines a maximum number

$${N}_{sets}^{TB , max}$$

of HARQ-ACK information bits per DCI format for the second sub-codebook based on the multi-PDSCHs and multi-cell TDRA table. For example, in the formula herein, one can replace

$${N}_{set s , cell combo j}^{TB}$$

with

$${N}_{set s , cell combo j}^{TB} = {max}_{{different rows r of}_{{{{the multi - PDSCH}_{multi - cell TDRA table}}_{for the cell combo j}}_{of the set s of cells}}} {\sum }_{{{different cells c}_{in the cell combo j}}_{of the set s of cells}} {N}_{TB , c}^{DL} \cdot {N}_{PDSCH , c}^{r}$$

Wherein

$${N}_{PDSCH , c}^{r}$$

is a number of PSDCHs/SLIVs for serving cell c as configured by row r of the multi-cell TDRA table. For example, when the UE is configured TBG-based HARQ-ACK bundling for the serving cell c, the parameter

$${N}_{PDSCH , c}^{r}$$

can be replaced by

$${N}_{HARQ - ACK , c}^{TBG , r} ,$$

that refers to a number of TBG-based HARQ-ACK bundle groups associated with the number of PSDCHs/SLIVs for serving cell c as configured by row r of the multi-cell TDRA table.

For example, in the example herein, the first max operations on the cell combinations and the second max operation on the TDRA rows for the cell combinations can be combined into a single max operation over TDRA rows for serving cells that can be scheduled by a DCI format 1_3.

In another example, the UE determines a maximum number

$${N}_{sets}^{TB , max}$$

of HARQ-ACK information bits per DCI format for the second sub-codebook as a product of a maximum number of cells in a set across different sets of cells, and maximum number of TBs/PDSCHs/TBGs per cell that can be scheduled by a single DCI format. For example, such methods can be conditioned on having the latter maximum be same for each of the co-scheduled cell (in different sets of cells).

In another example, the UE is provided by higher layers, such as by RRC signaling, a value of a maximum number

$${N}_{sets}^{TB , max}$$

of HARQ-ACK information bits per DCI format for the second sub-codebook. For example, the UE does not need to determine the value of

$${N}_{sets}^{TB , max} ,$$

and uses the value provided by the higher layers. For example, the UE expects that the configured value of

$${N}_{sets}^{TB , max}$$

is not smaller than a maximum value

$${N}_{sets}^{TB , max}$$

that the UL would determine as previously described. For example, the UE does not expect to drop some or HARQ-ACK bits for some DCI formats that are associated with a larger number of HARQ-ACK information bits than the configured value of

$${N}_{sets}^{TB , max} .$$

For example, a pseudo-code for HARQ-ACK generation is identical for such case to that for the case wherein the UE determines the value of the maximum value

$${N}_{sets}^{TB , max}$$

as previously described. Such method can be beneficial, for example, to simplify the specifications of system operation by avoiding a text that would describe how to determine the maximum value

$${N}_{sets}^{TB , max} ,$$

or to simplify the UE complexity for such determination.

In another example, a configured value of

$${N}_{sets}^{TB , max}$$

provided by higher layers is smaller than a maximum value

$${N}_{sets}^{TB , max}$$

that the UE would determine as previously described. For example, the UE drops some or HARQ-ACK bits for some DCI formats that are associated with a larger number of HARQ-ACK information bits than the configured value of

$${N}_{sets}^{TB , max} .$$

Such method can be beneficial, for example, to reduce the HARQ-ACK codebook size.

In the second HARQ-ACK sub-codebook, the UE includes HARQ-ACK information corresponding to the second DCI formats in ascending order of corresponding second values for a counter DAI field associated with the second DCI formats. For example, the UE includes in the second sub-codebook first

$${N}_{sets}^{TB , max}$$

HARQ-ACK information bits corresponding to a first DCI format from the second DCI formats before including second

$${N}_{sets}^{TB , max}$$

HARQ-ACK information bits corresponding to a second DCI format from the second DCI formats when a first value for the counter DAI for the first DCI format is smaller than a second value for the counter DAI for the second DCI format.

For example, when the UE does not detect a DCI format associated with a value of the second counter DAI value, the UE includes a number of

$${N}_{sets}^{TB , max}$$

NACK bits in the second sub-codebook, in a same order associated with the value of the second counter DAI in other DCI formats that the UE detects after the DCI format, from the second DCI formats.

For example, for any given DCI format from the second DCI formats, the UE generates the

$${N}_{sets}^{TB , max}$$

HARQ-ACK information bits in the following order:
first, in ascending order of TBs associated with a PDSCH (that is, HARQ-ACK information for a first TB of a PDSCH is before HARQ-ACK information for a second TB for the PDSCH), if a second TB is provided for the PDSCH
second, in ascending order of PDSCH reception starting time among multiple PDSCH receptions on a serving cell, if multiple PDSCH receptions are scheduled on the serving cell
third, in ascending order of a cell index among the multiple serving cells that are scheduled by the given DCI format.

In one example, the ‘first’ and ‘second’ in the ordering herein are reversed. For example, the UE first generates HARQ-ACK information for respective first TBs of one or more PDSCH receptions on a cell, before generating HARQ-ACK information for respective second TBs of the one or more PDSCHs receptions on the cell. For example, for any given DCI format from the second DCI formats, the UE generates the

$${N}_{sets}^{TB , max}$$

HARQ-ACK information bits in the following order:
first, in ascending order of PDSCH reception starting time among multiple PDSCH receptions on a serving cell, if multiple PDSCH receptions are scheduled on the serving cell
in ascending order of TBs associated with PDSCHs (that is, HARQ-ACK information for respective first TBs of respective PDSCHs on a cell are before HARQ-ACK information for respective second TBs for the respective PDSCH on the cell), if the serving cell is configured with max 2 TB per PDSCH
third, in ascending order of a cell index among the multiple serving cells that are scheduled by the given DCI format.

If the UE is configured harq-ACK-SpatialBundlingPUCCH, the UE replaces

$${N}_{sets}^{TB , max}$$

with 1 for determination of the maximum number

$${N}_{TB , c}^{DL}$$

of HARQ-ACK bits. For example, the UE determines the maximum number

$${N}_{sets}^{TB , max}$$

of HARQ-ACK information bits for the second sub-codebook as the maximum total number of PDSCH receptions that can be scheduled by a DCI format 1_3 over more than one serving cells in a set of serving cells across the number of sets of serving cells. For example, the UE applies a binary AND operation between HARQ-ACK information corresponding for a first TB and HARQ-ACK information for a second TB of a corresponding PDSCH.

For example, when the UE generates N HARQ-ACK information bits for a first DCI format 1_3, wherein

$$N < {N}_{sets}^{TB , max} ,$$

the UE appends

$$( {N}_{sets}^{TB , max} - N )$$

NACKs to the end of the N HARQ-ACK information bits, wherein

$${N}_{sets}^{TB , max}$$

is the maximum number of HARQ-ACK information bits provided for the second HARQ-ACK sub-codebook.

In another example, when the UE determines N_{c} HARQ-ACK information bits for (one or more than one) PDSCHs scheduled on a serving cell c by a DCI format 1_3, wherein

$${N}_{c} < {N}_{PDSCH , c}^{max} ,$$

the UE appends

$$( {N}_{PDSCH , c}^{max} - {N}_{C} )$$

NACKs to the N_{c} HARQ-ACK information bits.

For example, the UE can be configured, by nrofHARQ-BundlingGroups for a cell in a set of cells scheduledCellListDCI-1-3, a value

$${N}_{HARQ - ACK , c}^{TBG , max}$$

for a maximum number of HARQ-ACK information bits that the UE generates per serving cell (for a first TB, and same for a second TB, is applicable) from the more than one serving cells scheduled by a DCI format 1_3. For example, the UE determines up to a number

$${N}_{HARQ - ACK , c}^{TBG , max}$$

of PUSCH groups (or TB groups) by splitting multiple PDSCHs receptions scheduled by the DCI format 1_3 for a given cell. For example, the UE determines the maximum number

$${N}_{sets}^{TB , max}$$

of HARQ-ACK information bits for a DCI format associated with the second sub-codebook by replacing

$${N}_{PDSCH , c}^{max} {N}_{HARQ - ACK , c}^{TBG , max} .$$

For example, the UE determines an ACK for a PDSCH group (or TB group) when different PDSCHs in the PDSCH group are decoded correctly, and determines a NACK for the PDSCH group when at least one PDSCH from the PDSCH group is decoded incorrectly. Therefore, the UE determines a HARQ-ACK information bit for a PDSCH group (TB group) as a binary AND of HARQ-ACK information bits corresponds to the PDSCH receptions in the PDSCH group (TB group).

For example, when the UE determines fewer PDSCH groups than the maximum configured number

$${N}_{HARQ - ACK , c}^{TBG , max}$$

of PUSCH groups, the UE determines a NACK value for each missing PSDCH group.

For example, when the UE generates N_{c} HARQ-ACK information bits for PDSCH groups/TB groups associated with a serving cell c that is scheduled by a DCI format 1_3, wherein

$${N}_{c} < {N}_{HARQ - ACK , c}^{TBG , max} ,$$

the UE appends

$$( {N}_{HARQ - ACK , c}^{TBG , max} - {N}_{x} )$$

NACKs to the end of the N_{c} HARQ-ACK information bits.

For example, the UE includes HARQ-ACK information for respective first TBs associated with different PDSCH groups before including HARQ-ACK information for respective second TBs, if applicable, associated with the different PDSCH groups. Alternatively, the UE determines HARQ-ACK information for respective first and second TBs associated with a first PDSCH group before determining HARQ-ACK information for respective first and second TBs associated with a next/second PDSCH group (wherein ordering of PDSCH groups is in ascending order of PDSCH starting time).

For example, when the UE is configured both nrofHARQ-BundlingGroups and harq-ACK-SpatialBundlingPUCCH, the UE generates one HARQ-ACK information bit for each TB group/PDSCH group, as previously described, after an AND operation for HARQ-ACK information associated with a first TB and that for a second TB of each PDSCH in the PDSCH group.

For a TB group or a PDSCH group associated with at least one PDSCH that does not overlap with an UL symbol indicated by tdd-UL-DL-ConfigurationCommon, or by tdd-UL-DL-ConfigurationDedicated if provided, the UE assumes that TB(s) provided by a PDSCH that overlaps with an UL symbol indicated by tdd-UL-DL-ConfigurationCommon, or by tdd-UL-DL-ConfigurationDedicated if provided, are correctly received. For a TB group or a PDSCH group associated only with PDSCHs that overlap with UL symbols indicated by tdd-UL-DL-ConfigurationCommon, or by tdd-UL-DL-ConfigurationDedicated if provided, the UE generates a NACK value for the TB group or the PDSCH group.

If O_{ACK}+O_{SR}+O_{CSI}≤11 and

$${N}_{sets}^{DL} > 0 ,$$

for obtaining a PUCCH transmission power as described in clause 7.2.1 of [REF3], the UE determines n_{HARQ-ACK}=n_{HARQ-ACK,0}+n_{HARQ-ACK,1}, where n_{HARQ-ACK,0} is the value of n_{HARQ-ACK} for the first Type-2 HARQ-ACK sub-codebook and n_{HARQ-ACK,1} is the value of n_{HARQ-ACK} for the second Type-2 HARQ-ACK sub-codebook that is determined as

$${n}_{HARQ - ACK} = ( ( {V}_{DAI , {m}_{last}}^{DL} - {\sum }_{s = 0}^{{N}_{sets}^{DL} - 1} {U}_{DAI , s} ) mod ( {T}_{D} ) ) {N}_{TB , max}^{DL , MC} + {\sum }_{s = 0}^{{N}_{sets}^{DL} - 1} {\sum }_{m = 0}^{M - 1} {N}_{m , s}^{received}$$

where
in the following
   a DCI format 1_3 schedules more than one PDSCH receptions providing transport blocks with enabled HARQ-ACK information on only one cell (if supported) or (collectively) on more than one serving cells;
   a dormancy indication is regarded as a PDSCH reception providing a single transport block with enabled HARQ-ACK information on a cell with associated DCI fields used for SCell dormancy indication (such as a non-scheduled cell with invalid FDRA with smallest cell index among the co-scheduled cells by the DCI format 1_3).

$${v}_{DAI , {m}_{last}}^{DL}$$

is the value of the total DAI field in a last DCI format 1_3 the UE detects in a last PDCCH monitoring occasion within the M PDCCH monitoring occasions where the UE detects at least one DCI format 1_3.

$${V}_{DAI , {m}_{last}}^{DL} = 0$$

if the UE does not detect any DCI format 1_3 in any of the M PDCCH monitoring occasions.
U_{DAI,s} is the total number of DCI format 1_3 that the UE (e.g., the UE 116) detects within the M PDCCH monitoring occasions for the set s of serving cells. U_{DAI,s}=0 if the UE does not detect any DCI format 1_3 associated with scheduling on set s of serving cells in any of the M PDCCH monitoring occasions.

$${N}_{TB , max}^{DL , MC}$$

is:

$${N}_{TB , max}^{DL , MC} = {N}_{sets}^{TB , max}$$

if harq-ACK-SpatialBundlingPUCCH is not provided and nrofHARQ-BundlingGroups is also not provided;

$${N}_{ sets}^{TB , max}$$

is determined as previously described, for example, a maximum total number of TBs in PDSCH receptions (including one PDSCH reception for a serving cell or multiple PDSCH receptions for a serving cell) that can be scheduled by a DCI format 1_3 over more than one serving cells in a set of serving cells across the number of sets of serving cells;

$${N}_{TB , max}^{DL , MC} = {N}_{sets}^{TB , max}$$

after replacing

$${N}_{TB , c}^{DL}$$

with 1 when determining

$${N}_{sets}^{TB , max}$$

if harq-ACK-SpatialBundlingPUCCH is provided and nrofHARQ-BundlingGroups is not provided;

$${N}_{TB , max}^{DL , MC} = {N}_{sets}^{TB , max}$$

after replacing

$${N}_{PDSCH , c}^{max} with {N}_{HARQ - ACK , c}^{TBG , max}$$

when determining

$${N}_{sets}^{TB , max}$$

if harq-ACK-SpatialBundlingPUCCH is not provided and nrofHARQ-BundlingGroups is provided;

$${N}_{TB , max}^{DL , MC} = {N}_{sets}^{TB , max}$$

after replacing

$${N}_{TB , c}^{DL}$$

with 1 and replacing

$${N}_{PDSCH , c}^{max}$$

with

$${N}_{HARQ - ACK , c}^{TBG , max}$$

when determining

$${N}_{sets}^{TB , max}$$

if both harq-ACK-SpatialBundlingPUCCH and nrofHARQ-BundlingGroups are provided.

$${N}_{m , s}^{rec eived}$$

is
if harq-ACK-SpatialBundlingPUCCH is not provided and nrofHARQ-BundlingGroups is also not provided: the number of transport blocks, in PDSCH receptions not overlapping with an UL symbol indicated by tdd-UL-DL-ConfigurationCommon or by tdd-UL-DL-ConfigurationDedicated if provided, associated with a DCI format 1_3 that the UE detects in PDCCH monitoring occasion m for set s of serving cells,
if harq-ACK-SpatialBundlingPUCCH is provided and nrofHARQ-BundlingGroups is not provided: the number of more than one PDSCHs, not overlapping with an UL symbol indicated by tdd-UL-DL-ConfigurationCommon or by tdd-UL-DL-ConfigurationDedicated if provided, scheduled by a DCI format 1_3 that the UE detects in PDCCH monitoring occasion m for set s of serving cells,
if harq-ACK-SpatialBundlingPUCCH is not provided and nrofHARQ-BundlingGroups is provided: the number of transport block groups (TBGs) with at least one PDSCH not overlapping with an UL symbol indicated by tdd-UL-DL-ConfigurationCommon or by tdd-UL-DL-ConfigurationDedicated if provided, from/based on PDSCH receptions associated with a DCI format 1_3 that the UE detects in PDCCH monitoring occasion m for set s of serving cells,
if harq-ACK-SpatialBundlingPUCCH is provided and nrofHARQ-BundlingGroups is also provided: the number of PDSCH groups, with at least one PDSCH not overlapping with an UL symbol indicated by tdd-UL-DL-ConfigurationCommon or by tdd-UL-DL-ConfigurationDedicated if provided, from/based on PDSCH receptions associated with a DCI format 1_3 that the UE detects in PDCCH monitoring occasion m for set s of serving cells.

For example, when time-domain HARQ-ACK bundling is not configured, a number of HARQ-ACK bits for a DCI format 1_3 is a maximum total number of TBs which can be co-scheduled by a DCI format 1_3, wherein the maximum is across different sets of serving cells scheduledCellListDCI-1-3 in the PUCCH group for the UE. For example, when the UE is scheduled less TBs than such maximum number of TBs, the UE generates sufficient NACKs until the number of HARQ-ACK bits are same as such maximum.

For example, when time-domain HARQ-ACK bundling is configured, a number of HARQ-ACK bits for a DCI format 1_3 is a maximum total number of transport block groups (TBGs) which can be co-scheduled by a DCI format 1_3, wherein the maximum is across different sets of serving cells scheduledCellListDCI-1-3 in the PUCCH group for the UE. For example, when the UE is scheduled less TBGs than such maximum number of TBs, the UE generates sufficient NACKs until the number of HARQ-ACK bits are same as such maximum.

For example, the UE includes such HARQ-ACK bits in a 2nd sub-CB of a Type-2 HARQ-ACK codebook when the DCI format 1_3 schedules more than one PDSCHs across multiple cells, or when the DCI format 1_3 schedules more than one PDSCHs on one cell (if supported) and the UE is not configured with TBG-based HARQ-ACK bundling or is configured more than one TBGs for the one cell.

For example, the UE generates HARQ-ACK for TBGs in ascending (or descending) order of PDSCH reception time, such as starting time or ending time, or based on ascending (or descending) order of SLIV in a corresponding TDRA table row, among the PDSCHs for one cell or among different cells. For example, the UE includes a first HARQ-ACK information bit corresponding to a first TBG (or PDSCH group) on a cell before a second HARQ-ACK information bit corresponding to a second TBG (or PDSCH group) when:
in one option, the first TBG (or PDSCH group) corresponds to first PDSCH receptions that are associated with first PDSCH SLIV entries in a corresponding row of the multi-PDSCH TDRA table for the cell, and the second TBG (or PDSCH group) corresponds to second PDSCH receptions that are associated with second PDSCH SLIV entries in the row of the multi-PDSCH TDRA table for the cell, and the first SLIV entries are before the second SLIV entries in the corresponding row of the multi-PDSCH TDRA table for the cell;
in a second option, a starting time of a PDSCH reception from the first PDSCH receptions, such as a first PDSCH reception with earliest starting time among the first PDSCH reception) is before respective starting times of any PDSCH reception from the second PDSCH receptions (including a second PDSCH reception with earliest starting time among the second PDSCH receptions).

For example, TBGs for each cell are ordered based on such SLIV ordering or PDSCH starting reception time ordering, while TBGs for different cells are orders based on cell index, such as ascending (or descending) order of cell index among the more than one cells that are scheduled by the DCI format 1_3.

Such ordering also applies to DAI counting or “last DCI” determination, wherein the UE determines an ordering of DAI value or DCI formats based on an ascending (or descending) order of PDSCH reception time, such as starting time or ending time, or based on an ascending (or descending) order of SLIV in a corresponding TDRA table row, in combination with an ordering based on cell index, such as ascending (or descending) order of cell index.

Such ordering of HARQ-ACK bits can apply to any DCI format, such as DCI format 1_3 or DCI format 1_1, that schedules multiple PDSCHs on one cell (or on multiple cells).

For example, for Type-2 HARQ-ACK codebook, for a number of cells which are co-scheduled by a DCI format 1_3, the reference PDSCH to determine a counter DAI associated with the DCI format 1_3 is:
a PDSCH on a cell with smallest serving cell index among the number of co-scheduled cells, when only one PDSCH is indicated (by a corresponding TDRA table row) for such cell, or
a PDSCH with earliest (or latest) PDSCH reception starting time (or ending time) on a cell with the smallest serving cell index among the number of co-scheduled cells, or
a PDSCH corresponding to a first/smallest SLIV index in a corresponding TDRA table row on a cell with the smallest serving cell index among the number of co-scheduled cells, or
a PDSCH on a cell with smallest serving cell index among respective PDSCH receptions on respective cells, from the number of co-scheduled cells, that have a same PDSCH reception starting (or ending) time.

For example, to determine a ‘last DCI’ format (such as a last DCI format for one or more of: determination of PUCCH power control; or determination of PUCCH resource; or HARQ-ACK codebook grouping), a reference PDSCH associated with a DCI format (such as DCI format 1_1 or DCI format 1_3) that schedules more than one PDSCH receptions on one cell (if supported) or schedules more than one PDSCH receptions across more than one cells is:
a PDSCH ending last (for example, with latest PDSCH reception ending time) on the one cell, when only the one cell is scheduled by the DCI format, or
a PDSCH on a cell with smallest serving cell index (or largest cell index) among the more than one co-scheduled cells, for example, when only one PDSCH is indicated (by a corresponding TDRA table row) for such cell, or
a PDSCH ending last (for example, with latest PDSCH reception ending time) on a cell with the smallest serving cell index among the more than one co-scheduled cells, for example, when more than one PDSCHs are indicated/scheduled by the DCI format on the cell with the smallest cell index, or
a PDSCH ending last (for example, with latest PDSCH reception ending time) among the more than one PDSCH receptions across the more than one co-scheduled cells; for example, such PDSCH may be or may not be on a cell with smallest cell index among the co-scheduled cells by the DCI format, or
a PDSCH corresponding to a first/smallest SLIV index in a corresponding TDRA table row on a cell with the smallest serving cell index among the number of co-scheduled cells, or
a PDSCH on a cell with smallest serving cell index among respective PDSCH receptions on respective cells, from the number of co-scheduled cells, that have a same PDSCH reception ending time.

For example, when a reference PDSCH for determination of a ‘last DCI’ format associated with a first DCI format is a first PDSCH on a first cell, and a reference PDSCH for determination of a ‘last DCI’ format associated with a second DCI format is a second PDSCH on a second cell, the UE determines that the second DCI format is not a ‘last DCI’ format when:
a reception ending time for the second PDSCH is earlier than a reception ending time for the first PDSCH, or
the second cell has a larger cell index than the first cell.

For example, the first DCI format is a ‘last DCI’ format when, for any second DCI format associated with a same HARQ-ACK codebook (or sub-codebook), a respective reference PDSCH for determination of a ‘last DCI’ format associated with the respective second DCI is a respective second PDSCH on a respective second cell, and:
a reception ending time for the respective second PDSCH is earlier than a reception ending time for the first PDSCH, or
the respective second cell has a larger cell index than the first cell.

In one realization, a UE can receive multiple PDCCH receptions in a same PDCCH monitoring occasion (MO) wherein the UE is provided by the multiple PDCCH receptions multiple DCI formats that schedule PDSCH receptions on a same serving cell (or a same non-serving cell). The UE counts the serving cell (or the non-serving cell) once for each DCI format when running a pseudo-code for Type-2/dynamic HARQ-ACK codebook. The UE applies such counting regardless of whether each DCI format from the multiple DCI formats schedules one PDSCH or multiple PDSCHs on the serving cell (or the non-serving cell).

For example, if the UE indicates a UE capability type2-HARQ-ACK-Codebook for processing multiple PDCCHs/DCI formats for a same cell in a same MO and the UE receives a number

$${N}_{PDSCH , c}^{m} > 1$$

of PDSCHs on a serving cell c that are scheduled by respective

$${N}_{PDSCH , c}^{m}$$

DCI formats in respective

$${N}_{PDSCH , c}^{m}$$

PDCCH receptions at a same PDCCH monitoring occasion m, the serving cell c is counted

$${N}_{PDSCH , c}^{m}$$

times for PDCCH monitoring occasion m in increasing order of the PDSCH reception starting time. For example, if the UE indicates type2-HARQ-ACK-Codebook and receives a number

$${N}_{PDSCH , c}^{m} > 1$$

of PDSCHs on a serving cell c that are scheduled by

$${N}_{PDCCH , c}^{m} > 1$$

DCI formats, wherein

$${N}_{PDCCH , c}^{m} \leq {N}_{PDSCH , c}^{m} ,$$

in PDCCH receptions at a same PDCCH monitoring occasion m, the serving cell c is counted

$${N}_{PDCCH , c}^{m}$$

times for PDCCH monitoring occasion m in increasing order of the PDSCH reception starting time of the respective

$${N}_{PDCCH , c}^{m} > 1$$

DCI formats. In a variation,

$${N}_{PDSCH , c}^{m} > 1$$

can be replaced by

$${N}_{PDSCH , c}^{m} \geq 1 .$$

In a variation,

$${N}_{PDCCH , c}^{m} > 1$$

can be replaced by

$${N}_{PDCCH , c}^{m} \geq 1 .$$

In a variation, the serving cell c is counted

$${N}_{PDSCH , c}^{m}$$

times for PDCCH monitoring occasion m in increasing order of the PDSCH reception starting time of the respective

$${N}_{PDSCH , c}^{m}$$

PDSCHs receptions. For example, each/a/any DCI format from the

$${N}_{PDCCH , c}^{m} > 1$$

DCI formats can schedule one PDSCH reception or multiple PDSCHs receptions, based on a number of SLIV entries indicated by a respective value of the TDRA field.

Similar method can apply to DCI formats that scheduled PDSCH reception on (one or) more than serving cells, such as DCI format 1_3, with one PDSCH reception per scheduled cell, or with more than one PDSCH reception per cell, or with more than one PDSCH reception for one or more cells.

For example, for each DCI format 1_3 with a same cell c as a cell with smallest cell index among the co-scheduled cells, the UE counts the serving cell c (or the non-serving cell c) once when running a pseudo-code for Type-2/dynamic HARQ-ACK codebook. For example, the UE receives multiple PDCCH receptions in a same PDCCH MO, and the UE detects multiple DCI formats 1_3 in the respective multiple PDCCH receptions, wherein each DCI format 1_3 from the multiple DCI formats 1_3 schedule on more than one cells, and a cell with smallest cell index is shared among the multiple DCI formats. For example, the UE receives a first DCI format 1_3 that schedules one or more PDSCHs on cells {1, 2} and a second DCI format 1_3 that schedules one or more PDSCHs on cells {1, 3}. For example, the UE counts cell #1 twice for the corresponding PDCCH MO, and performs a corresponding loop of HARQ-ACK feedback generation twice for cell #1 in that MO. For example, such counting depends on the number of such DCI formats 1_3, and does not depend on whether one or more of such DCI formats 1_3 schedule more the one PDSCH receptions on the cell with smallest cell index among the co-scheduled cells, such as cell #1 in the previous example.

Such methods may also apply to any DCI format that generates multiple HARQ-ACK information bits, regardless of whether a DCI format is a single-cell scheduling DCI (SC-DCI) format such as 1_0/1_1/1_2, or whether the DCI format is a multi-cell scheduling DCI (MC-DCI) format 1_3 that schedules one PDSCH per cell or more than one PDSCHs for one or more cells. For example, the UE can be configured multi-PDSCH scheduling on one or more cells, and an SC-DCI format can schedule more than one PDSCHs on one cell.

For example, a first DCI format (such as DCI format 1_3 or an SC-DCI format 1_0/1_1/1_2) can schedule more than one PDSCHs on a single cell c, and a second DCI format (such as DCI format 1_3) can schedule on more than one cells, wherein the cell c is a cell with smallest cell index among the more than one cells, and wherein the UE receives the first DCI and the second DCI in a same PDCCH MO. For example, the DCI format 1_3 can schedule one PDSCH on cell c or more than one PDSCHs on cell c. For example, the UE may not be configured with transport block group (TBG) bundling for HARQ-ACK, or can be configured >1 TBGs for cell c, thereby scheduling of more than one PDSCHs on cell c can result in multiple HARQ-ACK information bits for cell c. For example, the UE counts the cell c once for each of the first DCI format and the second DCI format, regardless of a number of PDSCHs scheduled by the first DCI format or the second DCI format.

For example, if the UE indicates type2-HARQ-ACK-Codebook anu receives

$${N}_{PDSCH , c}^{m} > 1$$

PDSCHs on a serving cell c that are scheduled by

$${N}_{PDSCH , c}^{m}$$

DCI formats 1_3 in PDCCH receptions at a same PDCCH monitoring occasion m, where
each of the DCI formats 1_3 schedules more than one PDSCH receptions on respective more than one serving cells,
c is the smallest cell index among the respective more than one serving cells, and
c is same across the

$${N}_{PDSCH , c}^{m}$$

DCI formats 1_3
the serving cell c is counted

$${N}_{PDSCH , c}^{m}$$

times for PDCCH monitoring occasion m in increasing order of the PDSCH reception starting time among the

$${N}_{PDSCH , c}^{m}$$

PDSCH receptions.

For example, if the UE indicates type2-HARQ-ACK-Codebook and receives

$${N}_{PDSCH , c}^{m} > 1$$

PDSCHs on a serving cell c that are scheduled by

$${N}_{PDCCH , c}^{m} > 1$$

DCI formats 1_3, wherein

$${N}_{PDCCH , c}^{m} \leq {N}_{PDSCH , c}^{m} ,$$

in PDCCH receptions at a same PDCCH monitoring occasion m, where
each of the DCI formats 1_3 schedules more than one PDSCH receptions on one or more than one serving cells,
c is the smallest cell index among the respective one or more than one serving cells for each of the DCI formats 1_3, and
c is same across the

$${N}_{PDCCH , c}^{m}$$

DCI formats 1_3
the serving cell c is counted

$${N}_{PDCCH , c}^{m}$$

times for PDCCH monitoring occasion m in increasing order of the PDSCH reception starting time among

$${N}_{PDCCH , c}^{m}$$

PDSCH receptions, from the

$${N}_{PDSCH , c}^{m}$$

PDSCH receptions, that have respective earliest PDSCH reception starting time for each respective DCI format from the

$${N}_{PCCCH , c}^{m}$$

DCI formats 1_3.

In one realization, when a UE is configured multiple-PDSCH scheduling on a cell, such as by configuration of a TDRA table for the cell that includes at least one row with multiple SLIV entries, and when the UE is also configured TBG-based HARQ-ACK information bundling, the UE determines the corresponding TBGs or PDSCH reception groups and the corresponding HARQ-ACK information bits in ascending order of:
SLIV entry indexes, or
PDSCH reception starting time, or
PDSCH reception starting time.

For example, when the TDRA field of a DCI format indicates a row with 8 SLIV entries with indexes {0, 1, . . . , 7} for a cell, and the UE is configured 2 TBGs, in one option, the UE determines the first TBG or PDSCH reception group to correspond to SLIV entries with indexes {0, 1, 2, 3} and the second TBG or PDSCH reception group to correspond to SLIV entries with indexes {4, 5, 6, 7}.

In another option, the UE re-orders the SLIV entries in ascending order of PDSCH reception starting time to determine indexes {t0, t1, . . . , t7}, where SLIV index to may or may not be same as SLIV index 0, SLIV index t1 may or may not be same as SLIV index 1, and so on. For example, the UE determines the first TBG or PDSCH reception group to correspond to SLIV entries with indexes {t0, t1, t2, t3} and the second TBG or PDSCH reception group to correspond to SLIV entries with indexes {t4, t5, t6, t7}.

For example, the UE generates a first HARQ-ACK information bit for the first TBG or the first PDSCH reception group, and generates a second HARQ-ACK information bit for the second TBG or the second PDSCH reception group.

Such determination of TBGs or PDSCH reception groups and corresponding HARQ-ACK information can apply to an SC-DCI format such as DCI format 1_0/1_1/1_2 or an MC-DCI format such as DCI format 1_3.

If a UE is provided nrofHARQ-BundlingGroups and is not provided harq-ACK-SpatialBundlingPUCCH for a serving cell c, the UE generates HARQ-ACK information over transport block groups (TBGs) for PDSCH receptions on the serving cell c where, for a maximum number of

$${N}_{PDSCH , c}^{max}$$

PDSCH receptions scheduled by a DCI format on the serving cell c, a maximum number of TBGs

$${N}_{HARQ - ACK , c}^{TBG , max}$$

is provided by nrofHARQ-BundlingGroups. If the UE detects a DCI format scheduling N_{PDSCH,c} PDSCH receptions on the serving cell c, the UE generates

$${N}_{HARQ - ACK , c}^{TBG , max}$$

HARQ-ACK information bits for the first TBs and, if applicable, generates

$${N}_{HARQ - ACK , c}^{TBG , max}$$

HARQ-ACK information bits for the second TBs as described in clause 9.1.1 of [REF3] by setting

$${N}_{HARQ - ACK}^{CBG / TB , max} = {N}_{HARQ - ACK , c}^{TBG , max}$$

and C=N_{PDSCH,c}, and by replacing code block indices with (SLIV entry) indexes of the respective first TBs, or if applicable second TBs, of the N_{PDSCH,c} PDSCH receptions in the ascending order of the starting of PDSCH receptions. For a TBG associated with at least one PDSCH that does not overlap with an UL symbol indicated by tdd-UL-DL-ConfigurationCommon, or by tdd-UL-DL-ConfigurationDedicated if provided, the UE assumes that TB(s) provided by a PDSCH that overlaps with an UL symbol indicated by tdd-UL-DL-ConfigurationCommon, or by tdd-UL-DL-ConfigurationDedicated if provided, are correctly received. For a TBG associated only with PDSCHs that overlap with UL symbols indicated by tdd-UL-DL-ConfigurationCommon, or by tdd-UL-DL-ConfigurationDedicated if provided, the UE generates a NACK value for the TBG.

If a UE is provided nrofHARQ-BundlingGroups and harq-ACK-SpatialBundlingPUCCH for a serving cell c, the UE generates HARQ-ACK information over PDSCH reception groups for PDSCH receptions scheduled by a DCI format on the serving cell c where a maximum number of PDSCH reception groups,

$${N}_{HARQ - ACK , c}^{TBG , max} ,$$

is provided by nrofHARQ-BundlingGroups. If the UE detects a DCI format scheduling N_{PDSCH,c} PDSCH receptions on the serving cell c, the UE generates

$${N}_{HARQ - ACK , c}^{TBG , max}$$

HARQ-ACK information bits for the N_{PDSCH,c} PDSCH receptions as described in clause 9.1.1 of [REF3] by setting

$${N}_{HARQ - ACK}^{CBG / TB , max} = {N}_{HARQ - ACK , c}^{TBG , max}$$

and C=N_{PDSCH,c}, and by replacing code block indices with (SLIV entry) indexes of the respective first TBs, or if applicable second TBs, of the N_{PDSCH,c} PDSCH receptions in the ascending order of the starting of PDSCH receptions, after binary AND operation of the HARQ-ACK information bits corresponding to the first and second transport blocks of each PDSCH reception. For a PDSCH reception group associated with at least one PDSCH that does not overlap with an UL symbol indicated by tdd-UL-DL-ConfigurationCommon, or by tdd-UL-DL-ConfigurationDedicated if provided, the UE assumes that TBs provided by a PDSCH that overlaps with an UL symbol indicated by tdd-UL-DL-ConfigurationCommon, or by tdd-UL-DL-ConfigurationDedicated if provided, are correctly received. For a PDSCH reception group associated only with PDSCHs that overlap with UL symbols indicated by tdd-UL-DL-ConfigurationCommon, or by tdd-UL-DL-ConfigurationDedicated if provided, the UE generates a NACK value for the PDSCH reception group.

If a UE is provided either pdsch-TimeDomainAllocationListForMultiPDSCH or pdsch-TimeDomainAllocationListForMultiPDSCH-DCI-1-3 and neither provided nrofHARQ-BundlingGroups nor harq-ACK-SpatialBundlingPUCCH for a serving cell c, the UE generates HARQ-ACK information over transport blocks for PDSCH receptions. If the UE detects a DCI format scheduling N_{PDSCH,c} PDSCH receptions on the serving cell c, the UE generates N_{PDSCH,c} HARQ-ACK information bits for the first TBs in the ascending order of the starting of PDSCH receptions and, if applicable, generates N_{PDSCH,c} HARQ-ACK information bits for the second TBs in the ascending order of the starting of PDSCH receptions. For a PDSCH reception that overlaps with an UL symbol indicated by tdd-UL-DL-ConfigurationCommon, or by tdd-UL-DL-ConfigurationDedicated if provided, the UE generates a NACK value for the first TB and, if applicable, generates a NACK value for the second TB in the PDSCH reception. If

$${N}_{PDSCH , c} < {N}_{PDSCH , c}^{max} ,$$

the UE generates a NACK value for the last

$${N}_{TB , c}^{DL} \cdot {N}_{PDSCH , c}^{max} - {N}_{TB , c}^{DL} \cdot {N}_{PDSCH , c}$$

HARQ-ACK information bits where

$${N}_{TB , c}^{DL}$$

is the value of maxNrofCodeWordsScheduledByDCI for serving cell c and

$${N}_{PDSCH , c}^{max}$$

is determined by the maximum number of SLIVs amongst rows of the TDRA table configured by either pdsch-TimeDomainAllocationListForMultiPDSCH or pdsch-TimeDomainAllocationListForMultiPDSCH-DCI-1-3.

If a UE (e.g., the UE 116) is provided either pdsch-TimeDomainAllocationListForMultiPDSCH or pdsch-TimeDomainAllocationListForMultiPDSCH-DCI-1-3 and harq-ACK-SpatialBundlingPUCCH and not provided nrofHARQ-BundlingGroups for a serving cell c, the UE generates HARQ-ACK information over PDSCH receptions for PDSCH receptions scheduled by a DCI format on the serving cell c. If the UE detects a DCI format scheduling N_{PDSCH,c} PDSCH receptions on the serving cell c, the UE generates N_{PDSCH,c} HARQ-ACK information bits for the PDSCH receptions in the ascending order of the starting of PDSCH receptions after binary AND operation of the HARQ-ACK information bits corresponding to the first and second transport blocks of each PDSCH reception. For a PDSCH reception that overlaps with an UL symbol indicated by tdd-UL-DL-ConfigurationCommon, or by tdd-UL-DL-ConfigurationDedicated if provided, the UE generates a NACK value for the PDSCH reception. If

$${N}_{PDSCH , c} < {N}_{PDSCH , c}^{max} ,$$

the UE generates a NACK value for the last

$${N}_{PDSCH , c}^{max} - {N}_{PDSCH , c}$$

HARQ-ACK information bits.

In one embodiment, certain DCI fields can be indicated or interpreted differently in a DCI format 0_3/1_3 that schedules only a single PUSCH/PDSCH for a cell or for one or more or all cells in a set of cells compared to a DCI format 0_3/1_3 that schedules multiple PUSCHs/PDSCHs for the cell or for one or more or all cells in the set of cells. Such fields can include at least one of: UL-SCH field or CSI request field in a DCI format 0_3, that apply to a reference cell, such as a smallest cell index among co-scheduled cells by a DCI format 0_3, or a smallest cell index among first cells from the co-scheduled cells by the DCI format 0_3, wherein the first cells includes cells that are configured or scheduled with only one PUSCH transmission (e.g., only one SLIV indicated by TDRA). When the DCI format 0_3 schedules more than one PUSCHs on the reference cell, the UL-SCH field or the CSI request field may be absent (0 bits) or may apply only to a reference PUSCH from the multiple PUSCHs, for example, based on order of starting/ending time of PUSCH transmissions or based on ascending (or descending) order of SLIV in a corresponding TDRA table row or based on CSI computation/processing timeline. When certain fields in a DCI format 1_3 are repurposed as a bitmap to indicate SCell dormancy, the bitmap can include NDI bit and RV bits corresponding to first TB of only a reference PDSCH or first TBs of scheduled PDSCHs, on a cell with smallest cell index among cells that are not scheduled (e.g., with invalid FDRA value) by a DCI format 1_3.

In one example, an UL-SCH field in a DCI format 0_3 has 0 bits (absent) when one of:
a number of scheduled PUSCHs indicated by the TDRA field for a cell with smallest cell index, among cells that are co-scheduled by the DCI format 0_3, is greater than 1, or
a number of scheduled PUSCHs indicated by the TDRA field for at least one cell, among cells that are co-scheduled by the DCI format 0_3, is greater than 1, or
a number of scheduled PUSCHs indicated by the TDRA field for any cell, among cells that are co-scheduled by the DCI format 0_3, is greater than 1.

For example, the UL-SCH field is present in the DCI format 0_3 and has 1 bit when a corresponding condition for scheduling greater than 1 PUSCHs, such as one of the herein, is not satisfied, for example one of:
a number of scheduled PUSCHs indicated by the TDRA field for a cell with smallest cell index is equal to 1, or
a number of scheduled PUSCHs indicated by the TDRA field for any cell that is co-scheduled by the DCI format 0_3 is equal to 1, or
a number of scheduled PUSCHs indicated by the TDRA field for at least one cell, among cells that are co-scheduled by the DCI format 0_3, is equal to 1.

For example, the UL-SCH field applies to a cell with smallest cell index, among first cells from the co-scheduled cells by the DCI format 0_3, wherein the first cells have only one respective PUSCH scheduled indicated by the TDRA field of the DCI format 0_3. Such cell may or may not have a smallest cell index among the co-scheduled cells.

In another example, the DCI format 0_3 includes a 1-bit UL-SCH field when the DCI format 0_3 scheduled more than one PUSCHs on the cell with the smallest cell index, or more than one PUSCHs on at least one other cell from the co-scheduled cells by the DCI format 0_3.

In a first method, an UL-SCH field in a DCI format 0_3 applies to a cell with smallest cell index among the cells scheduled by the DCI format 0_3, regardless of whether the cell with smallest cell index is configured with one PUSCH transmission or multiple PUSCH transmissions (such as one SLIV or multiple SLIVs in any row of a corresponding TDRA table for a corresponding cell) and regardless of whether the UE is scheduled by a DCI format 0_3 one PUSCH transmission or multiple PUSCH transmissions (such as one SLIV or multiple SLIVs in a row of a corresponding TDRA table that is indicated for a corresponding cell) on the cell with smallest cell index.

For example, a value of the UL-SCH field applies to a reference PUSCH from a reference cell such as the cell with smallest cell index among the cells that are scheduled by a DCI format 0_3. For example, the reference PUSCH can be:
a PUSCH with earliest (or latest) starting PUSCH transmission time among more than one PUSCHs on the scheduled cell with smallest cell index, or
a PUSCH with latest (or earliest) ending PUSCH transmission time among more than one PUSCHs on the scheduled cell with smallest cell index, or
a PUSCH corresponding to a first (or last) SLIV value in the corresponding TDRA table/row for the scheduled cell with smallest cell index, or
a next-to-last/penultimate PUSCH (for example, corresponding to a next-to-last/penultimate value for PDSCH reception starting time (or ending time) or corresponding to a next-to-last/penultimate SLIV entry in an indicated row of a corresponding TDRA table) among more than one PUSCHs on the scheduled cell with smallest cell index, or
a PUSCH with a first (or last) starting time or ending time for PUSCH transmission that meets (or respectively, does not meet) the CSI computation/processing/multiplexing timeline on the scheduled cell with smallest cell index, or
a PUSCH corresponding to a first (or last) SLIV value in the corresponding TDRA table/row that meets the CSI computation/processing/multiplexing timeline on the scheduled cell with smallest cell index.

In one example, a reference cell may not be a cell with smallest cell index among the co-scheduled cells by the DCI format 0_3.

For example, the reference cell can be a cell with smallest cell index, among first cells from the co-scheduled cells by the DCI format 1_3, wherein the first cells have only one respective PUSCH scheduled indicated by the TDRA field of the DCI format 0_3. Such reference cell may or may not have a smallest cell index among the co-scheduled cells.

In another example, the UL-SCH field applies to a reference PUSCH from the more than one PUSCHs that are scheduled on one cell (if supported) or that are scheduled across multiple cells. For example, the reference PUSCH is one of:
a PUSCH with earliest (or latest) starting PUSCH transmission time among the more than one PUSCHs, or
a PUSCH with latest (or earliest) ending PUSCH transmission time among the more than one PUSCHs, or
a next-to-last/penultimate PUSCH with a next-to-last/penultimate value for PDSCH reception starting time (or ending time) among the more than one PUSCHs, or
a PUSCH with a first (or last) starting time or ending time for PUSCH transmission that meets the CSI computation/processing/multiplexing timeline among the more than one PUSCHs.

In a second method, an UL-SCH field in a DCI format 0_3 applies to a cell with smallest cell index among the cells scheduled by the DCI format 0_3, when the cell with smallest cell index is configured with only one PUSCH transmission (i.e., no multi-PUSCH TDRA table for a corresponding cell, such as when a TDRA table for the corresponding cell does not include any rows with multiple SLIVs) or when the cell with smallest cell index is scheduled with only one PUSCH transmission (i.e., a TDRA row that corresponds to a single SLIV for a corresponding cell). In such case, the UL-SCH field has 1 bit.

For example, the UL-SCH field has 0 bits, for example, when the cell with smallest cell index is configured with more than one PUSCH transmissions or when the UE is scheduled by the DCI format 0_3 more than one PUSCH transmissions on the cell with smallest cell index.

In a third method, an UL-SCH field in a DCI format 0_3 applies to a reference cell such as a cell with smallest cell index among first cells from the cells scheduled by the DCI format 0_3, wherein the first cells correspond to a single PUSCH, such as configured with only single-PUSCH transmission (e.g., no multi-PUSCH TDRA table for a corresponding cell, such as when a TDRA table for the corresponding cell does not include any rows with multiple SLIVs) or the first cells includes cells that are scheduled only a single PUSCH (i.e., a TDRA row that corresponds to a single SLIV for a corresponding cell) by the DCI format 0_3. For example, the DCI format 0_3 indicates a TDRA codepoint that provides single SLIV for each cell from the first cells.

For example, the UL-SCH field has 0 bits, for example, when cells scheduled by the DCI format 0_3 are configured with more than one PUSCH transmissions (e.g., multi-PUSCH TDRA table for corresponding cell, such as when a TDRA table for the corresponding cell includes at least one row with multiple SLIVs), or when the UE is scheduled more than one PUSCH transmissions on any/all cells scheduled by the DCI format 0_3.

Similar methods, such as the first/second/third methods as previously described, can apply to a CSI request field in DCI format 0_3.

For example, a CSI request field of a DCI format 0_3 applies to a reference PUSCH from a reference cell such as the cell with smallest cell index among the cells that are scheduled by the DCI format 0_3. For example, the reference PUSCH can be:
a PUSCH with earliest (or latest) starting PUSCH transmission time among more than one PUSCHs on the scheduled cell with smallest cell index, or
a PUSCH with latest (or earliest) ending PUSCH transmission time among more than one PUSCHs on the scheduled cell with smallest cell index, or
a PUSCH corresponding to a first (or last) SLIV value in the corresponding TDRA table/row for the scheduled cell with smallest cell index, or
a next-to-last/penultimate PUSCH (for example, corresponding to a next-to-last/penultimate value for PDSCH reception starting time (or ending time) or corresponding to a next-to-last/penultimate SLIV entry in an indicated row of a corresponding TDRA table) among more than one PUSCHs on the scheduled cell with smallest cell index, or
a PUSCH with a first (or last) starting time or ending time for PUSCH transmission that meets (or respectively, does not meet) the CSI computation/processing/multiplexing timeline on the scheduled cell with smallest cell index, or
a PUSCH corresponding to a first (or last) SLIV value in the corresponding TDRA table/row that meets the CSI computation/processing/multiplexing timeline on the scheduled cell with smallest cell index.

For example, the CSI request field of a DCI format 0_3 applies to a cell with smallest cell index, among first cells from the co-scheduled cells by the DCI format 0_3, wherein the first cells have only one respective PUSCH scheduled indicated by the TDRA field of the DCI format 0_3. Such cell may or may not have a smallest cell index among the co-scheduled cells.

In another example, the CSI request field of a DCI format 0_3 applies to a reference PUSCH from the more than one PUSCHs that are scheduled on one cell (if supported) or that are scheduled across multiple cells. For example, the reference PUSCH is one of:
a PUSCH with earliest (or latest) starting PUSCH transmission time among the more than one PUSCHs, or
a PUSCH with latest (or earliest) ending PUSCH transmission time among the more than one PUSCHs, or
a next-to-last/penultimate PUSCH with a next-to-last/penultimate value for PDSCH reception starting time (or ending time) among the more than one PUSCHs, or
a PUSCH with a first/earliest (or last/latest) starting time (or ending time) for PUSCH transmission that meets the CSI computation/processing/multiplexing timeline among the more than one PUSCHs.

For example, a UE is not expected to receive a DCI format 0_3 with UL-SCH indicator of “0” and CSI request of zero(s).

For example, if a UE does not support triggering SRS only in DCI, except for DCI format 0_1 with CRC scrambled by SP-CSI-RNTI, the UE is not expected to receive a DCI format 0_3 with UL-SCH indicator of “0” and CSI request of zero(s).

If a UE supports triggering SRS only in DCI, except for DCI format 0_1 with CRC scrambled by SP-CSI-RNTI, the UE is not expected to receive a DCI format 0_3 with UL-SCH indicator of “0”, CSI request of zero(s) and SRS request of zero(s).

The UE is not expected to receive a DCI format 0_3 with UL-SCH indicator of “0”, when the indicated number of layers for a reference cell (such as the smallest cell index per the first/second/third method) and/or for a reference PUSCH such as a reference PUSCH on the reference cell, as previously described, is larger than 4.

Upon detection of a DCI format 0_3 with ‘UL-SCH indicator’ set to ‘0’ and with a non-zero ‘CSI request’ where the associated reportQuantity in CSI-ReportConfig set to ‘none’ for CSI report(s) triggered by ‘CSI request’ in this DCI format 0_3, in one option, the UE ignores fields for the scheduled cell with the smallest serving cell index in this DCI, as previously described in the first/second/third methods herein:
corresponding to the only one PUSCH on such cell with the smallest serving cell index in this DCI when the UE is configured with only one PUSCH transmission on such cell, or scheduled by the DCI format 0_3 with only one PUSCH transmission on such cells, or
corresponding to a reference PUSCH on such cell, as previously described, for example, with earliest/latest starting time or earliest/latest ending time of PUSCH transmission on such cell (with or without condition on satisfying the CSI computation/processing/multiplexing timeline), or corresponding to first/last SLIV value for such cells, or
corresponding to of the one or more multiple PUSCHs scheduled by DCI format 0_3 on such cell,
except the ‘CSI request’ field, and the UE shall not transmit the corresponding PUSCH, as in examples herein, on the serving cell with the smallest serving cell index as indicated by this DCI format 0_3.

For example, in various examples herein, the “cell with the smallest serving cell index in this DCI” can refer to a cell with smallest cell index among the scheduled cells by the DCI format 0_3, or can be a cell with smallest cell index among first cells from the scheduled cell by the DCI format 0_3, wherein the first cells include cells are that configured by TDRA configuration with only one PUSCH transmission (e.g., one SLIV) or scheduled by the DCI format 0_3 with only one PUSCH transmission (e.g., only one SLIV).

For example, when the UE is scheduled multiple PUSCHs on such reference cell for UL-SCH field or CSI request field, as previously described, the UE may discard scheduling information/DCI fields corresponding to the reference PUSCH except for the CSI request field, as previously described, on the reference cell, while the UE can transmit other scheduled PUSCHs on the reference cell.

In another option, upon detection of a DCI format 0_3 with ‘UL-SCH indicator’ set to ‘0’ and with a non-zero ‘CSI request’ where the associated reportQuantity in CSI-ReportConfig set to ‘none’ for CSI report(s) triggered by ‘CSI request’ in this DCI format 0_3, the UE ignores DCI fields corresponding to a reference PUSCH scheduled by this DCI format, as previously described in the example herein such as:
a PUSCH with earliest (or latest) starting PUSCH transmission time among more than one PUSCHs that are scheduled by the DCI format 1_3 on one cell (if supported) or across multiple cells, or
a PUSCH with latest (or earliest) ending PUSCH transmission time among the more than one PUSCHs, or
a next-to-last/penultimate PUSCH with a next-to-last/penultimate value for PDSCH reception starting time (or ending time) among the more than one PUSCHs, or
a PUSCH with a first/earliest (or last/latest) starting time (or ending time) for PUSCH transmission that meets the CSI computation/processing/multiplexing timeline among the more than one PUSCHs,
except the ‘CSI request’ field, and the UE shall not transmit the corresponding reference PUSCH, as in examples herein. For example, such reference PUSCH may or may not be on a serving cell with smallest serving cell index among cells that are co-scheduled by this DCI format 0_3.

For example, the UE may discard scheduling information/DCI fields corresponding to such reference PUSCH except for the CSI request field, as previously described, while the UE can transmit other scheduled PUSCHs, if any, on a same cell.

In another option, the UE discards of the multiple different PUSCHs that are scheduled by the DCI format 1_3 on a same cell as the cell for the reference PUSCH (may or may not be a reference cell), as previously described.

In various embodiments, methods, or examples, invalid or reserved values for FDRA field of a DCI format 1_3 (or a DCI format 0_3) may refer to one or more of the following:
resource Allocation=resource Allocation Type0 and all bits of a block of the frequency domain resource assignment (FDRA) field, associated with a cell such as an activated SCell, in the DCI format 0_3/1_3 are equal to 0, or
resource Allocation=resourceAllocationType1 and all bits of a block of the frequency domain resource assignment (FDRA) field, associated with a cell such as an activated SCell, in the DCI format 0_3/1_3 are equal to 1, or
resource Allocation dynamicSwitch and all bits of a block of the frequency domain resource assignment (FDRA) field, associated with a cell such as an activated SCell, in the DCI format 0_3/1_3 are equal to either 0 or 1, or
useInterlacePUCCH-PUSCH is provided and all bits of a block of the frequency domain resource assignment (FDRA) field, associated with a cell such as a serving cell, in the DCI format 0_3 are equal to 1 for μ=0 or all bits of the block are equal to 0 for μ=1.

When certain fields in a DCI format 1_3 are repurposed as a bitmap to indicate SCell dormancy, the bitmap can include NDI bit and RV bits corresponding to first TB of only a reference PDSCH or first TBs of scheduled PDSCHs, on a reference cell scheduled by a DCI format 1_3.

For example, the reference cell can be a cell with smallest cell index among the cells that are not scheduled (e.g., with invalid or reserved FDRA value) by the DCI format 1_3, regardless of whether one or multiple PDSCHs (e.g., one or multiple SLIVs) are indicated for the cell by the TDRA codepoint of the DCI format 1_3. For example, the reference cell can be a cell with smallest cell index among first cells from the cells that are not scheduled (e.g., with invalid or reserved FDRA value) by the DCI format 1_3, wherein the first cells are cells for which the TDRA codepoint of the DCI format 1_3 indicates only one respective PDSCH (e.g., only one SLIV).

For example, the reference PDSCH can be the only PDSCH indicated on the reference cell, when DCI format 1_3 indicates only one PDSCH (e.g., only one SLIV) for the reference cell. For example, the UE expects that DCI format 1_3 indicates only one PDSCH (e.g., only one SLIV) by the TDRA codepoint for the cell with smallest cell index among non-scheduled cells (i.e., with invalid FDRA value).

For example, when DCI format 1_3 indicates more than one PDSCHs (e.g., more than one SLIV) for the reference cell, the reference PDSCH can be:
a PDSCH with earliest (or latest) starting time for PDSCH reception, or
a PDSCH with latest (or earliest) ending time for PDSCH reception, or
a PDSCH with first (or last) SLIV entry in the corresponding TDRA entry/row,
among the multiple PDSCHs indicated for the reference cell.

For example, when the UE is indicated more than one PDSCHs (e.g., more than one SLIVs) for the reference cell, and the bitmap for SCell dormancy indication includes fields only corresponding to a reference PDSCH from the more one PDSCHs, the UE can generate only one ACK bit for the reference PDSCH/SLIV, while the UE can generate NACK bits for other indicated PDSCHs/SLIVs. In another example, the UE can be scheduled first PDSCHs on such reference cell, and therefore provide first HARQ-ACK information bits corresponding to the first PDSCHs, wherein the first PDSCHs include more than one PDSCHs, except for the reference PDSCH. For example, the UE can include an ACK corresponding to the SCell dormancy indication in a same order/place (e.g., based on ascending order of SLIV or PDSCH reception timing) as that corresponding to the reference PDSCH relative to the first PSDCHs.

In another example, the bitmap can include RV bits and NDI bits corresponding to first TBs of the multiple PDSCHs (e.g., multiple SLIVs) indicated for the reference cell. For example, the UE considers the RV bits in the bitmap in ascending (or descending) order of PDSCH reception starting/ending time as per corresponding SLIV entries, or in ascending order of SLIV index.

Similar methods apply to ordering of NDI bits corresponding to first TBs of the multiple PDSCHs (e.g., multiple SLIVs) indicated for the reference cell, in the bitmap for SCell dormancy indication.

For example, the UE can generate a number of ACK bits equal to a number of PDSCHs (e.g., SLIVs) indicated by the TDRA field of the DCI format 1_3 for the reference cell, expecting a single TB correctly received for such multiple PDSCHs.

For example, for generation of HARQ-ACK codebook, the UE may assume that that the UE receives a PDSCH on the serving cell associated with fields in DCI format 1_3 used for SCell dormancy indication, and a corresponding TB is correctly received. For example, the TDRA field of the DCI format 1_3 can indicate multiple PDSCHs/SLIVs for such serving cell whose associated fields are used for SCell dormancy indication, including NDI and RV fields. For example, the DCI format 1_3 can include RV and NDI fields that include multiple blocks corresponding to the multiple PDSCH SLIVs indicated by the TDRA field for such non-scheduled cell, and such NDI and RV fields can be fully used for the dormancy indication. For example, the NDI and RV fields (and not a certain part/block of those fields) are used for SCell dormancy indication. For example, there may be no restriction that only a TDRA with single SLIV is expected for such serving cell.

For example, methods herein may also apply to other DCI formats for scheduling multiple PDSCHs on a cell and used for SCell dormancy indication, such as a DCI format 1_1 that schedules multiple PDSCHs on a cell and is used for SCell dormancy indication.

In one embodiment, when a set of co-scheduled cells include cells with different SCS, a number of unicast DL or UL DCI formats that a UE supports can be based on a ratio of the scheduling cell SCS and a first SCS for first scheduled cells or a second SCS for second scheduled cells, and counting can be in a time duration that depends on both such SCSs.

The structure of UE features for multi-cell scheduling on cells with different SCS or carrier type can be based on that for same SCS and same carrier type. For example, taking into account PDSCH scheduling, FG 49-1 and FG 49-1b in TR 38.822 v18.0.0 can be used as baseline, while the following aspects/components can be revised:
Title of new FG: Since the set of cells include co-scheduled cells with two different SCS values, the scheduling cell will anyways have a different SCS from at least some of the cells in the set. Therefore, a distinction whether the scheduling cell is inside or outside the set of cells (as in FG 49-1 and FG 49-1b) is not relevant anymore. For example, for a set of cells that includes cells {1, 2, 3, 4}, with cell #1 and cell #2 having a first SCS, and cell #3 and cell #4 having a second SCS, the scheduling cell can be within the set of cells, such as cell #1, or can be outside the set of cells, such as a cell #0.
Components 1: can be based on combination and extension of corresponding component from FG 49-1 and FG 49-1b, for example, as follows:
   1) UE supports monitoring DCI format 1_3 for DL scheduling with different SCS and/or different carrier type between scheduling cell and cells in the set. The scheduling cell is included or not included in the set of cells, and is in a same PUCCH group as the set of cells.
Component 2: can reuse the more general description of FG 49-1 to avoid Rel-17 dynamic spectrum sharing (DSS) scenarios.
   2) Scheduling cell is PCell if set of cells includes PCell, and scheduling cell is PCell or an SCell if set of cells includes only SCells.
Component 3: can be based on components 3 and 12 from FG 49-1, components 3a/3b of FG 49-1b, Agreement from RAN1 #118bis, and the simplification in Proposal 1, collectively captured as follows (a restructure can be further discussed in RAN1 or RAN2 for additional simplification):
   3) Scheduling cell and co-scheduled cells have same or different SCS, and same or different carrier type. The set of co-scheduled cells have one or two different SCS values, and two different carrier types, by indicating support/not-support for one or multiple of the following cases.
Case 1-1: Scheduled cells include {FR1 licensed FDD cell(s) with SCS1 and FR1 licensed TDD cell(s) with SCS2} and {SCS1 same as SCS2}
   Scheduling cell from candidate value {FR1 licensed FDD, FR1 licensed TDD}
   Case 1-1a: Scheduling cell with SCS3 same as SCS1/SCS2
   Case 1-1b: Scheduling cell with SCS3 from candidate value: {SCS3 lower than SCS1/SCS2, SCS3 higher than SCS1/SCS2, both}
   Case 1-la and Case 1-1b can be separate or merged
Case 1-2: Scheduled cells include {FR1 licensed FDD cell(s) with SCS1 and FR1 licensed TDD cell(s) with SCS2} and {SCS1 different from SCS2}
   Scheduling cell from candidate value {FR1 licensed FDD, FR1 licensed TDD}
   Case 1-2a: Scheduling cell with SCS3 from candidate value: {SCS3 equal to min {SCS1, SCS2}, SCS3 equal to max {SCS1, SCS2}, both}
   Case 1-2b: Scheduling cell with SCS3 from candidate value: {SCS3 lower than min {SCS1, SCS2}, SCS3 higher than max {SCS1, SCS2}, both}
   Case 1-2a and Case 1-2b can be separate or merged
   Case 1-2c: Scheduling cell with SCS3 strictly between SCS1 and SCS2
Case 2-1: Scheduled cells include {FR1 licensed FDD cell(s) with SCS1 and FR2-1 cell(s) with SCS2} and {SCS1 same as SCS2}
   Scheduling cell from candidate value {FR1 licensed FDD, FR1 licensed TDD}
   Case 2-la: Scheduling cell with SCS3 same as SCS1/SCS2
   Case 2-1b: Scheduling cell with SCS3 lower than SCS1/SCS2
      Note 1: At least SCS1=SCS2=60 kHz is applicable for Case 2-1
      Note 1: SCS3 higher than SCS1/SCS2 may not apply when the scheduling cell is in FR1
   Case 2-la and Case 2-1b can be separate or merged
Case 2-2: Scheduled cells include {FR1 licensed FDD cell(s) with SCS1 and FR2-1 cell(s) with SCS2} and {SCS1 different from SCS2}
   Scheduling cell from candidate value {FR1 licensed FDD, FR1 licensed TDD}
   Case 2-2a: Scheduling cell with SCS3 from candidate value: {SCS3 equal to min {SCS1, SCS2}, [FFS SCS3 equal to max {SCS1, SCS2}, FFS both]}
   Case 2-2b: Scheduling cell with SCS3 lower than min {SCS1, SCS2}
      Note: SCS3 higher than max {SCS1, SCS2} may not apply when the scheduling cell is in FR1
   Case 2-2a and Case 2-2b can be separate or merged
   Case 2-2c: Scheduling cell with SCS3 strictly between SCS1 and SCS2
Case 3-1: Scheduled cells include {FR1 licensed TDD cell(s) with SCS1 and FR2-1 cell(s) with SCS2} and {SCS1 same as SCS2}
   Scheduling cell from candidate value {FR1 licensed FDD, FR1 licensed TDD}
   Case 3-1a: Scheduling cell with SCS3 same as SCS1/SCS2
   Case 3-1b: Scheduling cell with SCS3 lower than SCS1/SCS2
      Note 1: At least SCS1=SCS2-60 kHz is applicable for Case 3-1
      Note 1: SCS3 higher than SCS1/SCS2 may not apply when the scheduling cell is in FR1
   Case 3-1a and Case 3-1b can be separate or merged
Case 3-2: Scheduled cells include {FR1 licensed TDD cell(s) with SCS1 and FR2-1 cell(s) with SCS2} and {SCS1 different from SCS2}
   Scheduling cell from candidate value {FR1 licensed FDD, FR1 licensed TDD}
   Case 3-2a: Scheduling cell with SCS3 from candidate value: {SCS3 equal to min {SCS1, SCS2}, [FFS SCS3 equal to max {SCS1, SCS2}, FFS both]}
   Case 3-2b: Scheduling cell with SCS3 lower than min {SCS1, SCS2}
      Note: SCS3 higher than max {SCS1, SCS2} may not apply when the scheduling cell is in FR1
   Case 3-2a and Case 3-2b can be separate or merged
   Case 3-2c: Scheduling cell with SCS3 strictly between SCS1 and SCS2
Components 4-9: can directly follow FG 49-1/49-2 without any change. For example, components 4, 5, 6 on number of co-scheduled cells or number of cell sets, component 7 on HARQ-ACK CB type, component 8 on the scheme for co-scheduled cell indication, component 9 on the support of AP field as Type-2, do not depend on the SCS or carrier type, so no change is needed.
Component 10: can follow from the more general description in FG 49-1b, with some modification to handle different cases in component 3, as provided herein. In the following, “same SCS” means scheduling cell and co-scheduled cells share the same SCS, and “low-to-high SCS” means the scheduling cell has lower SCS than at least some of the co-scheduled cells, and same SCS as other co-scheduled cells, if any. Handling as in Rel-18 MCE would be sufficient.

On the other hand, “high-to-low SCS” means the scheduling cell has higher SCS than at least some of the co-scheduled cells, and same SCS as other co-scheduled cells, if any. For this case, additional handling is needed, as per UE feature requirements for the same/non-mixture SCS case, the UE would be required to support more unicast DCIs for scheduled cells that have same or closer SCS to the scheduling cell SCS, compared to scheduled cells that have different or further SCS than the scheduling cell SCS.

For example, take into account a scheduling cell with SCS3=30 kHz, and two cells in the set of co-scheduled cells with lower SCS1=15 kHz, while the other two cells in the set have same SCS2=30 kHz. Based on UE features, for the first two scheduled cells (with lower SCS), the UE would be required to support 1 unicast DL DCI per 2 consecutive slots of the scheduling cell. However, for the second two scheduled cells (with same SCS), the UE would be required to support 1 unicast DL DCI per 1 slot of the scheduling cell, or equivalently 2 unicast DL DCIs per 2 consecutive slots of the scheduling cell.

More precisely, when treated separately, the first scheduled cells with SCS1 would support 1 unicast DL DCI per N1 consecutive slots of the scheduling cell, and the second scheduled cells with SCS2 would support 1 unicast DL DCI per N2 consecutive slots of the scheduling cell, where

$$N 1 = \frac{SCS 3}{SCS 1} and N 2 = \frac{SCS 3}{SCS 2} .$$

In the example herein, N1=2 and N2=1.

Now, when treated jointly as a set of co-scheduled cells, the number of unicast DL DCIs is defined with respect to the scheduled cell with smallest SCS, i.e., max {N1, N2}=2 slots. Therefore, within a time window of max {N1, N2} slots, a total of

$$\frac{max \{ N 1 , N 2 \}}{N 1}$$

unicast DL DCIs are required for cells with SCS1 and a total of

$$\frac{max \{ N 1 , N 2 \}}{N 2}$$

unicast DL DCIs are required for cells with SCS2, each of which is split between the one DCI format 1_3 and a number of SC-DCI formats, if any remaining.

Therefore, component 10 can be characterized as follows:
10a) The number of unicast DL DCIs to process per slot of scheduling cell for a set of cells configured for multi-cell PDSCH scheduling by DCI format 1_3: One DCI format 1_3 for the set of cells and, one unicast DL DCI formats 1_0/1_1/1_2 (if supported) for each of the cells that are not scheduled by DCI 1_3
   Applies for same SCS.
   Applies for low-to-high SCS (i.e., scheduling cell has lower SCS than at least some cells from the set of cells, and same SCS as remaining cells in the set of cells, if any).
10b) The number of unicast DL DCIs to process per max {N1, N2} consecutive slots of scheduling cell for a set of cells configured for multi-cell PDSCH scheduling by DCI format 1_3:
   One DCI format 1_3 for the set of cells and,

$$\frac{max \{ N 1 , N 2 \}}{N 1} - 1$$

unicast DL DCI formats 1_0/1_1/1_2 (if supported) for each of the cells with SCS1 that are scheduled by DCI 1_3

$$\frac{max \{ N 1 , N 2 \}}{N 2} - 1$$

unicast DL DCI formats 1_0/1_1/1_2 (if supported) for each of the cells with SCS2 that are scheduled by DCI 1_3

$$\frac{max \{ N 1 , N 2 \}}{N 1} - 1$$

unicast DL DCI formats 1_0/1_1/1_2 (if supported) for each of the cells with SCS1 that are not scheduled by DCI 1_3

$$\frac{max \{ N 1 , N 2 \}}{N 2}$$

unicast DL DCI formats 1_0/1_1/1_2 (if supported) for each of the cells with SCS2 that are not scheduled by DCI 1_3
   Applies for high-to-low SCS (i.e., scheduling cell has higher SCS than at least some cells from the set of cells, and same SCS as remaining cells in the set of cells, if any), N1 and N2 are based on pair of (scheduling CC SCS, respective scheduled CC SCS), i.e., N1=ratio of (SCS3, SCS1) and N2=ratio of (SCS3, SCS2) per description in component 3: N=2 for (30,15), (60,30), (120,60) and N=4 for (60,15), (120,30), N=8 for (120,15)
   FFS the number of unicast DL DCIs when scheduling CC SCS is strictly in between scheduled CC SCS, if supported
Component 11: can follow from the more general description in FG 49-1. It is noted that, unlike Rel-18 MCE, the scheduling cell in Rel-19 MCE can be included in the set of co-scheduled cells even though the scheduling cell has different SCS than at least some of the co-scheduled cells, so the restrictions in component 11 of FG 49-1b are not applicable here.
11) Monitoring SS set(s) for DCI format 1_3 for a set of cells for the following cases:
1) Search space set configuration for DCI format 1_3 for the set of cells is provided only on the scheduling cell, or;
2) Search space set configurations for DCI format 1_3 for the set of cells with the same searchSpaceId are provided on both the scheduling cell and a serving cell in the set of cells with the scheduling cell being NOT in the set of cells
UE supporting FG 49-X can additionally report whether the UE (e.g., the UE 116) support following case
3) Search space set configurations for DCI format 1_3 for the set of cells with the same searchSpaceId are provided on both the scheduling cell and a serving cell in the set of cells with the scheduling cell being in the set of cells

Similar discussion applies to UL DCI 0_3 based on an extension of FG 49-2 and FG 49-2b. For example, for the case of FDD scheduling cell, same number of unicast UL DCIs can apply. For example, for the case of TDD scheduling cell, and for the high-to-low case, a number of unicast UL DCIs can be twice the counts herein, or such that, in a period of max {N1, N2} consecutive slots, each scheduled cell with SCS1 can support a total of

$$2 \frac{max \{ N 1 , N 2 \}}{N 1}$$

unicast UL DCIs, and each scheduled cell with SCS2 can support a total of

$$2 \frac{max \{ N 1 , N 2 \}}{N 2}$$

unicast UL DCIs, that can be split among 1 DCI format 0_3 for the set of cells, and remaining are DCI formats 0_0/0_1/0_2 for each cell based on whether the cell is scheduled or is not scheduled by the DCI format 0_3.

FGs 66-1 and 66-2 for multi-cell scheduling with different SCS/carrier type should be updated to support different SCS and different carrier type, and any UE feature pursuing different SCS and same carrier type should be deprioritized. In particular, the following aspects can be taken into account for FGs 66-1/66-2:
Include the restriction for different carrier types into the title and description of FGs 66-1/66-2;
Usage of up to two SCS values for co-scheduled cells, and same can be extended to the (carrier type, SCS) combinations.
For the set of co-scheduled cells, additional combinations of (carrier type, SCS) can be taken into account within FG 66-1/66-2, including (FR2-1, 60 kHz) and (FR1 unlicensed TDD, 30 kHz), although such support should not be together with another pair with same SCS or with same carrier type. Therefore, the set of scheduled cells should not include (FR2-1, 60 kHz) together with (FR2-1, 120 kHz), or should not include (FR1 unlicensed TDD, 30 kHz) together with (FR1 licensed TDD, 30 kHz).
The Rel-18 MCE features are not prerequisites, and the new FGs for Rel-19 MCE can be introduced independently.

Accordingly, apply the following updates to the FGs 66-1 and 66-2:

| Index | Feature group | Components |
|---|---|---|
| 66-1 | Multi-cell PDSCH scheduling | 1. UE supports monitoring DCI format 1_3 for DL |
| | by DCI format 1_3 with | scheduling with different SCS and different carrier |
| | different SCS and different | type for the cells in the set |
| | carrier type | 2. Supported applicable combinations of the |
| | | following from the band combination: |
| | | Two pairs of (carrier type, SCS) for the cells in the |
| | | set: {(FR1 licensed FDD, 15 kHz), (FR1 licensed |
| | | TDD, 30 kHz), (FR1 unlicensed TDD, 30 kHz), |
| | | (FR2-1, 60 kHz), (FR2-1, 120 kHz)} |
| | | A pair of (carrier type, SCS) for scheduling cell: |
| | | {(FR1 licensed FDD, 15 kHz), (FR1 licensed TDD, |
| | | 30 kHz)} |
| | | This FG cannot indicate two pairs of (carrier type, |
| | | SCS) for the cells in the set as (FR2, 60 kHz) and |
| | | (FR2, 120 kHz) |
| | | This FG cannot indicate two pairs of (carrier type, |
| | | SCS) for the cells in the set as (FR1 unlicensed TDD, |
| | | 30 kHz) and (FR1 licensed TDD, 30 kHz) |
| | | FFS: Other component(s) |

| | | |
|---|---|---|
| 66-2 | Multi-cell PUSCH scheduling | 1. UE supports monitoring DCI format 0_3 for UL |
| | by DCI format 0_3 with | scheduling with different SCS and different carrier type |
| | different SCS and different | for the cells in the set |
| | carrier type | 2. Supported applicable combinations of the following |
| | | from the band combination: |
| | | Two sets of (carrier type, SCS) for the cells in the set: |
| | | {(FR1 licensed FDD, 15 kHz), (FR1 licensed TDD, |
| | | 30 kHz), (FR1 unlicensed TDD, 30 kHz), (FR2-1, |
| | | 60 kHz), (FR2-1, 120 kHz)} |
| | | A pair of (carrier type, SCS) for scheduling cell: |
| | | {(FR1 licensed FDD, 15 kHz), (FR1 licensed TDD, |
| | | 30 kHz)} |
| | | This FG cannot indicate two pairs of (carrier type, |
| | | SCS) for the cells in the set as (FR2, 60 kHz) and (FR2, |
| | | 120 kHz) |
| | | This FG cannot indicate two pairs of (carrier type, |
| | | SCS) for the cells in the set as (FR1 unlicensed TDD, |
| | | 30 kHz) and (FR1 licensed TDD, 30 kHz) |
| | | FFS: Whether/how to define separate FG for reporting |
| | | three sets of (carrier type, SCS) for the cells in the set |
| | | FFS: Whether/how to define separate FG for reporting |
| | | unlicensed band in the sets of (carrier type, SCS) for |
| | | the cells in the set |
| | | FFS: Other component(s) |

In addition to the instances herein, the Rel-19 MCE FGs 66-1/66-2 can mostly reuse the structure of UE features for Rel-18 MCE. For example, taking into account PDSCH scheduling, FG 49-1 and FG 49-1b can be used as baseline, while the following aspects/components need to be revised:
Components 3: Since the set of cells include co-scheduled cells with two different SCS values, the scheduling cell will anyways have a different SCS from at least some of the cells in the set. Therefore, a distinction whether the scheduling cell is inside or outside the set of cells (as in FG 49-1 and FG 49-1b) is not relevant anymore. For example, for a set of cells that includes cells {1, 2, 3, 4}, with cell #1 and cell #2 having a first SCS, and cell #3 and cell #4 having a second SCS, the scheduling cell can be within the set of cells, such as cell #1, or can be outside the set of cells, such as a cell #0.
Therefore, Component 3 can be based on combination and extension of components 1 from FG 49-1/49-1b, and component 2 of FG 49-1, for example, as follows:
   3) The scheduling cell is included or not included in the set of cells, and is in a same PUCCH group as the set of cells.
   Scheduling cell is PCell if set of cells includes PCell, and scheduling cell is PCell or an SCell if set of cells includes only SCells.
Components 4-9: can directly follow FG 49-1/49-2 without any change. For example, components 4, 5, 6 on number of co-scheduled cells or number of cell sets, component 7 on HARQ-ACK CB type, component 8 on the scheme for co-scheduled cell indication, component 9 on the support of AP field as Type-2, do not depend on the SCS or carrier type, so no change is needed.
Component 10: can follow from the description in FG 49-1/49-1b, with some clarification to handle different cases in component 2.
   When the scheduling cell is (FR1 licensed FDD, 15 kHz) and the scheduled cell set includes cells with SCS {15 kHz+30 kHz}, or {15 kHz+60 kHz}, or {15 kHz+120 KHz}, or {30 KHz+60 kHz}, or {30 KHz+120 kHz}, handling with same SCS/low-to-high SCS from Rel-18 MCE can directly apply with:
      1 DCI format 1_3 for the set of cells, per slot of scheduling cell (15 kHz), and
      1 DCI format 1_0/1_1/1_2, per slot of scheduling cell (15 kHz), for each cell in the cell set that is not scheduled by the DCI format 1_3;
   When the scheduling cell is (FR1 licensed TDD, 30 kHz) and the scheduled cell set includes cells with SCS {30 KHz+60 kHz} or {30 KHz+120 kHz}, handling with same SCS/low-to-high SCS from in Rel-18 MCE can directly apply with:
      1 DCI format 1_3 for the set of cells, per slot of scheduling cell (30 kHz), and
      1 DCI format 1_0/1_1/1_2, per slot of scheduling cell (30 kHz), for each cell in the cell set that is not scheduled by the DCI format 1_3;
   When the scheduling cell is (FR1 licensed TDD, 30 kHz) and the scheduled cell set includes cells with SCS {15 kHz+30 kHz}, handling with same SCS/high-to-low SCS from Rel-18 MCE can directly apply with:
      1 DCI format 1_3 for the set of cells, per slot of scheduling cell (30 kHz)—this is to preserve a same UE capability for DCI processing as for the case of same SCS for scheduling cell SCS=30 kHz and scheduled cell SCS=30 kHz;
      Up to 1 DCI formats 1_0/1_1/1_2, per N1=2 consecutive slots of scheduling cell (30 kHz), for each cell in the cell set with SCS=15 kHz;
      Up to 1 DCI formats 1_0/1_1/1_2, per N2=1 slot of scheduling cell (30 kHz), for each cell in the cell set with SCS=30 kHz;
      No more than 1 DCI scheduling PDSCH, per N1=2 consecutive slots of scheduling cell (30 kHz), for each cell in the cell set with SCS=15 kHz;
      No more than 1 DCI scheduling PDSCH, per N2=1 slot of scheduling cell (30 kHz), for each cell in the cell set with SCS=30 kHz;
      The latter restrictions ensure that the UE capability does not exceed the limits for DCI processing.
   When the scheduling cell is (FR1 licensed TDD, 30 kHz) and the scheduled cell set includes cells with SCS {15 kHz+60 kHz} or {15 kHz+120 kHz}, handling can be fully reused:
      Handling of scheduling cell with SCS=30 kHz to scheduled cells with SCS=15 kHz follows high-to-low MCE, same as herein;
      Handling of scheduling cell with SCS=30 kHz to scheduled cells with SCS=60 kHz or SCS=120 kHz follows low-to-high MCE, which is identical to the same-SCS case, including usage of N2=1 same as for scheduled cells with SCS=30 kHz.
      Note: There has been implementations [3] for simply reusing Component 10 of FGs 49-1/49-1b based on the smallest SCS of the set of scheduled cells. Such extension would result in less DCI processing capability than, and is not preferred.
Component 11: can follow from the more general description in FG 49-1. It is noted that, unlike Rel-18 MCE, the scheduling cell in Rel-19 MCE can be included in the set of co-scheduled cells even though the scheduling cell has different SCS than at least some of the co-scheduled cells, so the restrictions in component 11 of FG 49-1b are not applicable here.
   11) Monitoring SS set(s) for DCI format 1_3 for a set of cells for the following cases:
      1) Search space set configuration for DCI format 1_3 for the set of cells is provided only on the scheduling cell, or;
      2) Search space set configurations for DCI format 1_3 for the set of cells with the same searchSpaceId are provided on both the scheduling cell and a serving cell in the set of cells with the scheduling cell being NOT in the set of cells
      UE supporting FG 49-X can additionally report whether the UE support following case
      3) Search space set configurations for DCI format 1_3 for the set of cells with the same searchSpaceId are provided on both the scheduling cell and a serving cell in the set of cells with the scheduling cell being in the set of cells

For example, can adopt the following for the FG 66-1 for DL MC-DCI 1_3 with different SCS and different carrier types:

Unlike FG 49-1/49-1b, no need for the FG title to mention scheduling cell being inside or outside the cell set;
   Components 3 can be defined as combination and extension of components 1 from FG 49-1/49-1b, and component 2 of FG 49-1, as follows:
      3) The scheduling cell is included or not included in the set of cells, and is in a same PUCCH group as the set of cells.
      Scheduling cell is PCell if set of cells includes PCell, and scheduling cell is PCell or an SCell if set of cells includes only SCells.
   Components 4-9 and 11 directly follow from FG 49-1 without any change;
Components 10 can be updated based on FG 49-1b as follows:
   10) The number of unicast DL DCIs to process for a set of cells configured for multi-cell PDSCH scheduling by DCI format 1_3
   One DCI format 1_3 for the set of cells, and,
   One unicast DL DCI formats 1_0/1_1/1_2 (if supported), per N consecutive slots of scheduling cell, for each of the cells,
   No more than 1 DCI scheduling PDSCH, per N consecutive slots of scheduling cell, for each cell in the set of cells;
   N is determined separately for each scheduled cell in the set of cells;
   For same SCS, N=1
   For low-to-high SCS, N=1.
   For high-to-low SCS, N is based on pair of (scheduling CC SCS, scheduled CC SCS): N=2 for (30,15)
      Note: Time span for DCI counting is different for different cells and different DCI formats (per slot for DCI 1_3, and per N slots for DL SC-DCI, with different values of N for different cells based on respective SCS).

Similar discussion applies to FG 66-2 for UL DCI 0_3 based on an extension of FG 49-2 and FG 49-2b.

For example, the number of UL DCI formats that the UE can support in case of an FDD Scheduling cell can be same as that previously described herein for number of DL DCI format.

For example, the number of UL DCI formats that the UE can support in case of an TDD Scheduling cell can be as follows:
The number of unicast UL DCIs to process for a set of cells configured for multi-cell PUSCH scheduling by DCI format 1_3
[Up to] two DCI formats 0_3 for the set of cells, slot of scheduling cell, and,
Up to two unicast DL DCI formats 0_0/0_1/0_2 (if supported), per N consecutive slots of scheduling cell, for each of the cells,
No more than 2 DCI scheduling PUSCH, per N consecutive slots of scheduling cell, for each cell in the set of cells;
N is determined separately for each scheduled cell in the set of cells;
For same SCS, N=1
For low-to-high SCS, N=1.
For high-to-low SCS, N is based on pair of (scheduling CC SCS, scheduled CC SCS): N=2 for (30,15)
   Note: Time span for DCI counting is different for different cells and different DCI formats (per slot for DCI 0_3, and per N slots for UL SC-DCI, with different values of N for different cells based on respective SCS).

As used herein:
“same SCS” means the corresponding scheduled cell in the set of cells has a same SCS as the scheduling cell;
“low-to-high SCS” means the corresponding scheduled cell in the set of cells has a lower/smaller SCS than the scheduling cell;
“high-to-low SCS” means the corresponding scheduled cell in the set of cells has a higher/larger SCS than the scheduling cell.

For example, a set of cells includes multiple scheduled cells with different SCS values, and each scheduled cell in the cell set can have different SCS, thereby associated with a different case described herein. For example, a first cell in the cell set can apply “same SCS”, and a second cell in the cell set can apply “low-to-high SCS” and a third cell in the cell set can apply “high-to-low SCS”.

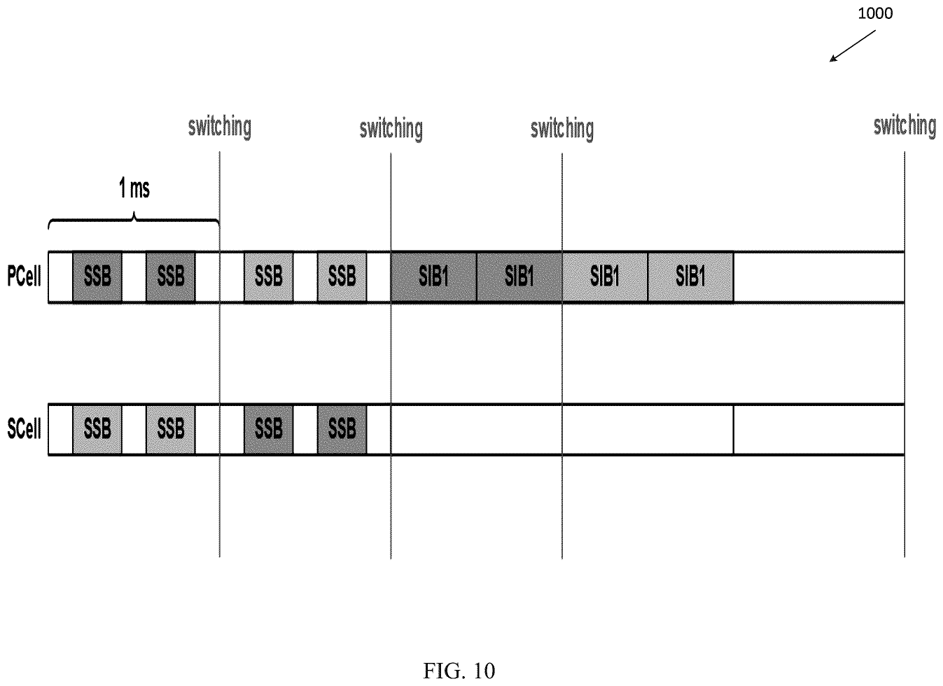

FIG. 10 illustrates an example of cell switching pattern 1000 according to embodiments of the present disclosure. For example, any of the UEs 111-116 of FIG. 1, such as the UE 111, can apply cell switching pattern 1000. This example is for illustration only and other embodiments can be used without departing from the scope of the present disclosure.

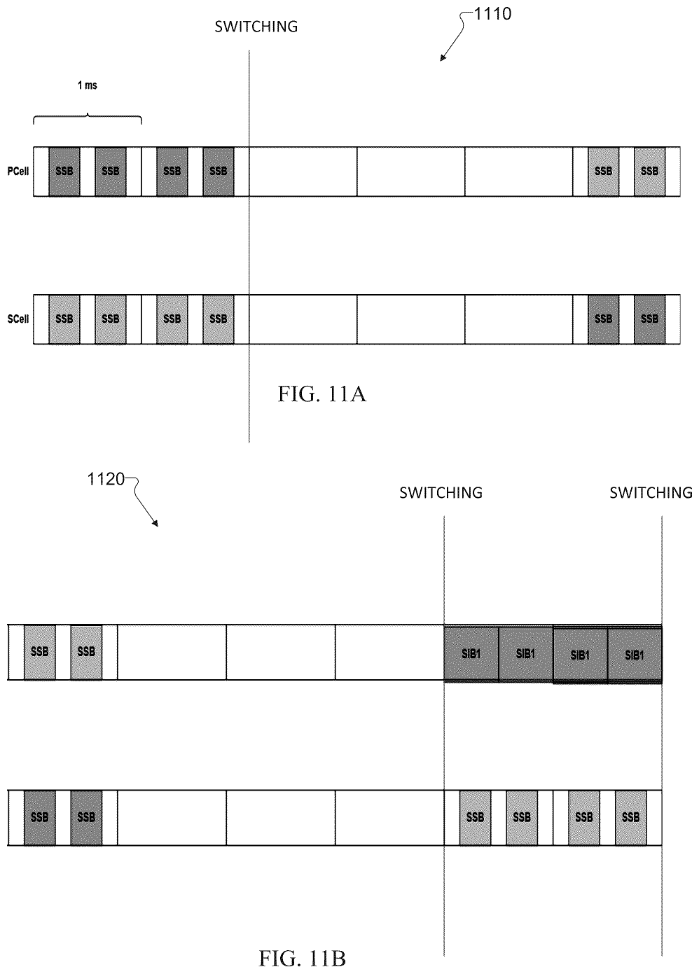

FIGS. 11A and 11B illustrate an example of cell switching pattern 1110 and 1120 according to embodiments of the present disclosure. For example, any of the UEs 111-116 of FIG. 1, such as the UE 112, can apply cell switching pattern 1110 and 1120. This example is for illustration only and other embodiments can be used without departing from the scope of the present disclosure.

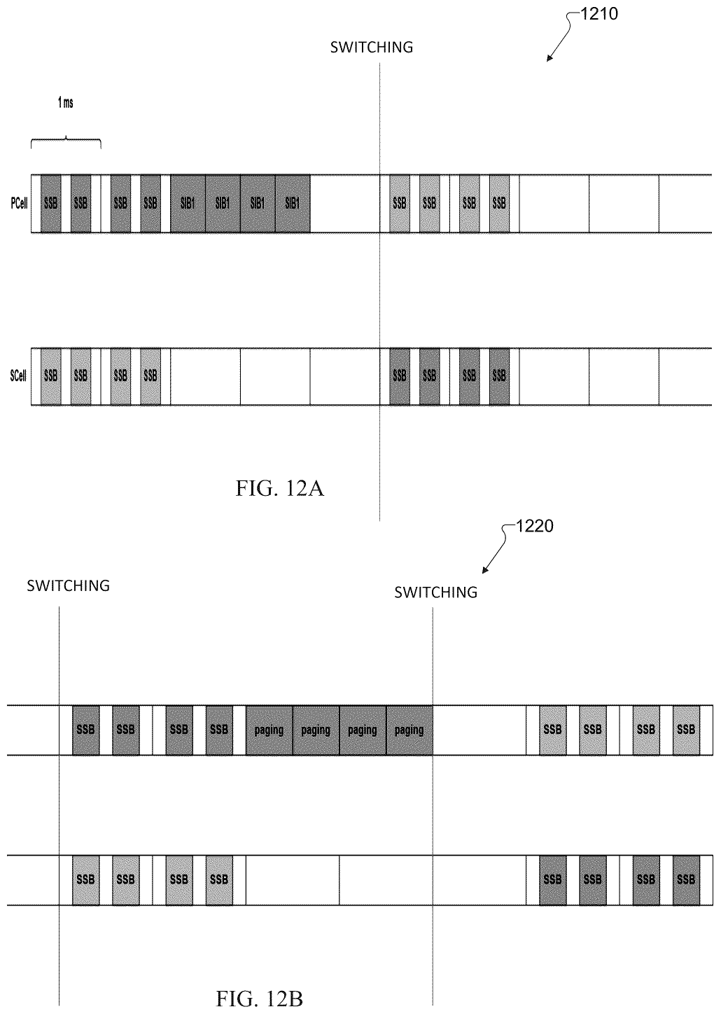

FIGS. 12A and 12B illustrate an example of cell switching pattern 1210 and 1220 according to embodiments of the present disclosure. For example, any of the UEs 111-116 of FIG. 1, such as the UE 113, can apply cell switching pattern 1210 and 1220. This example is for illustration only and other embodiments can be used without departing from the scope of the present disclosure.

In one embodiment, a UE can be configured a pattern for switching between a first cell, such as a PCell, and a second cell, such as an SCell. For example, the PCell is an FR1 FDD cell, and the SCell is an SDL cell. For example, the switching pattern can be based on a periodicity, such as 5 or 10 or 20 msec or other values, and a number of switching points to indicates a switch from the PCell to the SCell or from the SCell to the PCell, including switching delays. A number of switching points in the Cell switching pattern can be based on one or more of: an SSB periodicity, a number of actually transmitted SSB indexes on the PCell, a periodicity of the Cell switching pattern, and whether or not SSB is present or absent on the SCell (such as whether the PCell and the SCell are synchronized and/or collocated).

For example, both the PCell and the SCell are in same frequency range, such as FR1, or can be in different frequency ranges.

For example, the switching pattern periodicity can be same as SSB periodicity on the PCell or larger (or shorter) than SSB periodicity on the PCell.

In one realization, the Cell switching pattern can include a first number of switching points when a periodicity of the Cell switching pattern is larger than a threshold, and includes a second number of switching points when the periodicity of the Cell switching pattern is smaller than the threshold.

For example, the Cell switching pattern can include 1 switching point when corresponding periodicity is larger than 5 msec, and can include 2 or 3 switching points when corresponding periodicity is 5 msec.

For example, the Cell switching pattern can include 1 switching point when corresponding periodicity is same as or shorter than an SSB periodicity on the PCell (or the SCell), and can include 2 or more switching points when corresponding periodicity is larger than an SSB periodicity on the PCell (or the SCell).

For example, the Cell switching pattern can include 1 switching point when corresponding periodicity is same as or larger than an SSB periodicity on the PCell (or the SCell), and can include 2 or more switching points when corresponding periodicity is shorter than an SSB periodicity on the PCell (or the SCell).

For example, a UE does not expect SSB candidates in time domain for the SCell to (partially or) fully overlap with a time duration configured for PCell operation, such as before a switching point from PCell or SCell. Therefore, the UE expects that the SCell can have SSB candidates available with same beam index or with different beam index from the PCell, or with same half-frame bit or different half-frame bit compared to the SSB for the PCell.

For example, having 2 or more switching points can be further conditioned on whether the SCell provides a separate SSB, such as when the SCell is not synchronized or collocated with the PCell. For example, when the SCell is synchronized or collocated with the PCell, or does not otherwise transmit SSB, the Cell switching pattern can include only 1 switching point.

For example, having 2 or more switching points can be further conditioned on how many SSB indexes are actually provided by the PCell. For example, when the PCell includes only one or two SSB indexes, the Cell switching pattern can include only 1 switching point. For example, when the PCell includes only three or four SSB indexes, the Cell switching pattern can include 2 or more switching points.

In one example, for a random access channel (RACH) procedure on such a PCell or SCell, a RAR window on the PCell can start after the UE has switched back to the PCell. For example, a time duration in which the UE is operating on the SCell (also corresponding transition time from and to the PCell/SCell) does not count towards the RAR window duration. For example, the UE may suspend timers/counters for a RAR window when the RAR window starts on the PCell before a time point for switching from PCell to SCell, and the RAR window has not finished by such switching point, so that the RAR window would otherwise overlap with a time duration in which the UE operates on the SCell. For example, the UE may resume corresponding timers/counters for the RAR window when the UE switches back to the PCell.

Similar may hold for UE measurement windows as well, such as for RRM measurements or RLM/RLF measurements or for BFR measurements, and so on. For example, the UE does not a time duration in which the UE is operating on the SCell (possibly also corresponding transition time from and to the PCell/SCell) towards a time duration for such RRM/RLM/RLF/BFR measurement, that may result in triggering handover/RLF/BFR events. For example, the UE may suspend corresponding timers/counters for RRM/RLM/RLF/BFR when a corresponding measurement window starts on the PCell before a time point for switching from PCell to SCell, and the corresponding measurement window does not finish before/by such PCell-to-SCell switching point, so that the corresponding measurement window would otherwise overlap with a time duration in which the UE operates on the SCell. For example, the UE may resume corresponding timers/counters for the corresponding measurement window when the UE switches back to the PCell. Similar may also apply to other time durations for other UE operations such as for UE DRX or Cell DTX/DRX.

For example, the cell switching pattern can append two patterns.

For example, the switching pattern can be a bitmap corresponding to slots, where a value 0 indicates operation on the PCell, and a value indicates operation on the SCell.

Various methods in this embodiment and examples can also apply to Cell discontinuous transmission (DTX)/discontinuous reception (DRX) pattern or a UE DRX pattern on a single cell, such as a PCell or an SCell, in CONNECTED mode or in IDLE/INACTIVE mode.

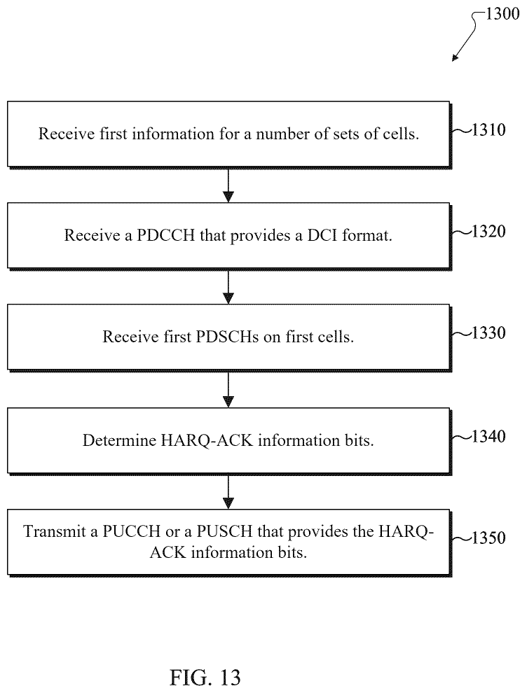

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method 1300 begins with the UE receiving first information for a number of sets of cells (1310). The UE then receives a PDCCH that provides a DCI format (1320). For example, in 1320, the DCI format schedules receptions of the first PDSCHs on the first cells in a set s of cells from the number of sets of cells. The first PDSCHs include one or more PDSCHs on each cell from the first cells.

The UE then receives first PDSCHs on first cells (1330). The UE then determines HARQ-ACK information bits (1340). For example, in 1340, first

$${N}_{sets}^{HARQ - ACK , s}$$

HARQ-ACK information bits, from the HARQ-ACK information bits, are associated with the receptions of the first PDSCHs. All subsequent

$$( {N}_{sets}^{HARQ - ACK , max} - {N}_{sets}^{HARQ - ACK , s} )$$

HARQ-ACK information bits, from the HARQ-ACK information bits, have a NACK value.

$${N}_{sets}^{HARQ - ACK , s}$$

is a sum, across all the first cells, of

$${N}_{TB , c}^{DL} \cdot {N}_{PDSCH , c}^{max}$$

when TBG HARQ-ACK bundling does not apply for a cell c, or

$${N}_{TB , c}^{D L} \cdot {N}_{HARQ - ACK , c}^{TBG , max} ,$$

when TBG HARQ-ACK bundling applies for the cell c.

$${N}_{TB , c}^{DL}$$

is a maximum number of codewords per PDSCH on the cell c, when spatial HARQ-ACK bundling does not apply for the cell c, otherwise

$${N}_{TB , c}^{DL} = 1. {N}_{PDSCH , c}^{max}$$

is a maximum number of SLIVs over all rows of a first TDRA table associated with the cell c.

$${N}_{HARQ - ACK , c}^{TBG , max}$$

is a maximum number of TBGs for HARQ-ACK bundling for the cell c.

$${N}_{sets}^{HARQ - ACK , max}$$

is a maximum number of HARQ-ACK information bits for any DCI format that schedules PDSCHs on one or more cells in any set of cells from the number of sets of cells. The cell c is from the first cells. The UE then transmits a PUCCH or a PUSCH that provides the HARQ-ACK information bits (1350).

In various embodiments, the number of sets of cells are in a same PUCCH group of cells, and

$${N}_{sets}^{HARQ - ACK , max}$$

is a maximum of

$${N}_{s e t s}^{HARQ - ACK , s}$$

over any set of cells from the number of sets of cells and any number of PDSCHs that are scheduled by any DCI format on one or more cells in any set of cells from the number of sets of cells.

In various embodiments, the UE receives second information for TDRA tables with one-to-one mapping to DL BWPs of cells in the set s of cells. The first TDRA table is from the TDRA tables and maps to an active DL BWP of the cell c. The UE receives third information for a second TDRA table for the set s of cells. A TDRA field of the DCI format indicates a second row of the second TDRA table. The second row of the second TDRA table includes entries with one-to-one mapping to the DL BWPs of the cells in the set s of cells. An entry, mapped to the active DL BWP of the cell c, in the second row of the second TDRA table provides an index of a first row of the first TDRA table. The first row of the first TDRA table includes one or more SLIVs. The one or more SLIVs correspond to receptions of second one or more PDSCHs on the active DL BWP of the cell c. The second one or more PDSCHs are included in the first PDSCHs.

In various embodiments, the UE indicates a capability for a maximum number of PDSCH receptions that are scheduled by one DCI format across cells in any set of cells from the number of sets of cells.

In various embodiments, the TBG HARQ-ACK bundling does not apply for the cell c or TBG HARQ-ACK bundling applies for the cell c with value

$${N}_{HARQ - ACK , c}^{TBG , max} > 1 .$$

In various embodiments, the DCI format indicates reserved values for a FDRA field corresponding to a cell from the set s of cells, a TDRA field of the DCI format indicates SLIVs for respective PDSCHs for the cell, TBG HARQ-ACK bundling does not apply for the cell, and the HARQ-ACK information bits for the respective PDSCHs on the cell include an ACK value associated with a first SLIV from the SLIVs, followed by NACK values associated with remaining SLIVs from the SLIVs.

In various embodiments, the UE indicates a capability for HARQ-ACK feedback associated with DCI formats provided by PDCCH receptions in a same PDCCH MO. The DCI formats schedule PDSCH receptions on the cell c. The UE receives

$${N}_{PDCCH , c}^{m} > 1$$

DCI formats provided by PDCCH receptions in a PDCCH MO m. Each DCI format, from the

$${N}_{PDCCH , c}^{m}$$

DCI formats, schedules PDSCH receptions on the cell c. The

$${N}_{PDCCH , c}^{m}$$

DCI formats schedules

$${N}_{PDSCH , c}^{m} > 1$$

PDSCH receptions on the cell c. c is a smallest cell index among respective cells that are scheduled by each of the

$${N}_{PDCCH , c}^{m}$$

DCI formats. c is a same across the

$${N}_{PDCCH , c}^{m}$$

DCI formats. The UE counts the cell c a number

$${N}_{PDCCH , c}^{m}$$

times for PDCCH MO m in increasing order of respective earliest PDSCH reception starting time, for each of the

$${N}_{PDCCH , c}^{m}$$

DCI formats, among the

$${N}_{PDSCH , c}^{m}$$

PDSCH receptions.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving first information for a number of sets of cells;
receiving a physical downlink shared channel (PDCCH) that provides a downlink control information (DCI) format, wherein:
the DCI format schedules receptions of more than one first physical downlink shared channels (PDSCH) on first more than one cell in a set s of cells from the number of sets of cells, and
the first more than one PDSCH include one or more PDSCHs on each cell from the first more than one cell;
receiving the first more than one PDSCH on the first more than one cell;
determining hybrid automatic repeat request acknowledgement (HARQ-ACK) information bits, wherein:
first
$${N}_{s e t s}^{HARQ - ACK , s}$$
HARQ-ACK information bits, from the HARQ-ACK information bits, are associated with the receptions of the first more than one PDSCH,
all subsequent
$$( {N}_{s e t s}^{HARQ - ACK , max} - {N}_{s e t s}^{HARQ - ACK , s} )$$
HARQ-ACK information bits, from the HARQ-ACK information bits, have a negative acknowledgment (NACK) value,
$${N}_{s e t s}^{HARQ - ACK , s}$$
is a sum, across all the first more than one cell, of:
$${N}_{TB , c}^{D L} \cdot {N}_{PDSCH , c}^{max}$$
when transport block group (TBG) HARQ-ACK bundling does not apply for a cell c, or
$${N}_{TB , c}^{D L} \cdot {N}_{HARQ - ACK , c}^{TBG , max}$$
when TBG HARQ-ACK bundling applies for the cell c,
$${N}_{TB , c}^{DL}$$
is a maximum number of codewords per PDSCH on the cell c, when spatial HARQ-ACK bundling does not apply for the cell c, otherwise
$${N}_{TB , c}^{DL} = 1 ,$$
$${N}_{PDSCH , c}^{max}$$
is a maximum number of start and length indicator values (SLIVs) over all rows of a first time-domain resource allocation (TDRA) table associated with the cell c,
$${N}_{HARQ - ACK , c}^{TBG , max}$$
is a maximum number of TAGs for HARQ-ACK bundling for the cell c,
$${N}_{sets}^{HARQ - ACK , max}$$
is a maximum number of HARQ-ACK information bits for any DCI format that schedules PDSCHs on one or more cells in any set of cells from the number of sets of cells, and
the cell c is from the first more than one cell; and
transmitting a physical uplink control channel (PUCCH) or a physical uplink shared channel (PUSCH) that provides the HARQ-ACK information bits.

2. The method of claim 1, wherein:
the number of sets of cells are in a same PUCCH group of cells, and
$${N}_{sets}^{HARQ - ACK , max}$$
is a maximum of
$${N}_{sets}^{HARQ - ACK , s}$$
over:
any set of cells from the number of sets of cells, and
any number of PDSCHs that are scheduled by any DCI format on one or more cells in any set of cells from the number of sets of cells.

3. The method of claim 1, further comprising:
receiving second information for TDRA tables with one-to-one mapping to downlink bandwidth parts (DL BWPs) of cells in the set s of cells, wherein the first TDRA table is from the TDRA tables and maps to an active DL BWP of the cell c; and
receiving third information for a second TDRA table for the set s of cells, wherein:
a TDRA field of the DCI format indicates a second row of the second TDRA table,
the second row of the second TDRA table includes entries with one-to-one mapping to the DL BWPs of the cells in the set s of cells,
an entry, mapped to the active DL BWP of the cell c, in the second row of the second TDRA table provides an index of a first row of the first TDRA table,
the first row of the first TDRA table includes one or more SLIVs,
the one or more SLIVs correspond to receptions of second one or more PDSCHs on the active DL BWP of the cell c, and
the second one or more PDSCHs are included in the first more than one PDSCH.

4. The method of claim 1, further comprising:
indicating a capability for a maximum number of PDSCH receptions that are scheduled by one DCI format across cells in any set of cells from the number of sets of cells.

5. The method of claim 1, wherein:
TBG HARQ-ACK bundling does not apply for the cell c, or
TBG HARQ-ACK bundling applies for the cell c with value
$${N}_{HARQ - ACK , c}^{TBG , max} > 1 .$$

6. The method of claim 1, wherein:
the DCI format indicates reserved values for a frequency-domain resource allocation (FDRA) field corresponding to a cell from the set s of cells,
a TDRA field of the DCI format indicates SLIVs for respective PDSCHs for the cell,
TBG HARQ-ACK bundling does not apply for the cell, and
the HARQ-ACK information bits for the respective PDSCHs on the cell include an acknowledgment (ACK) value associated with a first SLIV from the SLIVs, followed by NACK values associated with remaining SLIVs from the SLIVs.

7. The method of claim 1, further comprising:
indicating a capability for HARQ-ACK feedback associated with DCI formats provided by PDCCH receptions in a same PDCCH monitoring occasion (MO), wherein the DCI formats schedule PDSCH receptions on the cell c;
receiving
$${N}_{PDCCH , c}^{m} > 1$$
DCI formats provided by PDCCH receptions in a PDCCH MO m, wherein:
each DCI format, from the
$${N}_{PDCCH , c}^{m}$$
DCI formats, schedules PDSCH receptions on the cell c,
the
$${N}_{PDCCH , c}^{m}$$
formats schedule
$${N}_{PDSCH , c}^{m} >$$
1 PDSCH receptions on the cell c,
c is a smallest cell index among respective cells that are scheduled by each of the
$${N}_{PDCCH , c}^{m}$$
DCI formats, and
c is same across the
$${N}_{PDCCH , c}^{m}$$
DCI formats; and
counting the cell c a number
$${N}_{PDCCH , c}^{m}$$
times for PDCCH MO m in increasing order of respective earliest PDSCH reception starting time, for each of the
$${N}_{PDCCH , c}^{m}$$
DCI formats, among the
$${N}_{PDSCH , c}^{m}$$
PDSCH receptions.

8. A user equipment (UE) comprising:
a transceiver configured to:
receive first information for a number of sets of cells;
receive a physical downlink shared channel (PDCCH) that provides a downlink control information (DCI) format, wherein:
the DCI format schedules receptions of first physical downlink shared channels (PDSCHs) on first more than one cell in a set s of cells from the number of sets of cells, and
the first more than one PDSCH include one or more PDSCHs on each cell from the first more than one cell; and
receive the first more than one PDSCH on the first more than one cell; and
a processor operably coupled with the transceiver, the processor configured to determine hybrid automatic repeat request acknowledgement (HARQ-ACK) information bits, wherein:
first
$${N}_{sets}^{HARQ - ACK , s}$$
HARQ-ACK information bits, from the HARQ-ACK information bits, are associated with the receptions of the first more than one PDSCH,
all subsequent
$$( {N}_{sets}^{HARQ - ACK , max} - {N}_{sets}^{HARQ - ACK , s} )$$
HARQ-ACK information bits, from the HARQ-ACK information bits, have a negative acknowledgment (NACK) value,
$${N}_{sets}^{HARQ - ACK , s}$$
is a sum across all the first more than one cell, of:
$${N}_{TB , c}^{DL} \cdot {N}_{PDSCH , c}^{max}$$
when transport block group (TBG) HARQ-ACK bundling does not apply for a cell c, or
$${N}_{TB , c}^{DL} \cdot {N}_{HARQ - ACK , c}^{TBG , max}$$
when TBG HARQ-ACK bundling applies for the cell c,
$${N}_{TB , c}^{DL}$$
is a maximum number of codewords per PDSCH on the cell c, when spatial HARQ-ACK bundling does not apply for the cell c, otherwise
$${N}_{TB , c}^{DL} = 1 ,$$
$${N}_{PDSCH , c}^{max}$$
is a maximum number of start and length indicator values (SLIVs) over all rows of a first time-domain resource allocation (TDRA) table associated with the cell c,
$${N}_{HARQ - ACK , c}^{TBG , max}$$
is a maximum number of TAGs for HARQ-ACK bundling for the cell c,
$${N}_{sets}^{HARQ - ACK , max}$$
is a maximum number of HARQ-ACK information bits for any DCI format that schedules PDSCHs on one or more cells in any set of cells from the number of sets of cells, and
cell c is from the first more than one cell;
wherein the transceiver is further configured to transmit a physical uplink control channel (PUCCH) or a physical uplink shared channel (PUSCH) that provides the HARQ-ACK information bits.

9. The UE of claim 8, wherein:
the number of sets of cells are in a same PUCCH group of cells, and
$${N}_{sets}^{HARQ - ACK , max}$$
is a maximum of
$${N}_{sets}^{HARQ - ACK , s}$$
over:
any set of cells from the number of sets of cells, and
any number of PDSCHs that are scheduled by any DCI format on one or more cells in any set of cells from the number of sets of cells.

10. The UE of claim 8, wherein:
the transceiver is further configured to receive second information for TDRA tables with one-to-one mapping to downlink bandwidth parts (DL BWPs) of cells in the set s of cells;
the first TDRA table is from the TDRA tables, and maps to an active DL BWP of the cell c;
the transceiver is further configured to receive third information for a second TDRA table for the set s of cells;
a TDRA field of the DCI format indicates a second row of the second TDRA table;
the second row of the second TDRA table includes entries with one-to-one mapping to the DL BWPs of the cells in the set s of cells;
an entry, mapped to the active DL BWP of the cell c, in the second row of the second TDRA table provides an index of a first row of the first TDRA table;
the first row of the first TDRA table includes one or more SLIVs;
the one or more SLIVs correspond to receptions of second one or more PDSCHs on the active DL BWP of the cell c; and
the second one or more PDSCHs are included in the first more than one PDSCH.

11. The UE of claim 8, wherein the transceiver is further configured to indicating a capability for a maximum number of PDSCH receptions that are scheduled by one DCI format across cells in any set of cells from the number of sets of cells.

12. The UE of claim 8, wherein:
TBG HARQ-ACK bundling does not apply for the cell c, or
TBG HARQ-ACK bundling applies for the cell c, with value
$${N}_{HARQ - ACK , c}^{TBG , max} > 1.$$

13. The UE of claim 8, wherein:
the DCI format indicates reserved values for a frequency-domain resource allocation (FDRA) field corresponding to a cell from the set s of cells,
a TDRA field of the DCI format indicates SLIVs for respective PDSCHs for the cell,
TBG HARQ-ACK bundling does not apply for the cell, and
the HARQ-ACK information bits for the respective PDSCHs on the cell include an acknowledgment (ACK) value associated with a first SLIV from the SLIVs, followed by NACK values associated with remaining SLIVs from the SLIVs.

14. The UE of claim 8, wherein:
the transceiver is further configured to transmit information indicating a capability for HARQ-ACK feedback associated with DCI formats provided by PDCCH receptions in a same PDCCH monitoring occasion (MO), wherein the DCI formats schedule PDSCH receptions on the cell c;
the transceiver is further configured to receive
$${N}_{PDCCH , c}^{m} > 1$$
formats provided by PDCCH receptions in a PDCCH MO m, wherein:
each DCI format, from the
$${N}_{PDCCH , c}^{m}$$
DCI formats, schedules PDSCH receptions on the cell c,
the
$${N}_{PDCCH , c}^{m}$$
DCI formats schedule
$${N}_{PDCCH , c}^{m} > 1$$
PDSCH receptions on the cell c,
c is a smallest cell index among respective cells that are scheduled by each of the
$${N}_{PDCCH , c}^{m}$$
DCI formats, and
c is same across the
$${N}_{PDCCH , c}^{m}$$
DCI formats, and
the processor is further configured to count the cell c a number
$${N}_{PDCCH , c}^{m}$$
times for PDCCH MO m in increasing order of respective earliest PDSCH reception starting time, for each of the
$${N}_{PDCCH , c}^{m}$$
DCI formats, among the
$${N}_{PDCCH , c}^{m}$$
PDSCH receptions.

15. A base station comprising:
a transceiver configured to:
transmit first information for a number of sets of cells;
transmit a physical downlink shared channel (PDCCH) that provides a downlink control information (DCI) format, wherein:
the DCI format schedules transmissions of first physical downlink shared channels (PDSCHs) on first more than one cell in a set s of cells from the number of sets of cells, and
the first more than one PDSCH include one or more PDSCHs on each cell from the first more than one cell;
transmit the first more than one PDSCH on the first more than one cell; and
receive a physical uplink control channel (PUCCH) or a physical uplink shared channel (PUSCH) that provides hybrid automatic repeat request acknowledgement (HARQ-ACK) information bits; and
a processor operably coupled with the transceiver, the processor configured to determine the HARQ-ACK information bits from the PUCCH or PUSCH reception, wherein:
first
$${N}_{sets}^{HARQ - ACK , s}$$
HARQ-ACK information bits, from the HARQ-ACK information bits, are associated with the receptions of the first more than one PDSCH,
all subsequent
$$( {N}_{sets}^{HARQ - ACK , max} - {N}_{sets}^{HARQ - ACK , s} )$$
HARQ-ACK information bits, from the HARQ-ACK information bits, have a negative acknowledgment (NACK) value,
$${N}_{sets}^{HARQ - ACK , s}$$
is a sum, across all the first more than one cell, of:
$${N}_{TB , c}^{DL} \cdot {N}_{PDSCH , c}^{max}$$
when transport block group (TBG) HARQ-ACK bundling does not apply for a cell c, or
$${N}_{TB , c}^{DL} \cdot {N}_{HARQ - ACK , c}^{TBG , max}$$
when TBG HARQ-ACK bundling applies for the cell c,
$${N}_{TB , c}^{DL}$$
is a maximum number of codewords per PDSCH on the cell c, when spatial HARQ-ACK bundling does not apply for the cell c, otherwise
$${N}_{TB , c}^{D L} = 1 ,$$
$${N}_{PDSCH , c}^{max}$$
is a maximum number of start and length indicator values (SLIVs) over all rows of a first time-domain resource allocation (TDRA) table associated with the cell c,
$${N}_{H A R Q - ACK , c}^{TBG , max} > 1$$
is a maximum number of TAGs for HARQ-ACK bundling for the cell c,
$${N}_{s e t s}^{H A R Q - ACK , max}$$
is a maximum number of HARQ-ACK information bits for any DCI format that schedules PDSCHs on one or more cells in any set of cells from the number of sets of cells, and
cell c is from the first more than one cell.

16. The base station of claim 15, wherein:
the number of sets of cells are in a same PUCCH group of cells, and
$${N}_{s e t s}^{H A R Q - ACK , max}$$
is a maximum of
$${N}_{s e t s}^{H A R Q - ACK , s}$$
over:
any set of cells from the number of sets of cells, and
any number of PDSCHs that are scheduled by any DCI format on one or more cells in any set of cells from the number of sets of cells.

17. The base station of claim 15, wherein:
the transceiver is further configured to transmit second information for TDRA tables with one-to-one mapping to downlink bandwidth parts (DL BWPs) of cells in the set s of cells;
the first TDRA table is from the TDRA tables, and maps to an active DL BWP of the cell c;
the transceiver is further configured to transmit third information for a second TDRA table for the set s of cells;
a TDRA field of the DCI format indicates a second row of the second TDRA table;
the second row of the second TDRA table includes entries with one-to-one mapping to the DL BWPs of the cells in the set s of cells;
an entry, mapped to the active DL BWP of the cell c, in the second row of the second TDRA table provides an index of a first row of the first TDRA table;
the first row of the first TDRA table includes one or more SLIVs;
the one or more SLIVs correspond to transmissions of second one or more PDSCHs on the active DL BWP of the cell c; and
the second one or more PDSCHs are included in the first more than one PDSCH.

18. The base station of claim 15, wherein the transceiver is further configured to receive an indication of a capability for a maximum number of PDSCH transmissions that are scheduled by one DCI format across cells in any set of cells from the number of sets of cells.

19. The base station of claim 15, wherein:
the DCI format indicates reserved values for a frequency-domain resource allocation (FDRA) field corresponding to a cell from the set s of cells,
a TDRA field of the DCI format indicates SLIVs for respective PDSCHs on the cell,
TBG HARQ-ACK bundling does not apply for the cell, and
the HARQ-ACK information bits for the respective PDSCHs on the cell include an acknowledgment (ACK) value associated with a first SLIV from the SLIVs, followed by NACK values associated with remaining SLIVs from the SLIVs.

20. The base station of claim 15, wherein:
the transceiver is further configured to receive an indication of a capability for HARQ-ACK feedback associated with DCI formats provided by PDCCH transmissions in a same PDCCH monitoring occasion (MO), wherein the DCI formats schedule PDSCH transmissions on the cell c;
the transceiver is further configured to transmit
$${N}_{P D C C H , c}^{m} > 1$$
DCI formats provided by PDCCH transmissions in a PDCCH MO m, wherein:
each DCI format, from the
$${N}_{P D C C H , c}^{m}$$
DCI formats, schedules PDSCH transmissions on the cell c,
the
$${N}_{P D C C H , c}^{m}$$
DCI formats schedule
$${N}_{P D S C H , c}^{m} > 1$$
PDSCH transmission on the cell c,
c is a smallest cell index among respective cells that are scheduled by each of the
$${N}_{P D C C H , c}^{m}$$
DCI formats, and
c is same across the
$${N}_{P D C C H , c}^{m}$$
DCI formats; and
the processor is further configured to count the cell c a number
$${N}_{P D C C H , c}^{m}$$
times for PDCCH MO m in increasing order of respective earliest PDSCH transmission starting time, for each of the
$${N}_{P D C C H , c}^{m}$$
DCI formats, among the
$${N}_{P D S C H , c}^{m}$$
PDSCH transmissions.
